(19) United States
(12) Patent Application Publication
(10) Pub. No.: US 2014/0366065 A1
(43) Pub. Date: Dec. 11, 2014

(54) Method, Scene List Output Device, Program, and Server

(71) Applicants: Kabushiki Kaisha Toshiba, Tokyo (JP); Toshiba Lifestyle Products & Services Corporation, Tokyo (JP)

(72) Inventors: Hiroshi Hattori, Akishima (JP); Toyokazu Itakura, Kawasaki Kanagawa (JP)

(21) Appl. No.: 14/468,076

(22) Filed: Aug. 25, 2014

Related U.S. Application Data
(63) Continuation of application No. PCT/JP2013/064512, filed on May 24, 2013.

(51) Int. Cl. H04N 21/482; H04N 5/445; H04N 21/45; H04N 21/466; H04N 21/44; H04N 21/442

(52) U.S. Cl. CPC H04N 21/4826; H04N 21/44008; H04N 21/44204; H04N 21/4532; H04N 21/4667; H04N 21/4821; H04N 5/44543; H04N 2005/44556
USPC 725/45

(57) ABSTRACT

According to one of the embodiments, provided is a method including receiving scene information items related to scenes included in contents of genres, displaying the scene information items at least partly sorted out, displaying the scene information items sorted out in a first sorting order when an operation is performed with respect to a first scene in a first content of a first genre in the scene information items, and displaying the scene information items sorted out in a second sorting order which is different from the first sorting order when an operation is performed with respect to a second scene in a second content of a second genre which is different from the first genre in the scene information items.

### CROSS REFERENCE TO RELATED APPLICATIONS

This application is a Continuation application of PCT Application No. PCT/JP2013/064512, filed May 24, 2013, the entire contents of which are incorporated herein by reference.

### FIELD

Embodiments described herein relate generally to a method, scene list output device, program, and server.

### BACKGROUND

In recent years, multiple functions are performed in digital televisions. For example, multifunctional digital TVs perform a scene play function in addition to their basic functions. The basic functions include receiving and playing broadcast contents, and recording the received contents. The scene play function is to extract a designated scene from a plurality of scenes in the recorded contents and play the extracted scene. For example, the multifunctional digital TVs display a list of a plurality of scene information items corresponding to a plurality of scenes in the recorded contents in response to the activation of the scene play function, and extract a scene corresponding to a scene information item designated from the list for playing the scene. A user has only to designate a scene information item to view a scene of his/her interest or a content including the scene of interest.

As the storage volume of a device such as a hard disk and the like increases, massive contents data can be recorded, and a function to efficiently retrieve a preferable one from such massive contents data is a great demand. The above-mentioned multifunctional digital TVs can retrieve a scene information item including a retrieval keyword from a plurality of scene information items and display the retrieved scene information item in a list; however, a more efficient list displaying (list output) scheme is required.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a play screen (scene list display screen) displayed in a player of the embodiments.

FIG. 2 shows another example of a play screen (scene list display screen) displayed in the player of the embodiments.

FIG. 3 shows another example of a play screen (scene list display screen) displayed in the player of the embodiments.

FIG. 4 shows another example of a play screen (scene list display screen) displayed in the player of the embodiments.

FIG. 5 shows another example of a play screen (scene list display screen) displayed in the player of the embodiments.

FIG. 6 shows an example of a schematic structure of a remote controller corresponding to the player of the embodiments.

FIG. 7 shows an example of a schematic system structure of the embodiments.

FIG. 8 shows another example of a schematic system structure of the embodiments.

FIG. 9 shows another example of a schematic system structure of the embodiments.

FIG. 10 shows definitions/meanings of terms/abbreviations used in the present embodiments.

FIG. 11 shows an example of a software structure of the embodiments.

FIG. 12A shows an example of Scenefo and SceneList functions.

FIG. 12B shows another example of Scenefo and SceneList functions.

FIG. 12C shows another example of Scenefo and SceneList functions.

FIG. 13 shows an example of screen transition of Scenefo/SceneList.

FIG. 14 shows an example of screen transition at the time when an application is activated.

FIG. 15 shows definitions/meanings of terms/abbreviations used in the present embodiments.

FIG. 16 shows an example of the cooperation of servers of the embodiments.

FIG. 17 shows an example of a schematic structure of a metadata server of the embodiments.

FIG. 18A shows an example of the metadata included in scene information.

FIG. 18B shows another example of the metadata included in scene information.

FIG. 18C shows another example of the metadata included in scene information.

FIG. 18D shows another example of the metadata included in scene information.

FIG. 19 shows an example of details of the system structure of the embodiments.

FIG. 20 shows an image of services provided by the scene information.

FIG. 21A shows an example of the outline of the screen transition.

FIG. 21B shows another example of the outline of the screen transition.

FIG. 21C shows another example of the outline of the screen transition.

FIG. 21D shows another example of the outline of the screen transition.

FIG. 22 shows an example of details of the screen transition.

FIG. 23 shows another example of details of the screen transition.

FIG. 24 shows another example of details of the screen transition.

FIG. 25 shows another example of details of the screen transition.

FIG. 26 shows another example of details of the screen transition.

FIG. 27 shows an example of a screen view.

FIG. 28 shows another example of a screen view.

FIG. 29 shows another example of a screen view.

FIG. 30 shows another example of a screen view.

FIG. 31A shows an example of a list of ScenePlay function.

FIG. 31B shows another example of a list of ScenePlay function.

FIG. 31C shows another example of a list of ScenePlay function.

FIG. 32 shows an example of screen transition in the ScenePlay function.

FIG. 33 shows an example of a cloud menu screen.

FIG. 34 shows an example of a screen view after the screen transition.

FIG. 35 shows another example of a screen view after the screen transition.

FIG. 36 shows another example of a screen view after the screen transition.

FIG. 37 shows another example of a screen view after the screen transition.

FIG. 38 shows another example of a screen view after the screen transition.

FIG. 39 shows another example of a screen view after the screen transition.

FIG. 40 shows an example of the cloud menu screen.

FIG. 41 shows an example of a list of top thirty of instantaneous view rating.

FIG. 42 shows an example of a list of top thirty of popular scene.

FIG. 43 shows an example of scene information recommended by friends.

FIG. 44 shows an example of scene information corresponding to hot words of the day.

FIG. 45 shows an example of a scene play screen customized for user.

FIG. 46 shows a flow of the screen transition process.

FIG. 47 shows an example of a screen view.

FIG. 48 shows another example of a screen view.

FIG. 49 shows another example of a screen view.

FIG. 50 shows another example of a screen view.

FIG. 51 shows another example of a screen view.

FIG. 52 shows another example of a screen view.

FIG. 53 shows another example of a screen view.

FIG. 54 explains a normal scene play and continuous scene play.

### DETAILED DESCRIPTION

The embodiments are described.

One of the embodiments of the present application is to provide a method, scene list output device, program, and server which can output a list of scene listings efficiently.

According to one of the embodiments, provided is a method including receiving information related to scenes included in contents of genres, displaying scene listings included in the information; displaying first scene listings sorted out in a first sorting order when an operation is performed with respect to a first scene in a first content of a first genre in the scene listings, and displaying second scene listings sorted out in a second sorting order different from the first sorting order when an operation is performed with respect to a second scene in a second content of a second genre different from the first genre in the scene listings.

Hereinafter, the embodiments are described with reference to the accompanying drawings.

Firstly, a scene information function, scene list function, and scene play function (Scenefo/SceneList/ScenePlay function) will be summarized. Secondly, sorting scene listings (it may be called scene information items) which is one of scene list edit processes, and outputting a scene list including the sorted scene information items (scene list display) will be explained. Lastly, the ScenePlay function will be explained in detail. In the description of the ScenePlay function, a player 1 which achieves sorting of the scene information items and output of the scene list including the sorted scene information items (scene list edit process) will be explained together. In the present embodiments, content/contents are synonymous with program/programs.

(Summary of ScenePlay)

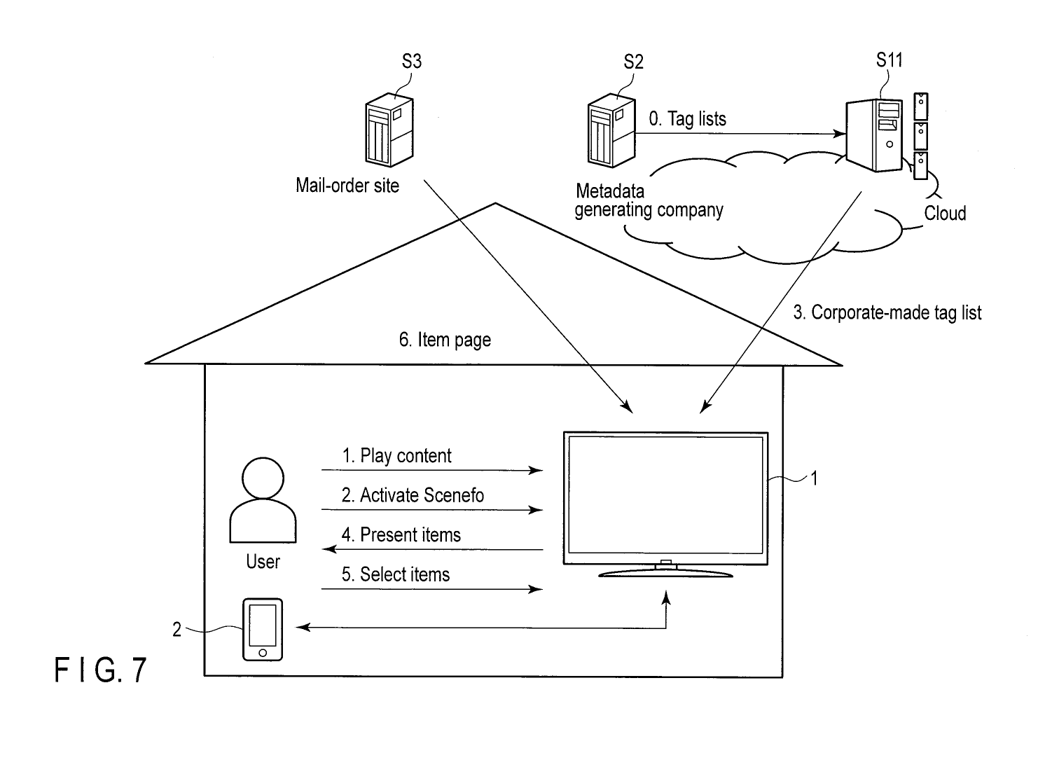

FIGS. 7 to 9 show outlines of the system structures of the embodiments. The system is structured with various kinds of servers (tag list server S11, metadata generating server S2, mail-order site server S3, and the like) and the player 1 (which is, for example, a digital TV). A mobile terminal 2 (tablet PC, smartphone, and the like) can be applied thereto. Note that, the player used as a part of the system structure is a digital TV in the present embodiments; however, it is not limited thereto. That is, any optional device can be used in the system as long as the device includes a user interface, communication function, content process function, content output function, memory function, and the like. Such a device is, for example, a digital recorder, mobile terminal, and the like.

Now, a “Scenefo/SceneList/ScenePlay” application which serves a time cloud function installed in the digital TV is explained. The Scenefo means scene information items. SceneList means a list gathering the scene information items. ScenePlay means playing a content using a scene information item.

The time cloud function is a cloud service which links a visual content with a tag or a scene information item generated by a metadata generating company, a user, a bot, or the like. The time cloud function can be divided into the following three functions.

<Scenefo>

As shown in FIG. 7, Scenefo function provides a scene information item of a scene drawing user's interest during the content viewing. The Tag List® (Trademark) is, for example, a corporate made tag list provided by a metadata generating company. Note that a user made tag list prepared by a user him/herself can be used.

As shown in FIG. 7, the system can provide the following service through the following processes.

0. Register tag lists

1. Play contents

2. Activate Scenefo

3. Send/receive corporate made tag list

4. Present merchandise (display)

5. Select merchandise (input operation)

6. Provide merchandise page (display)

<SceneList>

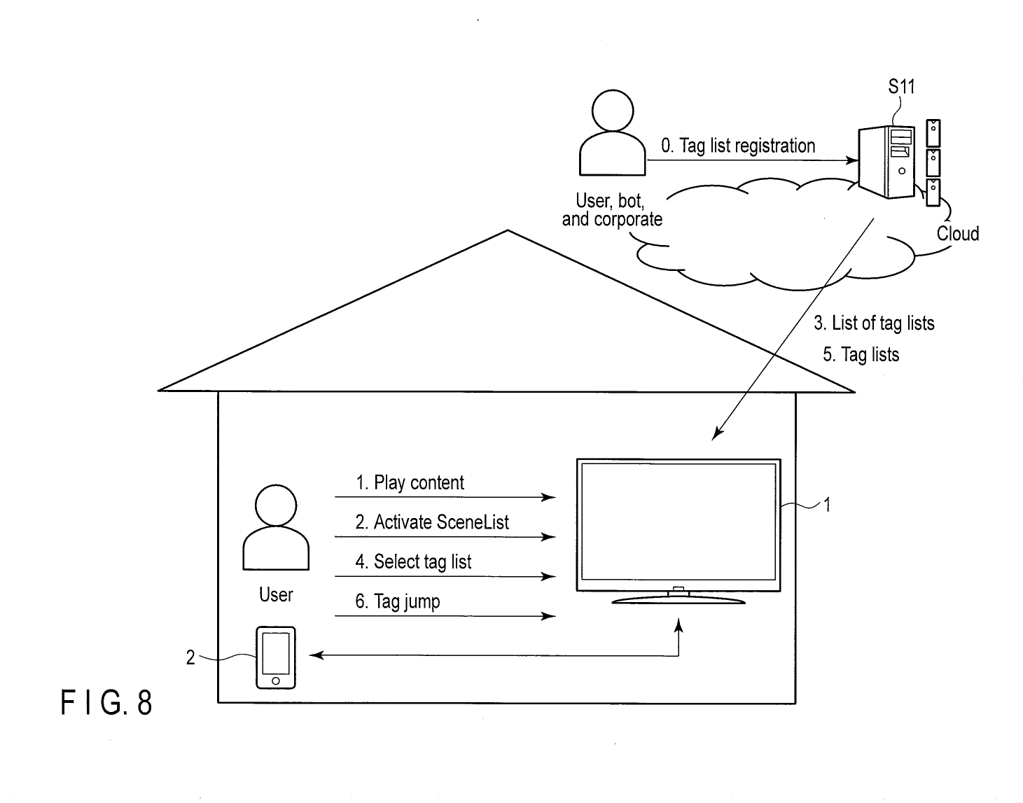

As shown in FIG. 8, the SceneList function selects only the scene a user wants to view. Among various tag lists such as a user made tag list, tag bot made tag list, and corporate made tag list provided from a metadata generating company, the user can select a desired tag list to choose a scene he/she wants to view.

0. Register tag lists

1. Play contents

2. Activate SceneList

3. Send/Receive list of tag lists

4. Select tag list

5. Send/receive selected tag list

6. Tag jump

<ScenePlay>

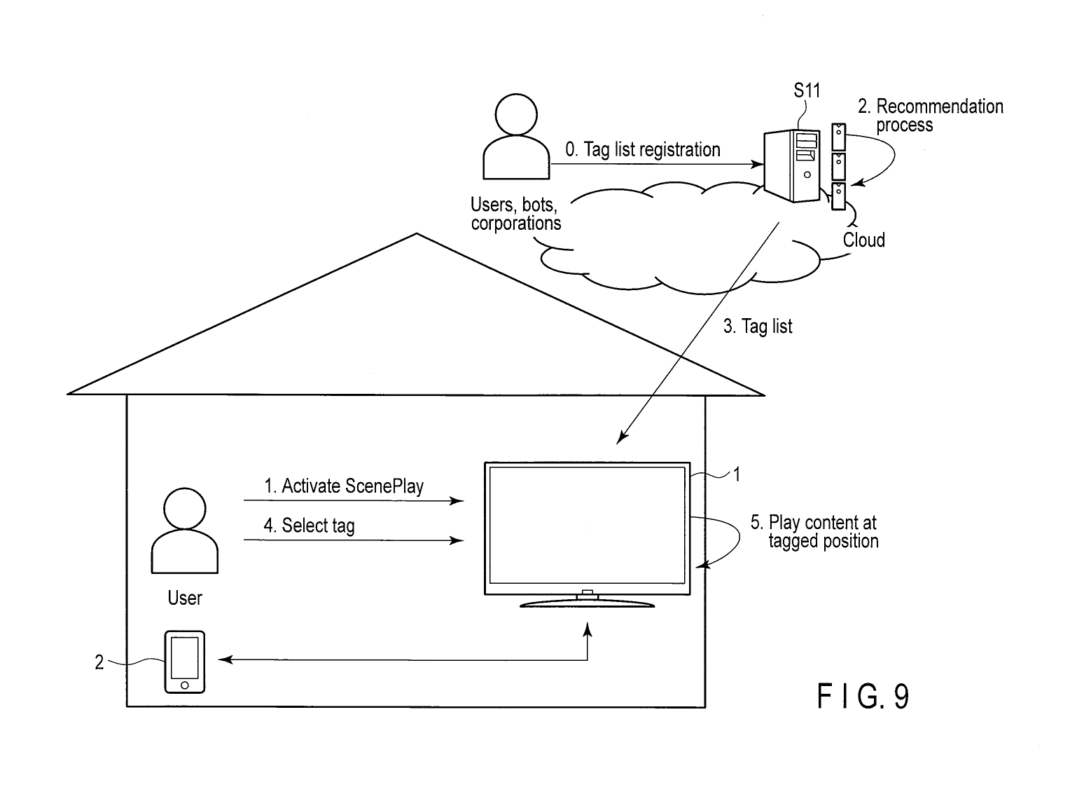

As shown in FIG. 9, the ScenePlay function can retrieve a scene in which a user is interested from a great number of scene information items of playable visual contents. A user can find a scene of interest from recommended scenes and view the scene of interest continuously. Various tag lists such as a user made tag list, tag bot made tag list, and corporate made tag list provided from a metadata generating company can be used in this function.

0. Register tag lists

1. Activate ScenePlay

2. Recommend process

3. Send/receive list of tags

4. Select tag (input operation)

5. Play contents from tagged position

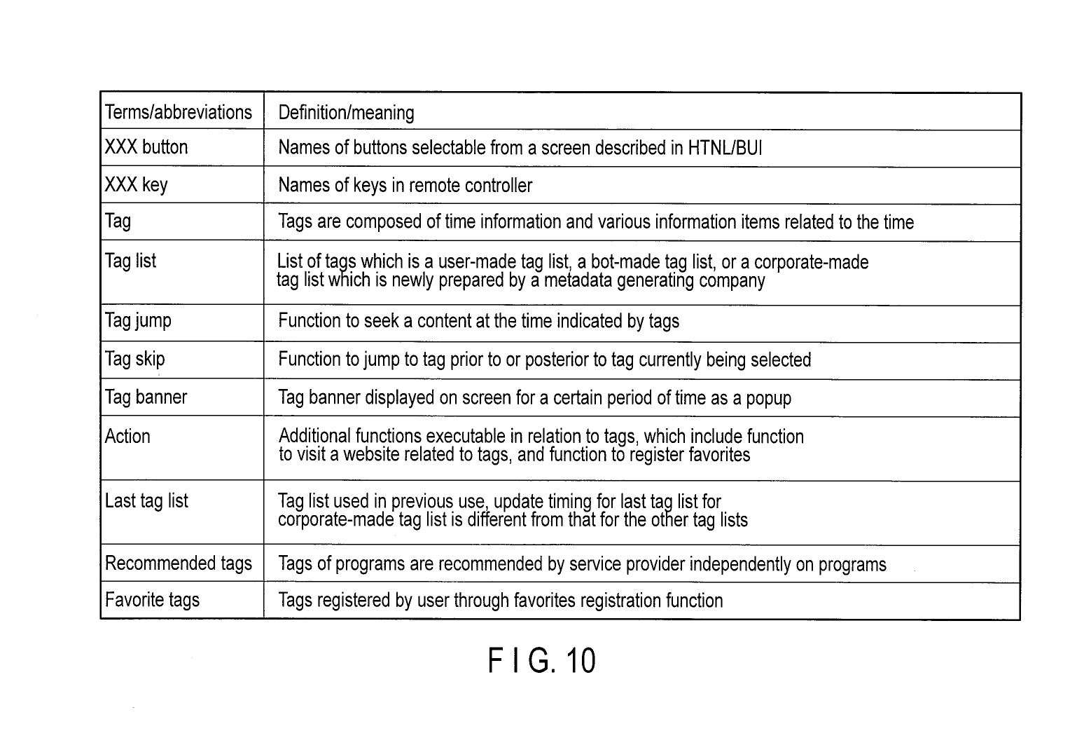

FIG. 10 indicates definitions/meanings of terms/abbreviations used in the present embodiments.

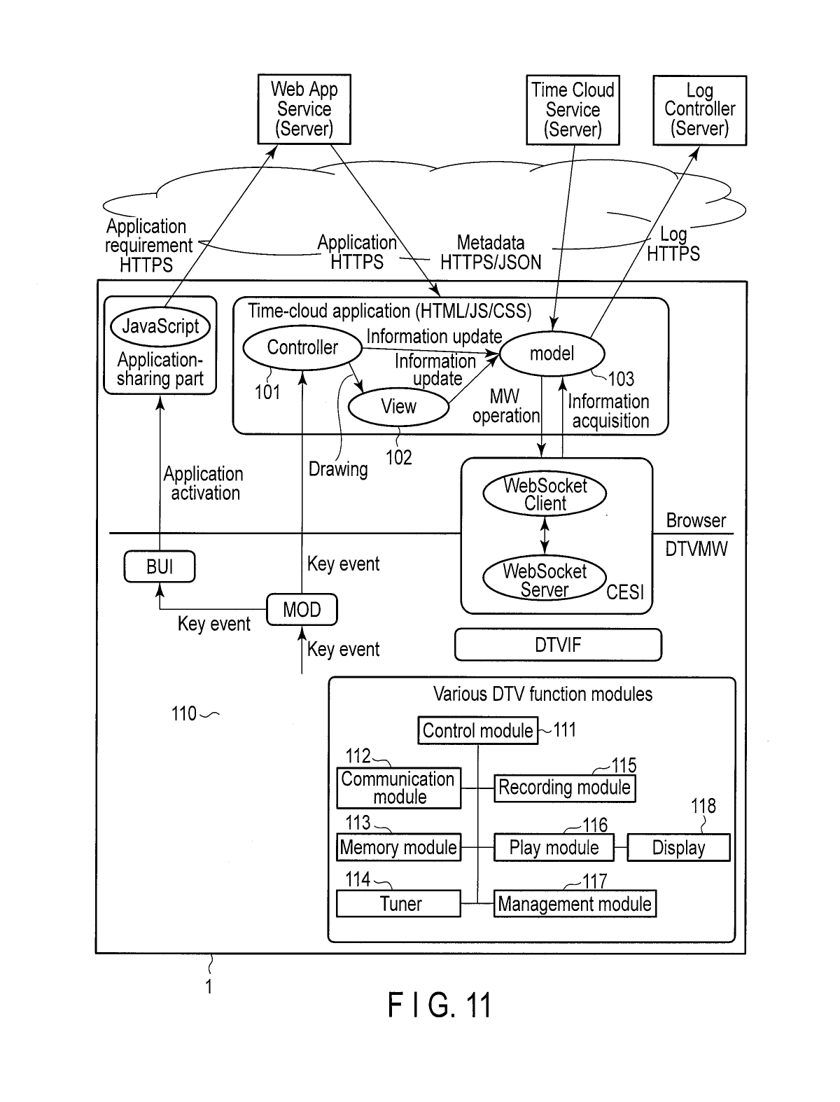

FIG. 11 shows an example of schematic structure of the player of the present embodiments. The time cloud application of the player 1 is roughly divided into a controller 101 used for a key event process, a view 102 used for display, and a model 103 used for information acquisition from DTV MW and servers and DTV operation. A DTV multifunction module 110 includes a plurality of modules to achieve the Scenefo/SceneList/ScenePlay function, together with a module to achieve basic functions of the DTV such as playing and recording of contents and a module to retrieve contents and scenes. The DTV multifunction module 110 includes, for example, a control module 111, communication module 112, memory module 113, tuner 114, recording module 115, play module 116, management module 117, and display 118.

(Scene List Edit Process)

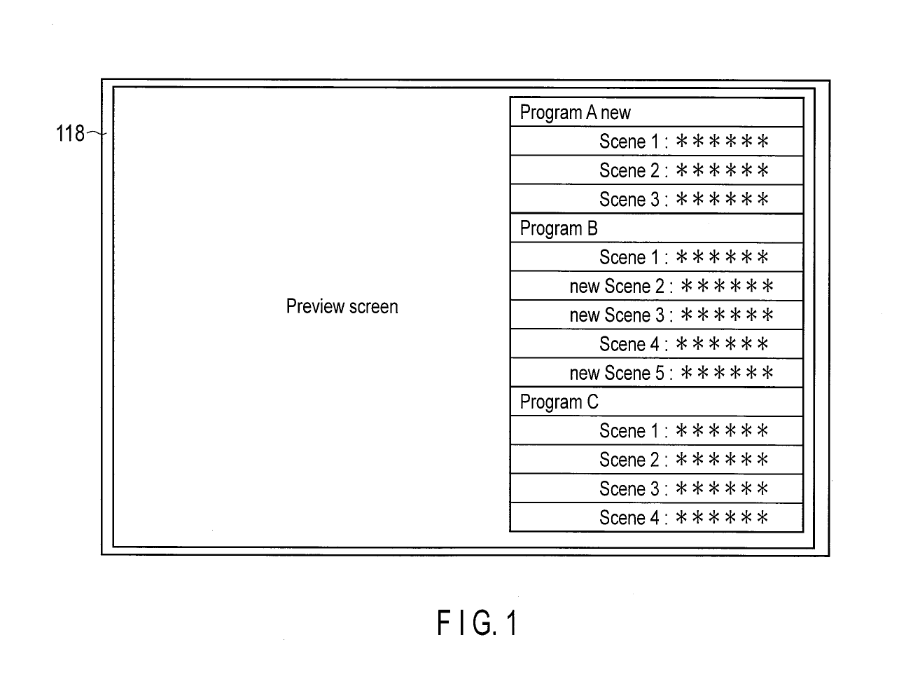

FIGS. 1 to 4 show how the player 1 (scene management device) shown in FIG. 11 outputs a play screen (scene list display screen) in a sequential scene play. The player receives information (including a plurality of scene information items) related to a plurality of scenes in a plurality of contents of a plurality of genres, and outputs a scene list including a plurality of scene information items sorted out based on sorting conditions corresponding to the genres.

That is, the player receives information related to scenes included in contents of genres, and displays scene listings included in the information. Further the player can display first scene listings sorted out in a first sorting order when an operation is performed with respect to a first scene in a first content of a first genre in the scene listings, and can display second scene listings sorted out in a second sorting order different from the first sorting order when an operation is performed with respect to a second scene in a second content of a second genre different from the first genre in the scene listings.

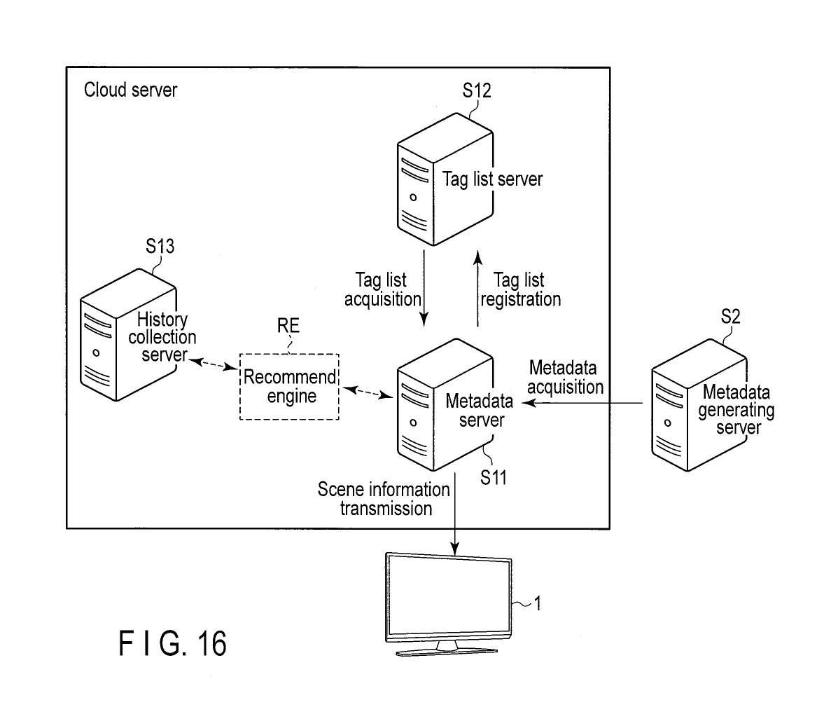

The player 1 (communication module 112) sends a process history (indicating, for example, prescheduled recording, execution of recording, prescheduled playing, and execution of playing) to a cloud server (which is composed of metadata server S11, tag list server S12, history collection server S13, and recommend engine RE shown in FIG. 16). The cloud server collects process histories, performs a recommendation process based on the collected process histories, extracts scene information items to be recommended, and sends the extracted scene information items to the player 1. For example, if the player 1 sends a process history indicative of prescheduled recording of content A to the cloud server, the cloud server then extracts scene information items of content A for recommendation, and sends the extracted scene information items of content A to the player 1. Or, for example, after content A has been broadcast (after the player 1 has recorded content A), the cloud server (metadata server S11) sends the scene information items of content A to the player 1.

Furthermore, the player 1 has a highlight scene play function which is controlled by, for example, the control module 111 and the play module 116 of the player 1. For example, the player 1 can send retrieval keywords or words of the day to the cloud server, and in response to this, the cloud server extracts a scene information item including any of the retrieval keywords or the words of the day and sends the extracted scene information item to the player 1. If the cloud server extracts a plurality of scene information items including any of the retrieval keywords or the words of the day, the cloud server sends the plurality of scene information items to the player 1. Or, if the cloud server extracts a plurality of scene information items including any of the retrieval keywords or the words of the day, the cloud server generates a scene list including the plurality of scene information items and sends the scene list to the player 1 instead. For example, the cloud server generates a scene list including the plurality of scene information items sorted out based on the sorting conditions corresponding to the genre of the contents. Or, the cloud server generates a scene list including the plurality of scene information items sorted out based on the sorting conditions corresponding to the genre of the contents, the scene information items with viewing history reflected therein. Note that the cloud server retains the management information related to the contents playable in the player 1 (for example, contents recorded by the player 1) from the process histories of the player 1, and extracts one or more scene information items including any of the retrieval keywords or the words of the day from a plurality of scene information items related to a plurality of scenes in the plurality of contents playable in the player 1. Then, the cloud server sends the extracted one or more scene information items (or a scene list including the plurality of scene information items) to the player 1.

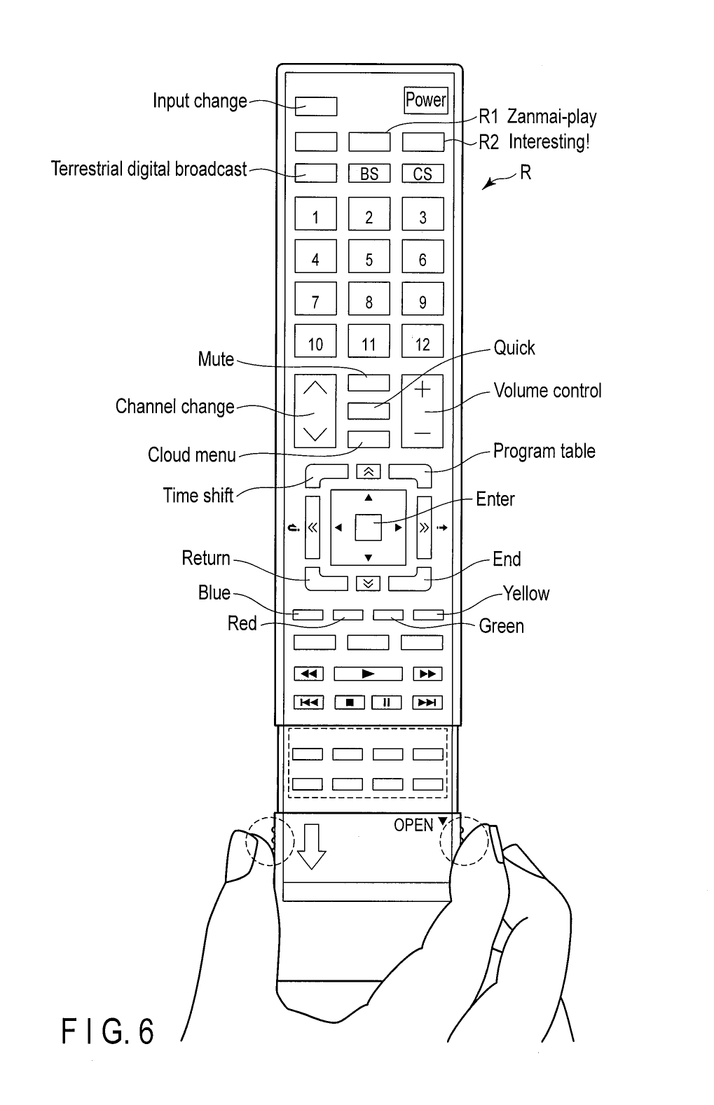

Note that the retrieval keywords and the words of the day may be input to the player 1 by a user using a remote controller R shown in FIG. 6 or the like or may be transferred to the player 1 from a mobile terminal 2.

The player 1 (communication module 112) receives a plurality of scene information items from the cloud server, and then, the player 1 (control module 111, play module 116, management module 117, and display 118) generates a scene list including the plurality of scene information items and outputs (displays) the scene list. For example, the player 1 generates a scene list including the plurality of scene information items sorted out based on the sorting conditions corresponding to the genre of the contents. Or, the player 1 generates a scene list including the plurality of scene information items sorted out based on the sorting conditions corresponding to the genre of the contents, the scene information items with viewing history reflected therein. Or, the player 1 receives a scene list including the plurality of scene information items from the cloud server and outputs (displays) the scene list. What is displayed in the scene list is prepared based on a comparison between the metadata obtained from the server to a plurality of recording contents.

FIGS. 1 to 4 show examples of a scene list display screen. The scene information includes, for example, the information related to a corresponding content (title of the content, channel number of the content, date of broadcast of the content, and the like), the information related to a corresponding scene (explanation, comment, and the like), and runtime of the corresponding scene in the corresponding content (the time to start playing and the time to end playing).

For example, if a user selects (designates playing) one scene information item from the plurality of scene information items using, for example, the remote controller R shown in FIG. 6, the play module 116 in the player 1 starts to play the content including a scene corresponding to the selected scene information item. That is, the play module 116 in the player retrieves the scene corresponding to the selected scene information item to be played and plays the retrieved scene which is output (displayed) by the display 118. Furthermore, if the user presses an up cursor key or a down cursor key of the remote controller R, the play module 116 plays the scene which is next or previous to the scene currently being played.

Here, the cloud server extracts the scene information item including the retrieval keyword or word of the day in the above-description; however, no limitation is intended thereby. That is, the player 1 may extract the scene information item including the retrieval keyword or word of the day from the plurality of scene information items received in advance from the cloud server.

Now, a contents recording function of the player 1 is explained. The contents recording function can be divided into automatic recording and designated recording. For example, if the automatic recording is used to have the recording module 115 of the player 1 record the contents broadcast in a plurality of channels, the contents recorded automatically are stored in a first region of the memory module 113 for a certain period of time, and afterwards, the contents are erased or replaced with the other contents. That is, the contents stored in the first region of the memory module 113 are unprotected. If the designated recording is used to have the recording module 115 of the player 1 record the designated contents broadcast in the designated channels, the contents recorded by the designated recording are stored in a second region of the memory module 113. The contents stored in the second region of the memory module 113 are kept untouched unless they are deleted intentionally.

For example, the scene information items corresponding to the plurality of scenes in the plurality of contents recorded by the contents recording function of the player 1 are retrieval targets of the retrieval keywords and the words of the day.

With the highlight scene play function, the player 1 can provide (display) in an instant retrieval results of the scenes (a scene list) requested by the user from the bulk recorded contents. Using the scene list, the user can easily view the desired scene or the contents including the desired scene. Furthermore, a scene list on which the viewing history is reflected can be provided (displayed) in an instant using one or any optional combination of scene list edit processes (1) to (7) described below. If the viewing history is reflected upon the scene list, the program previously viewed can be ranked at the top or bottom of the scene list. Furthermore, if the viewing history is switched between active and inactive states genre-by-genre, the ranking in the list can better fit the needs of the user.

(1) In the player 1 (management module 117) or cloud server (history collection server S13 and the like), the viewing history of the contents is managed. As explained above, the cloud server receives the process history, and based thereon, manages the viewing history of the contents played in the player 1. For example, if the player 1 plays a scene of content B (hereinafter referred to as scene B1) for a certain period of time (for example, more than 5 minutes), the player 1 then manages the information indicative of an already-viewed status of the content B and the information indicative of an already-viewed status of the scene B1, and if the player 1 plays a scene of content C (hereinafter referred to as scene C1) for a certain period of time, the player 1 then manages the information indicative of an already-viewed status of the content C and the information indicative of an already-viewed status of the scene C1. Furthermore, the cloud server manages the same information.

Based on the information indicative of the already-viewed status, the player 1 or the cloud server reflects the viewing history in the scene list. That is, the player 1 or the cloud server can reflect the viewing history in the scene list which is made from the retrieval results of the retrieval keywords or the words of the day (for example, “World Cup”). As shown in FIG. 1, the scene list is displayed on the right side of the screen, and the scene list indicates that all of the scenes of program A are unviewed. The scene list includes an unviewed program guidance which indicates the unviewed status of program A (for example, characteristic information such as “new”). Furthermore, based on the status indicating that scenes 2, 3, and 5 of program B are unviewed, the scene list includes an unviewed program guidance which indicates the unviewed status of each of the scenes 2, 3, and 5 of program B (for example, characteristic information such as “new”). Note that, in FIG. 1, each of scene 1, scene 2, scene 3, and the like is the identification information of the extracted scene and it does not mean that these scenes 1, 2, 3, and the like are the scenes sequential in one program.

As can be understood from the above, the player 1 or the cloud server generates the scene list in which the viewing history is reflected and the player 1 outputs (displays) the scene list in which the viewing history is reflected. Referring to the unviewed program guidance in the scene list, the user can recognize whether the program and the scene are already-viewed or unviewed.

(2) Considering a case where the player 1 is used by a plurality of users, the player 1 (management module 117) registers a plurality of user accounts and manages the viewing history for each user account. The cloud server receives the process history from the player 1, and based thereon, manages the viewing history of each user account in the player 1. For example, upon the input by a user account UA1, the player 1 allows the login of the user account UA1. During the login state of the user account UA1, if a scene of content B (hereinafter referred to as scene B1) is played for a certain period of time, the player 1 then associates the user account UA1 with the information indicative of an already-viewed status of the content B and the information indicative of an already-viewed status of the scene B1 for the information management, and if a scene of content C (hereinafter referred to as scene C1) is played for a certain period of time, the player 1 then associates the user account UA1 with the information indicative of an already-viewed status of the content C and the information indicative of an already-viewed status of the scene C1 for the information management.

During the login state of the user account UA1, the player 1 or the cloud server reflects the viewing history in the scene list based on the information indicative of the already-viewed status associated with the user account UA1.

If the player 1 allows a login of a different user account, for example, UA2, the above is performed similarly.

As can be understood from the above, the player 1 or the cloud server generates the scene list in which the viewing history of each user account is reflected and the player 1 outputs (displays) the scene list in which the viewing history of each user account is reflected. By the login using his/her user account, the user can recognize whether the program and the scene are already-viewed or unviewed referring to the unviewed program guidance corresponding to his/her user account in the scene list.

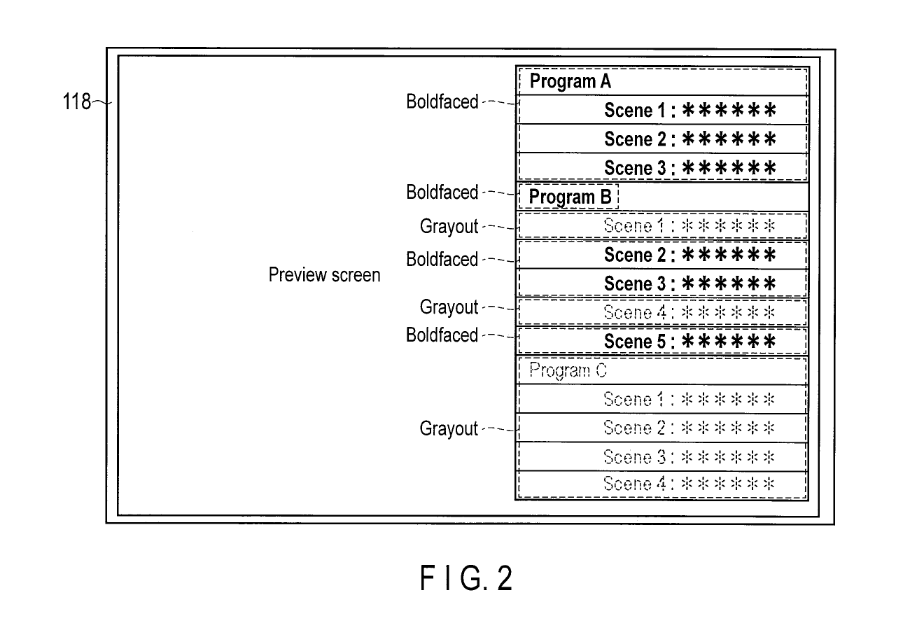

(3) The player 1 or the cloud server reflects the viewing history in the scene list based on the already-viewed information. For example, as shown in FIG. 2, the scene list indicates that all of the scenes of program A are unviewed showing characteristic information of program A and scenes 1, 2, and 3 of program A displayed in bold type. Furthermore, corresponding to the unviewed status of each of scenes 2, 3, and 5 of program B, the scene list shows characteristic information of the scenes 2, 3, and 5 of program B in bold type. Corresponding to the already-viewed status of each of scenes 1 and 4 of program B, the scene list shows characteristic information of the scenes 1 and 4 of program B displayed in grayout type. Corresponding to the already-viewed status of each of scenes 1 to 4 of program C, the scene list shows characteristic information of the scenes 1 to 4 of program B in grayout type.

As can be understood from the above, the player 1 or the cloud server generates the scene list in which the viewing history is reflected and the player 1 outputs (displays) the scene list in which the viewing history is reflected. Referring to the differences in the display format of the characteristic information in the scene list, the user can easily recognize whether the program and the scene are already-viewed or unviewed.

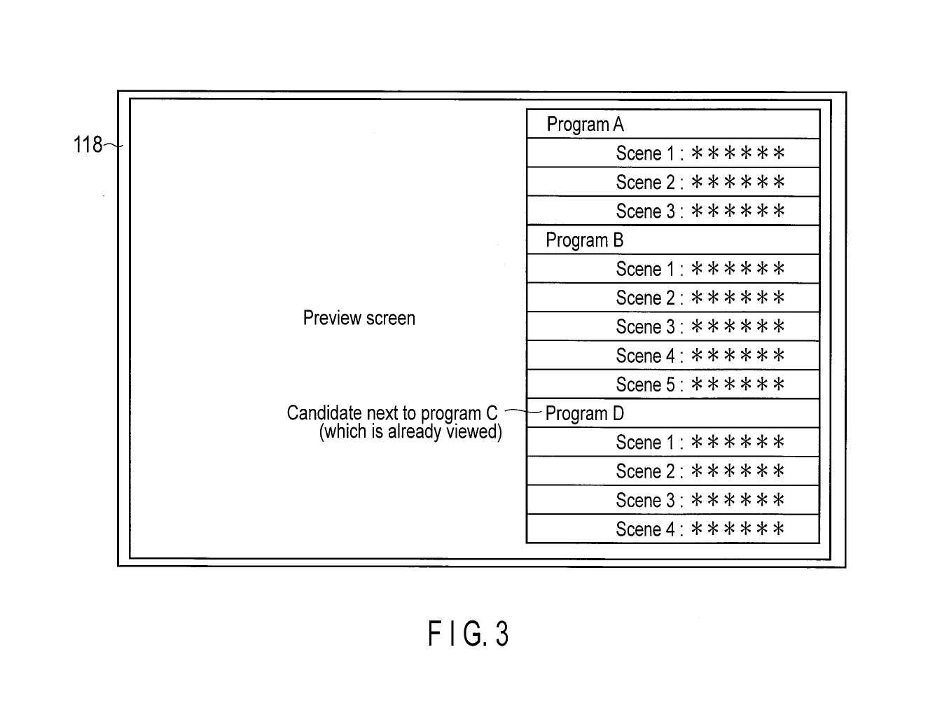

(4) The player 1 or the cloud server generates a scene list based on the already-viewed information. For example, as shown in FIG. 3, the player 1 or the cloud server generates the scene list excluding the scene information of the already-viewed program C based on the user setting. Or, the player 1 or the cloud server generates the scene list which ranks the already-viewed program C at the bottom of the list based on the user setting. The above-described scene list can be generated scene-by-scene instead of program-by-program.

Referring to the scene list excluding the already-viewed programs, the user can select and view a scene of a desired program.

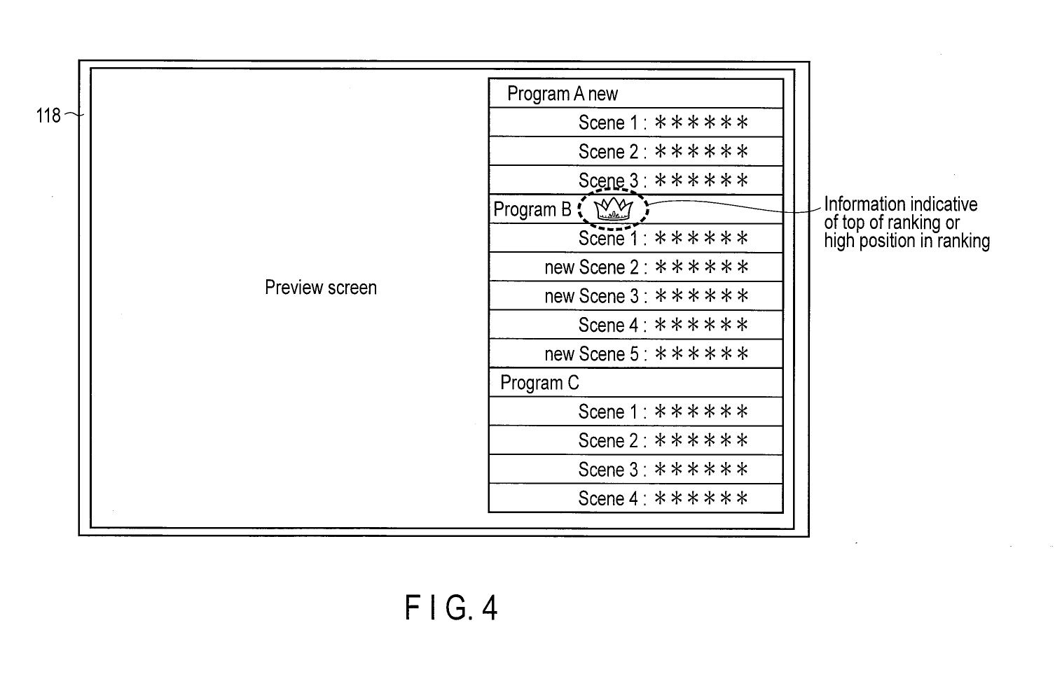

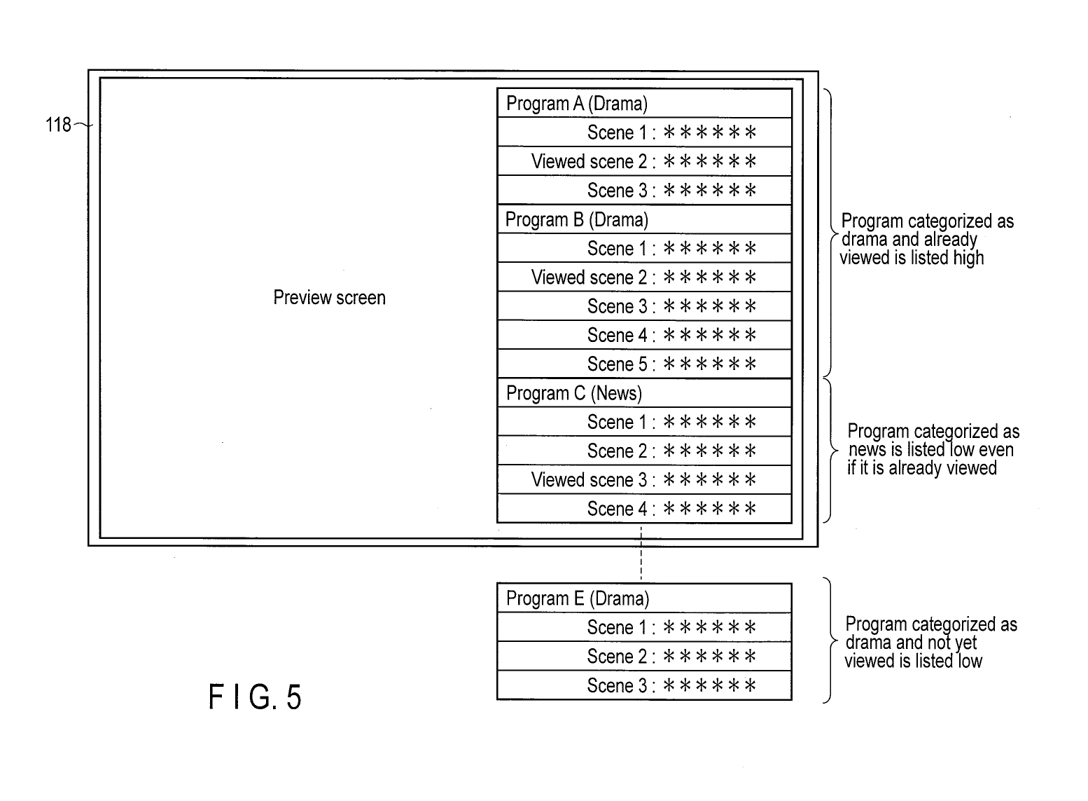

(5) The cloud server can collect process histories from a plurality of players 1 to generate a view rating ranking and the like based on, for example, recording schedule information and play information of each program, and can send the view rating ranking to the players 1. For example, based on the view rating ranking, the player 1 or the cloud server can generate a scene list in which the view rating ranking is reflected. As shown in FIG. 4, the scene list indicates that the program B is the highest in the view rating ranking or within the top ten of the ranking, and includes a higher view rating guidance (for example, a crown mark) indicative that the program B is the highest in the view rating ranking or within the top ten of the ranking. The above-described scene list can be generated scene-by-scene instead of program-by-program.

Referring to the scene list in which the view rating ranking is reflected, the user can select and view a scene of a highly ranked program. Furthermore, referring to both the viewing history and the scene list in which the view rating ranking is reflected, the user can select and view a desired scene.

(6) The player 1 or the cloud server generates a scene list including a plurality of scene information items sorted out based on sorting conditions corresponding to program genres, and the player 1 outputs (displays) the generated scene list. For example, the player 1 or the cloud server generates scene information items of a first genre (for example, drama) and scene information items of a second genre (for example, news), the scene information items of the first genre sorted out based on a first sorting condition (for example, viewing history) and a second sorting condition (for example, date of broadcast) set for the first genre, and the scene information items of the second genre sorted out based on the second sorting condition (for example, date of broadcast), and outputs a scene list including the sorted scene information items. The details are described hereinafter.

Program information corresponding to each program includes, for example, program ID, program title, genre, time to start broadcast, and runtime of program. The player 1 or the cloud server can retrieve the genre of the program from the program information. Furthermore, the player 1 or the cloud server can manage (store) sorting conditions corresponding to each genre. For example, in response to the input operation of the user and the like, the player 1 or the cloud server can manage (store) the first and second sorting conditions set for the first genre and the second sorting condition set for the second genre.

Now, the followings are given for explanation. The first genre is a drama, and the first sorting condition is to sort out the scene information items of the contents of the first genre having the viewing history for the first priority. The second sorting condition is to sort out the scene information items by the order of the date of broadcast for the second priority (which is less prior to the first priority).

Or, the first sorting condition is to sort out the scene information items of the previously-retrieved contents of the first genre having the viewing history for the first priority, and a third sorting condition is to sort out the scene information items of the previously-retrieved contents of the first genre having no viewing history for a third priority (which is less prior to the second priority).

Based on the above sorting conditions, the player 1 or the cloud server sorts out the scene information items of the contents of the first genre (for example, drama) using both the viewing history and the date of broadcast and sorts out the scene information items of the contents of the second genre (for example, news) using the date of broadcast alone. For example, programs such as drama, movie, animation, documentary, sports (continuously-viewed program) are generally played from the very beginning to the ending of the program (continuously viewed). Thus, if the program of the first genre has been (previously retrieved and) viewed, the user may probably be interested in the program, and if the program of the first genre has not been (previously retrieved or) viewed, the user may not be interested in the program. On the other hand, programs such as news, music, variety, report, and information are generally played partly, that is, sequence-by-sequence and segment-by-segment. Thus, even if the program of the second genre has been (previously retrieved and) viewed, whether or not the user is interested in the program is difficult to determine.

The player 1 or the cloud server can output (display) the scene list to which such conditions are reflected. For example, if a scene information item of a drama program which has been retrieved previously but never been viewed is now retrieved again, the entire scene information items of the program are determined to match the sorting condition of being previously-retrieved but having no viewing history and they are ranked (displayed) lower in the list. In contrast, if a scene information item of a drama program which has been retrieved previously and viewed is now retrieved again, the entire scene information items of the program are determined to match the sorting condition of being previously-retrieved and having the viewing history and they are ranked (displayed) higher in the list.

Here, if a scene information item of a news program which has been retrieved previously but never been viewed is now retrieved again, the scene information items of the program are ranked (displayed) based on the date of broadcast of the program (regardless of the viewing history). If a scene information item of a news program which has been retrieved previously and viewed is now retrieved again, the scene information items of the program are ranked (displayed) based on the date of broadcast of the program (regardless of the viewing history).

The sorting conditions can be optionally set genre-by-genre by the user, and based on the settings by the user, the player 1 can output (display) the scene list in which programs such as drama and the like are ranked based on their viewing history and date of broadcast and programs such as news and the like are ranked based on their date of broadcast.

(7) The player 1 switches a user interface (UI) display in scene information depending on the genre of the scene information. For example, in the scene information of a drama, there are an input button used to give high evaluation (or low evaluation) to a single scene and a general input button used to give high evaluation (or low evaluation) to the entire scenes. In the scene information of a news program, there is an input button used to give high evaluation (or low evaluation) to a single scene.

The user may evaluate the entire scenes of the drama program at a time using the scene information of the drama program.

(8) The player 1 or the cloud server generates a scene list based on the information of rerun of programs or the like, and the player 1 outputs (displays) the generated scene list. For example, the scenes showing high similarity can be ranked lower in the list. Otherwise, the scenes showing high similarity can be omitted from the list.

Through the above scene list edit processes, the player 1 or the cloud server can generate a scene list and output (display) the generated scene list. Thus, a user can easily select an unviewed scene or already-viewed scene from a scene list in which the viewing history is reflected. Furthermore, the user can easily select a desired scene from the scene list including a plurality of scene information items sorted out based on sorting conditions corresponding to genres.

Note that all of the above processes (scene list edit processes) can be executed by software. Thus, the above processes can easily be achieved by simply installing a program to execute the above processes in a computer using a computer readable storage medium storing such a program.

For example, the player 1 can download the above program through the communication module 112 or the like, and store the downloaded program to complete the install of the program. Thus, the player 1 which corresponds to the above-mentioned computer can easily achieve the above processes (scene edit) based on the installed program.

Furthermore, the player 1 can read the above program from a computer readable storage medium, and store the read program to complete the install of the program.

(Scene Play Details)

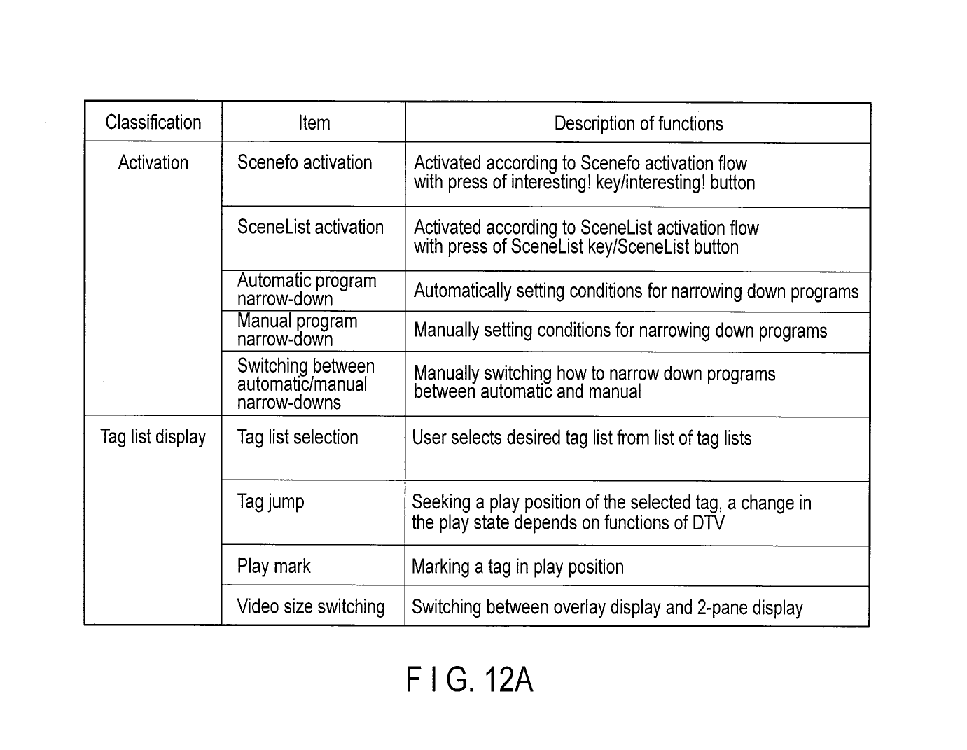

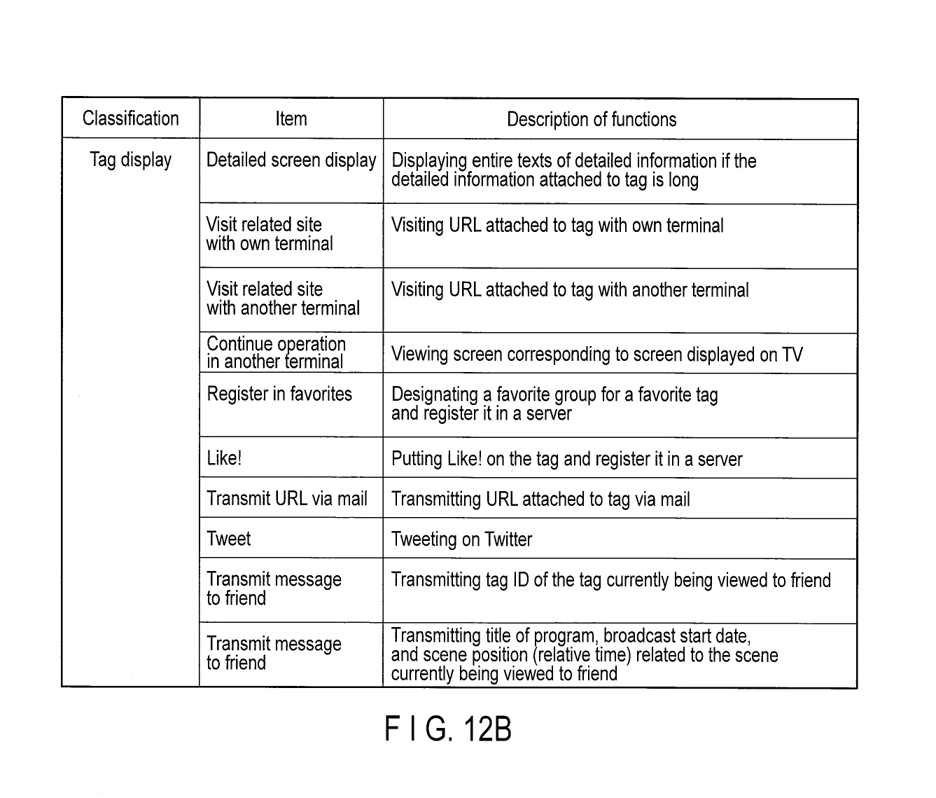

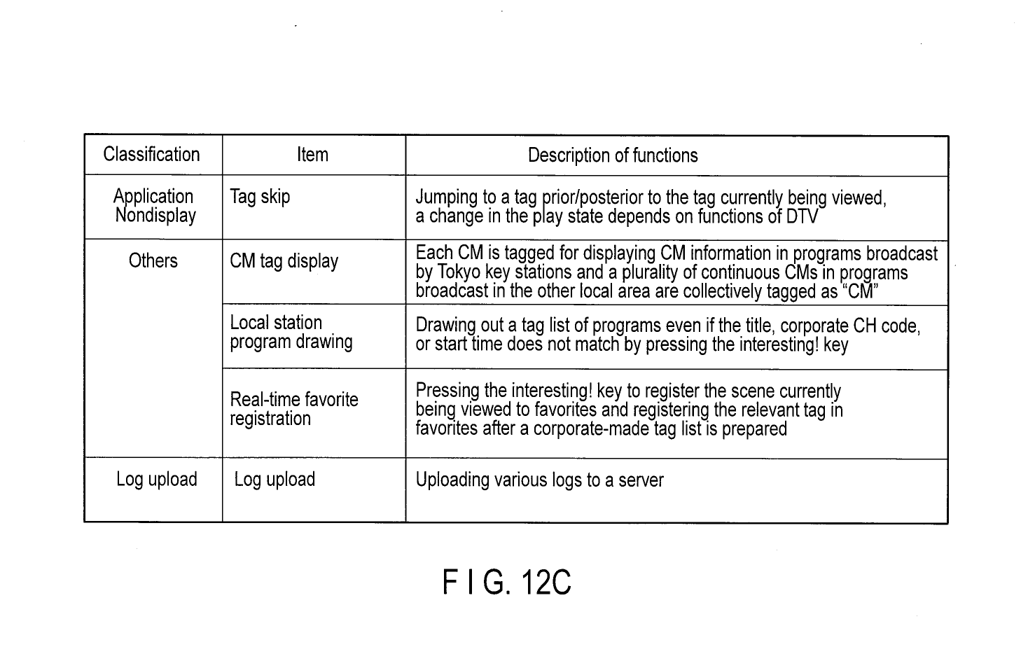

FIGS. 12A, 12B, and 12C show an example of Scenefo and SceneList functions.

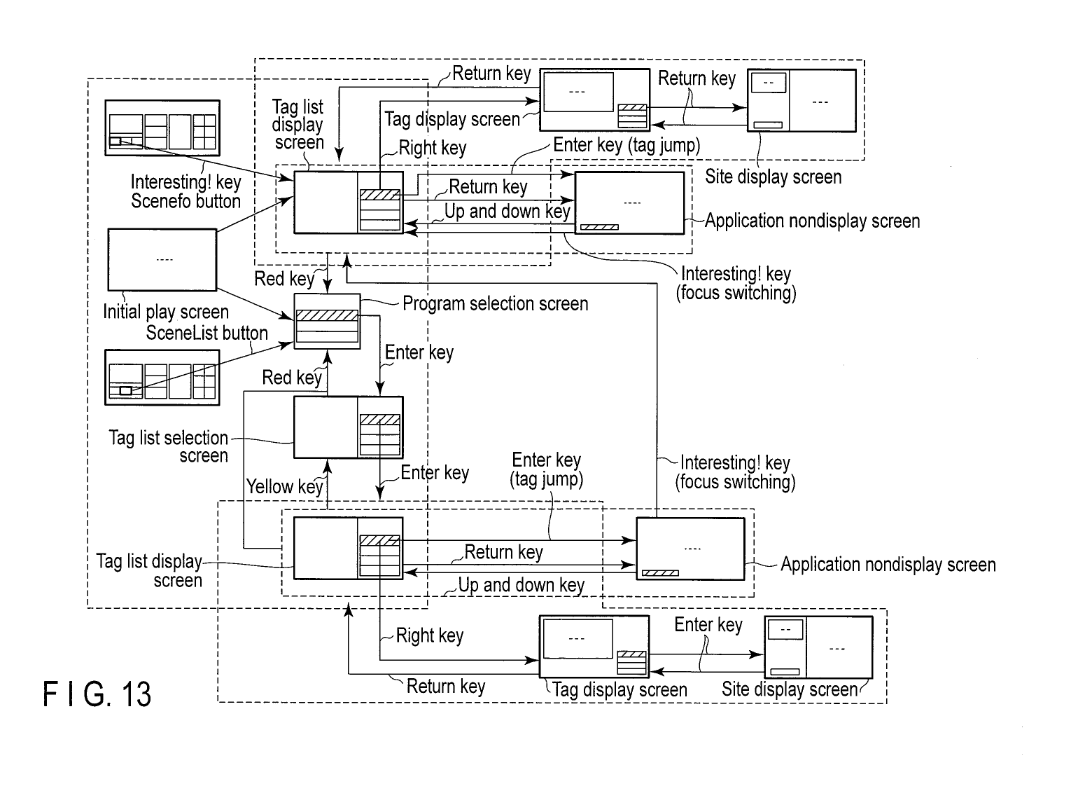

FIG. 13 shows an example of how the screen transition is performed between Scenefo/SceneList.

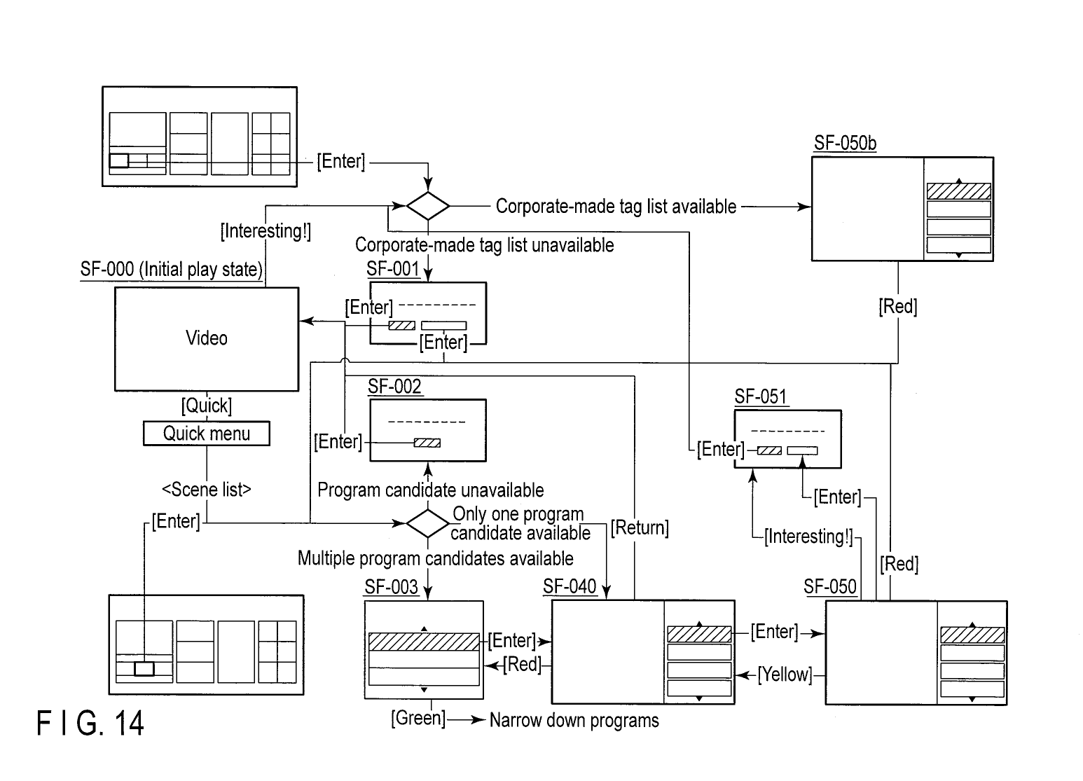

In a digital TV (DTV), the Scenefo/SceneList application is inactivated at the time when visual contents are started (initial play screen), and the Scenefo/SceneList application is activated for the first time by the user operation. A browser is activated at the same time when the application is activated. FIG. 14 shows screen transitions during the activation of the application. At the time of the screen transitions, data related to a tag list are acquired from a metadata server.

Now, the metadata server and the like are explained in detail.

The metadata server is a server to manage program metadata information required to achieve the Scenefo, SceneList, and ScenePlay functions of the time cloud service. The metadata used in this service are acquired from a metadata generating sever of the data provider. The metadata server uses the acquired metadata to generate a scene information item indicative of detailed information of one scene in a program, and sends the generated scene information items to the player.

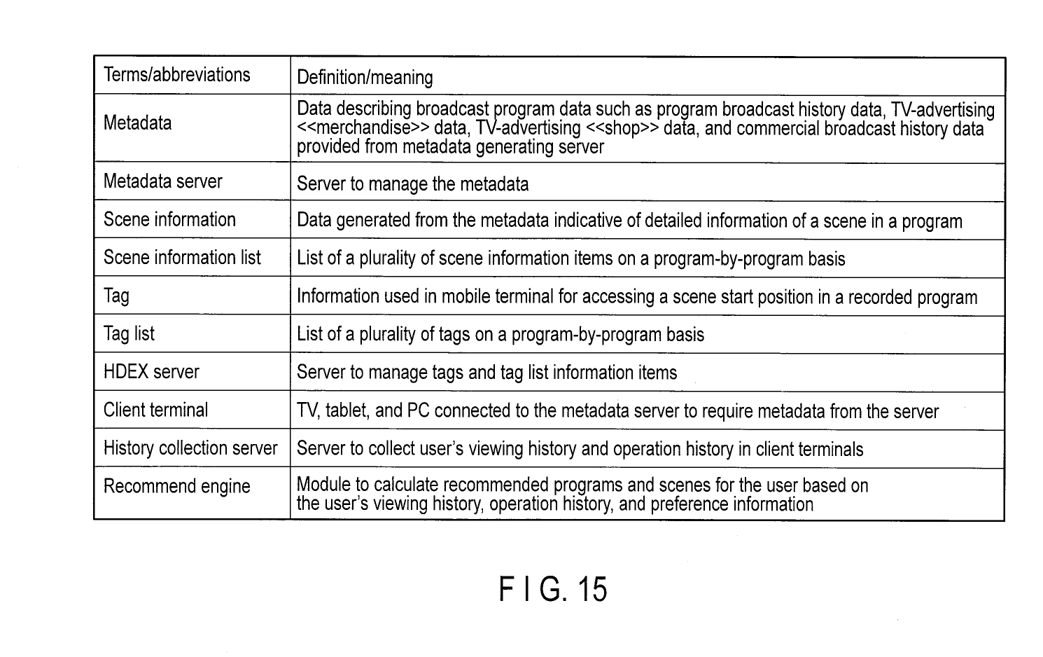

FIG. 15 indicates definitions/meanings of terms/abbreviations used in the present embodiments.

FIG. 16 shows an example of a cooperative work among servers used in the embodiments.

The metadata server S11 acquires metadata from a metadata generating server S2 and stores the acquired metadata in a database of the metadata server S11. Part of the acquired metadata are converted into a format compatible with a tag processing application in a terminal and registered in a tag list server S12 which manages the tag list information. In response to a request from the player, the metadata server S11 converts the requested metadata into the scene information and sends the scene information to the player. The player can acquire the user made tag list information used in the time cloud service from the tag list server S12 through the metadata server S11.

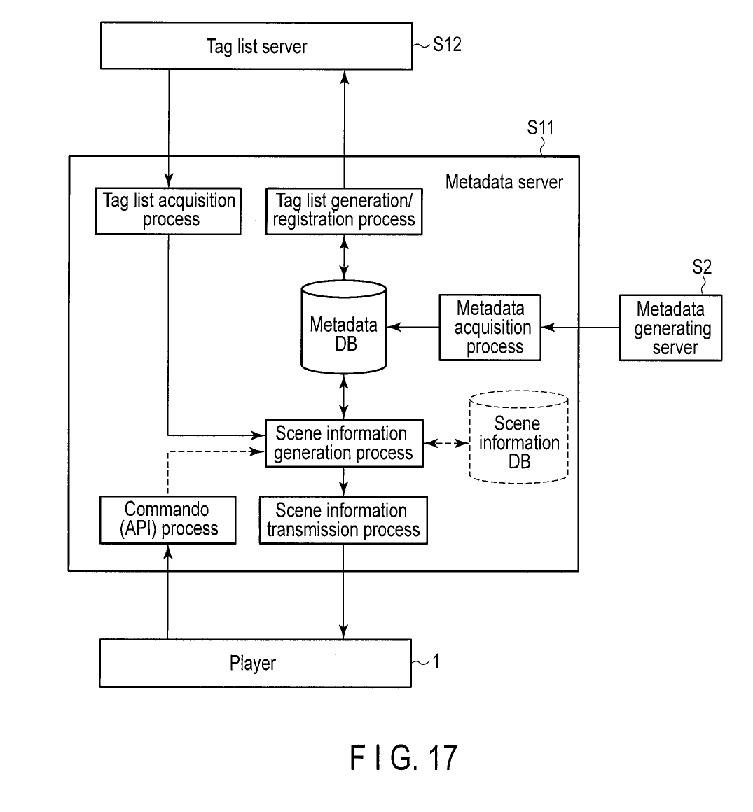

FIG. 17 shows an example of a schematic structure of the metadata server of the embodiments.

The metadata server performs the following functions.

(1) Command (Web API) Process

The metadata server S11 acquires various data and provides the data to the player. For example, the metadata server S11 acquires the following data to provide them to the player.

<Scene Information List>

The metadata server S11 acquires a scene information list of the programs matching designated conditions. If there are a plurality of scene information lists of the programs matching the designated conditions, all of the lists are acquired. If there is not a scene information list of the programs matching the designated conditions, a no match result is notified. A user made tag list registered in the tag list server S12 can be included in the scene information lists to be acquired.

<List of Programs Having Scene Information List>

The metadata server S11 acquires a list of programs in a scene information list matching the designated conditions. Programs associated with a user made tag list registered in the tag list server S12 can be included in the list of the programs to be acquired.

<List of Scene Information List>

The metadata server S11 acquires a list of scene information lists registered in designated programs. A list of user made tag lists registered in the tag list server S12 can be included in the list of the scene information lists to be acquired.

<Scene Information List> (ID Designation)

The metadata server S11 acquires scene information lists of designated IDs. If tag list IDs are designated, the metadata server S11 acquires the user made tag list registered in the tag list server S12.

<Scene Information Retrieval>

The metadata server S11 acquires the scene information list including the scene information items corresponding to designated retrieval conditions. The retrieval conditions may include any optional keyword input by the user.

<Recommended Scene Information>

The metadata server S11 acquires recommended scene information calculated by a recommend engine RE.

<Favorite Scene Information>

The metadata server S11 acquires favorite scene information registered by a user and managed in the server.

(2) Metadata Acquisition Process

The metadata server S11 acquires the metadata provided by the metadata generating server S2. To acquire the metadata provided by the metadata generating server S2, Web API provided by the metadata generating server S2 is used.

(3) Tag List Generation/Registration Process

Program broadcast history data in the metadata are registered in the tag list server S12 as a tag list. The registered metadata are compatible with existing tag lists and available in the terminal via the application.

(4) Scene Information Generation/Transmission process

Scene information is generated based on the metadata acquired from the metadata generating server S2 and transmitted to the player. The processes performed to generate the scene information are described hereinafter.

(4.1) Drawing Program Information

The player transmits the followings to the server: (a) program title (or identification information such as program ID); (b) date of broadcast; and (c) channel number. The metadata server uses (a) program title, (b) date of broadcast, and (c) channel number to search a corresponding program in its database. If there is a corresponding program in which one or more scene information items are registered, the metadata server generates the one or more scene information items of the program, and then transmits the generated information items to the player. If there are several corresponding programs, the metadata server transmits every candidate to the player. If there is not a corresponding program, the metadata server transmits a no match result to the player.

That is, the player transmits the identification information (such as title, date of broadcast, and channel number) of the contents to the metadata server, and receives a plurality of scene information items corresponding to a plurality of scenes of the contents from the metadata server.

(4.2) Retrieving Scene Information

Metadata information corresponding to the retrieval conditions received from the player is retrieved from the database in the metadata server, and a scene information list including the metadata information is transmitted to the player. The metadata to be retrieved are program broadcast history data, merchandise data (name of merchandise, and the like), merchandising corporate data (name of corporate, and the like), shop data, and commercial broadcast history data.

(4.3) Generating Scene Information Items

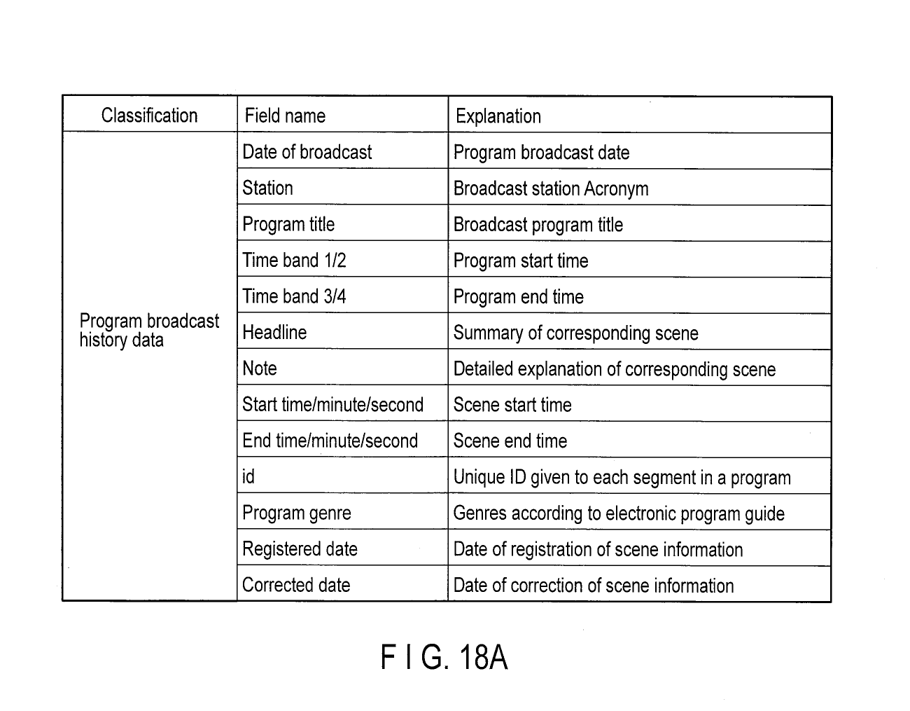

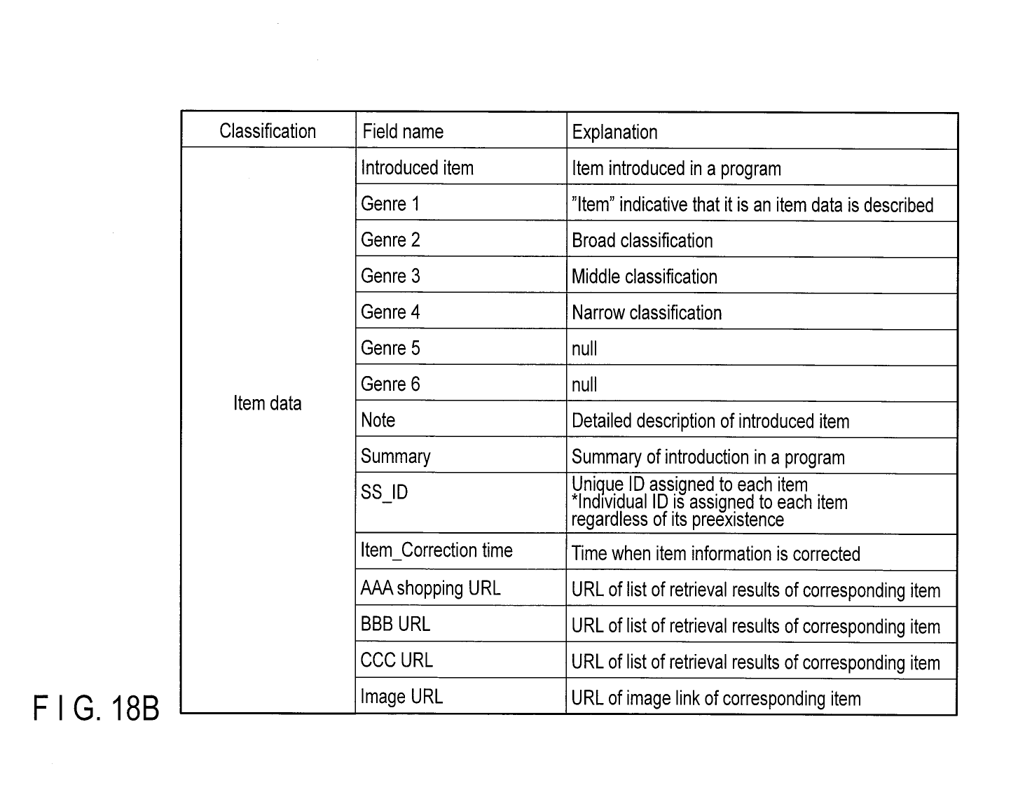

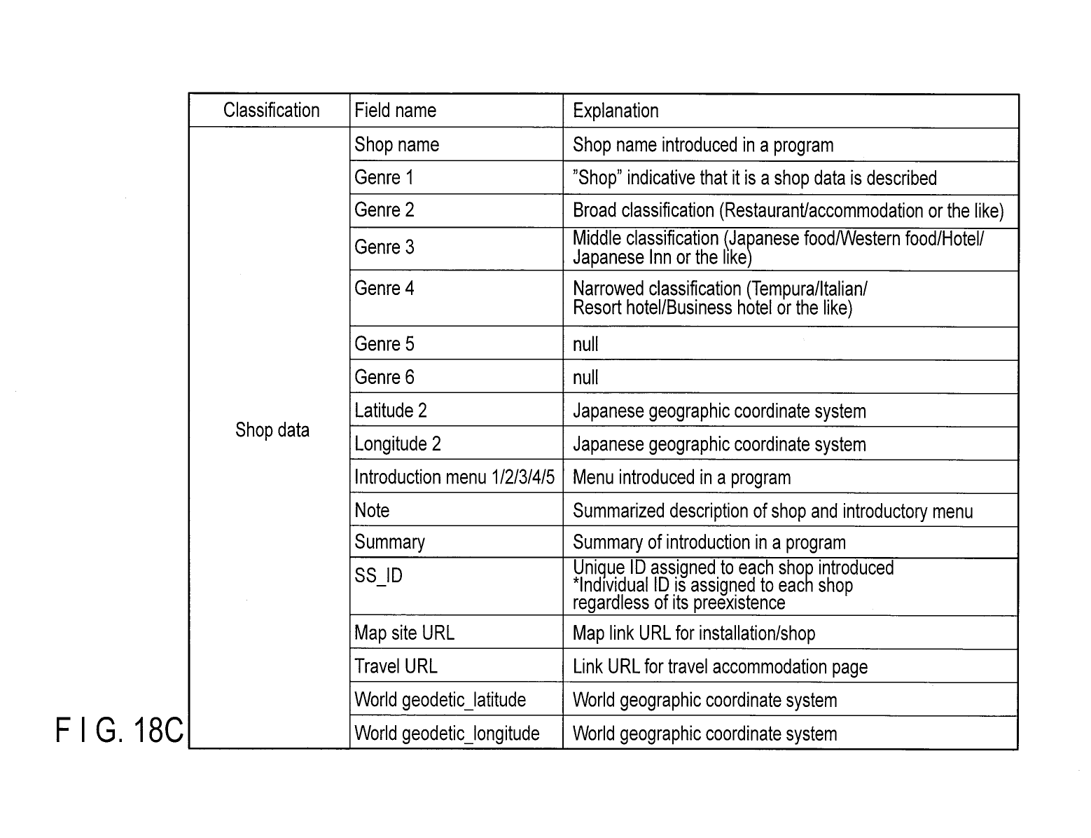

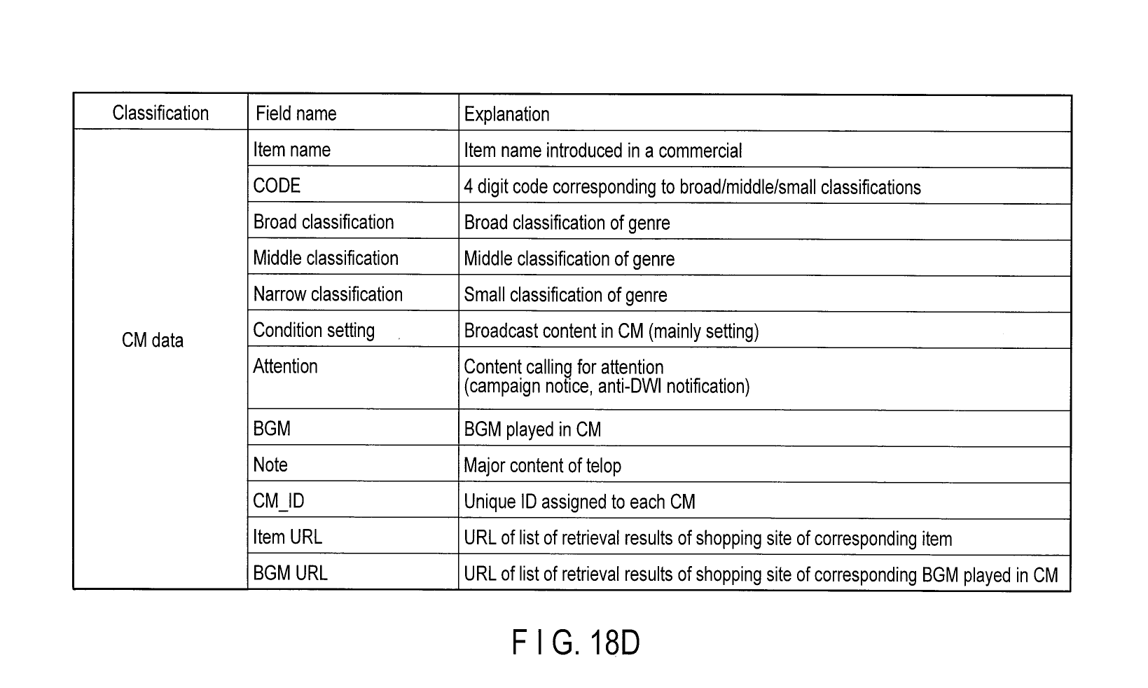

The broadcast history data, merchandise data, merchandising corporate data, shop data, and commercial broadcast history data stored in the database in the metadata server are associated with scene information items to be generated. The scene information items to be generated include the above metadata as shown in FIGS. 18A, 18B, 18C, and 18D.

Note that a scene information item may not include merchandise information or shop information. A scene information item may include a plurality of merchandise data, merchandising corporate data, and shop data associated thereto.

(4.4) Merging Tag List Information and Scene Information

The scene information items generated in the metadata server and tag list information items managed in a tag list server are merged together in response to a request from the player, and the merged information items are transmitted to the player. Here, the tag list information items acquired from the tag list server do not describe a time to end, and thus, in response to the request from the player, the metadata server executes a process to set the time to end the current tag to a time to start a next tag within focused tags.

(4.5) Tag List Acquisition Process

The metadata server acquires the tag list information items registered in the tag list server in response to the request from the player, adds any necessary process to the acquired tag list information items, and transmits them to the player. An API provided by the tag list server is used for the data acquisition from the tag list server. The metadata server acquires the data related to tags and tag lists from the tag list server.

(4.6) Transmission Format Conversion Process

In response to the request from the player, the tag list information items in an XML format acquired from the tag list server are converted into a JSON format and transmitted to the player.

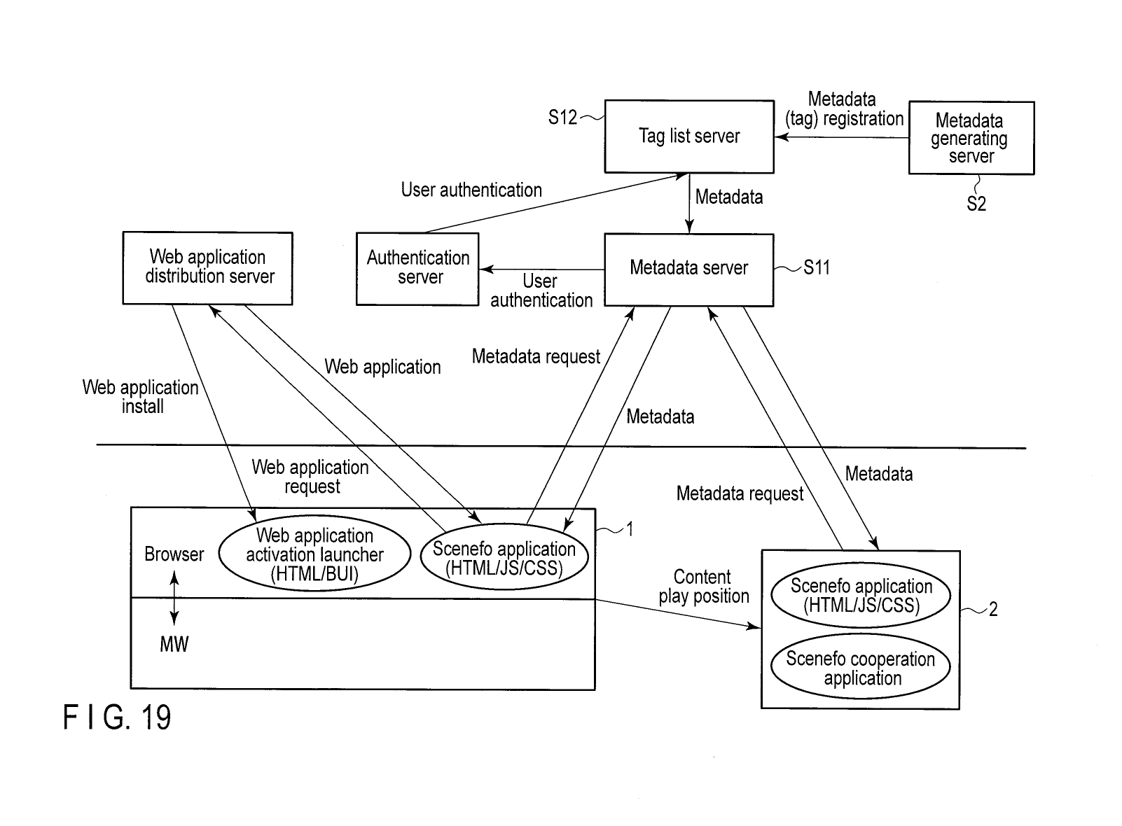

FIG. 19 shows an example of the detailed system structure of the embodiments. As explained above, the system is composed of various servers and player 1 (which is, for example, a DTV), and a mobile terminal 2 (such as tablet PC and smartphone) can be used in the system.

The DTV detects a press of a button or a key and functions corresponding to the button and key actions. For example, if the DTV detects a press of an interesting! button while a program is being played, the DTV accesses the scene information (Scenefo) at that point of time, and activetes various applications to provide services related to the scene. That is, the interesting! button is a button to designate an access to the scene information at a certain point of time during a program play. For example, if the interesting! button is pressed, the above-mentioned Scenefo application is activated and the services related to the scene being played are provided to the user. If the user simply pushes the interesting! button, the DTV and Scenefo application collaborate for offering the services corresponding to the scene being played at that point of time.

For example, if the user presses the interesting! button while the DTV plays a plurality of scenes of a program (contents) successively, the DTV detects the press of the button (scene information request) and switches the screen to the one showing the information (scene information items) related to the scene. The DTV changes the scene information items to be output each time when the scene changes.

For example, while playing a recorded program including a plurality of scenes, the DTV outputs a first scene information item corresponding to a first scene which is currently being played, and together with the first scene information, the DTV outputs a second scene information item corresponding to a second scene which is prior to the first scene and a third scene information item corresponding to a third scene which is posterior to the first scene. Note that the DTV outputs the first, second, and third scene information items together with the image of the program being played while displaying the first scene information item in a display format different from that of the second and third scene information items. For example, the first scene information item is displayed in a first display color and the second and third scene information items are displayed in a second display color.

Here, the scene information is explained in detail.

(1) Upon detecting a selection of an output (displayed) scene information item, the DTV outputs a link (service information) related to the scene which is the origin of the scene information item. Referring to the link (for example, URL of a website for merchandise purchase or of a website for reservation of pre-address header), a user can buy an item related to the scene or reserve a shop providing services related to the scene. Furthermore, the user can transfer the link related to the scene to a car navigation system and refer to a map related to the scene.

(2) Upon detecting a selection of an output (displayed) scene information item, the DTV activates an application related to the scene which is the origin of the scene information item in a mobile terminal.

(3) Upon detecting a selection of an output (displayed) scene information item, the DTV puts the information related to the scene which is the origin of the scene information item in Favorites.

(4) Upon detecting a selection of an output (displayed) scene information item, the DTV outputs a mail sending screen to prepare mail indicative of the information related to the scene which is the origin of the scene information item, and sends the mail in response to a certain selection or an input.

(5) Upon detecting a selection of an output (displayed) scene information item, the DTV dispatches a message of the information related to the scene which is the origin of the scene information item to friends.

Here, a user can press a like! button indicating the user's favored evaluation of the program at any time. Thus, upon detecting a press of the like! button (scene information request) during the play of the program, the DTV accesses the information of the scene being played at that point of time and creates a database of the information of the scene.

The information indicative of the press of the like! button can be associated with a scene tag, a list, a program, or a certain scene.

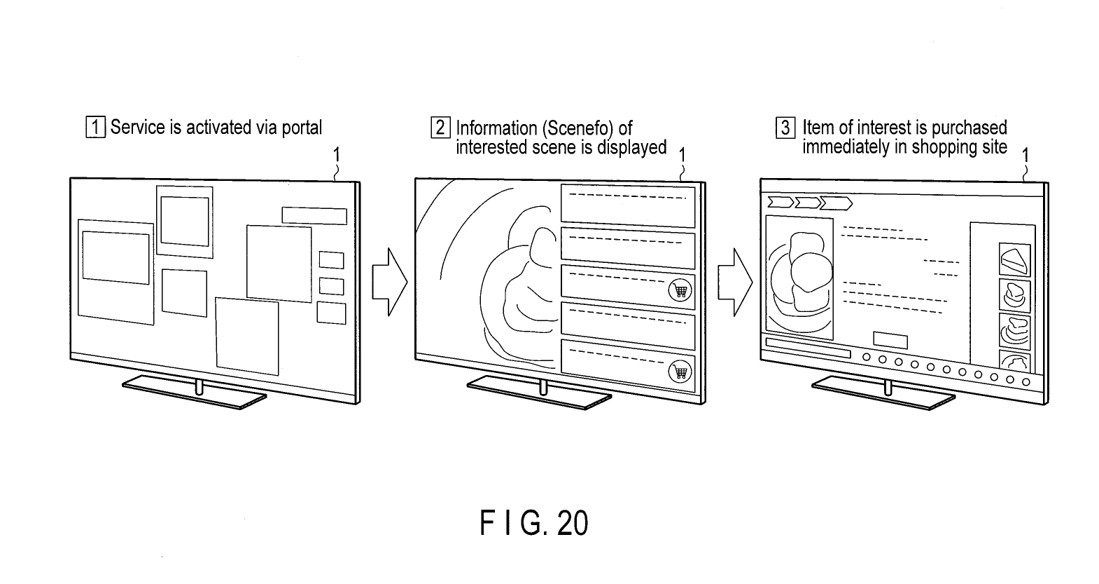

As shown in FIG. 20, the DTV can activate the services from a portal site, and the user can display information of a scene of interest and purchase an item of interest in a shopping site.

As described above, the system of the embodiments can correspond to each of a large number of scenes and provide information related to each scene timely.

Here, the above is further specified.

<Working Mechanism>

Upon detecting a press of a [Scenefo] key while a content in a PVR or a time shift machine is being played, the DTV displays a list of Scenefos focusing on the Scenefo second nearest to the position being played. The above list may be triggered by any other optional input instead of the press of the [Scenefo] key. The time shift machine is a machine to retroactively record the contents broadcast in a plurality of channels (for example, six channels) for a certain period of time (for example, past 15 days) from the present day (the whole record). Thus, if the whole record is performed by the time shift machine, the user can view each and every program broadcast in the past (for example, the past 15 days) at anytime.

For example, the list of Scenefos indicates a part of each Scenefo (only a few lines) as a headline.

If there is not a Scenefo, a dialog box saying “No Scenefo found. Display SceneList?” is displayed, and if yes is chosen, the screen changes to a SceneList selection screen.

Upon detecting a press of an up key or a down key while the list of Scenefos is being displayed, the DTV moves a Scenefo cursor accordingly.

Upon detecting a press of an enter key while the cursor is put on any optional Scenefo, the DTV plays the scene corresponding to the Scenefo on which the cursor is put (play jump).

Upon detecting a press of a return key or an end key while the list of Scenefos is being displayed, the DTV closes the list of Scenefos.

Upon detecting a press of a right key while the list of Scenefos is being displayed and the cursor is put on any optional Scenefo, the DTV displays detailed information of the Scenefo. The detailed information of the Scenefo includes the Scenefo entirely. The detailed information of the Scenefo includes action buttons corresponding to the contents of the Scenefo.

For example, the action buttons correspond to the following functions:

“Put this scene in Favorites”;

“Like!”/“Cancel Like!”/“Counting Like!s”;

“Go to shopping site on TV”;

“Go to shopping site via application”; and

“Send this Scenefo via email”.

Upon detecting a press of the “Put this scene in Favorites” button, the DTV puts the corresponding scene in Favorites (for cases of purchasing related items at once layer and viewing the scene again).

The server manages the Scenefo in Favorites to be shared in a TV/application and the like.

Upon detecting a press of the like! button, the DTV associates the Like! with the Scenefo and uploads a tag indicative of the Like! to the server. Thus, the number of Like!s associated with the Scenefo increases.

Upon detecting a press of the “Go to shopping site on TV” button, the DTV shows a shopping site on a browser.

Upon detecting a press of the “Go to shopping site via application” button, the DTV hands over a URL of a shopping site to an application. The application shows the shopping site based on the URL.

Even if the shopping site is displayed in the DTV, the user may feel it very uncomfortable to finish a payment of shopping with a device such as a remote controller of the DTV alone. Thus, as mentioned above, the DTV transmits the URL of the shopping site to the application installed in the mobile terminal 2 and guide the user to continue the payment of shopping in the application of the mobile terminal 2. The user can use a touch input function of the mobile terminal 2 in his/her hand to finish the payment of shopping and the like.

Note that, in displaying a shopping site, the DTV accepts a mode selection to choose a first mode displaying the shopping site on the DTV or a second mode displaying the shopping site in the mobile terminal 2. If the user selects the second mode, the DTV does not display the shopping site and sends the URL of the shopping site to the application of the mobile terminal 2. For example, the DTV transfers the URL of the shopping site to the application of the mobile terminal 2 via a server. The mobile terminal 2 displays the shopping site referring to the received URL.

Here, the mobile terminal 2 is used to display the shopping site instead of the DTV, but the mobile terminal 2 may be used to display any site or to perform whatever necessary instead of the DTV. That is, the DTV transmits URLs of any optional sites in addition to the shopping site to the mobile terminal 2 to display the sites therein.

Upon detecting a press of the “Send this Scenefo via email” button, the DTV displays an outgoing mail address select screen. The outgoing mail address selection screen shows mail addresses set for mail reservation as candidates and receives a mail address selection. Furthermore, the outgoing mail address selection screen can receive an input of a mail address. If the user selects a mail address and presses the [Send] button, the DTV detects the selected mail address and the press of the [Send] buttton and sends the mail.

Upon detecting a press of switch button while the list of Scenefos or Scenefo details are being displayed, the DTV switches a “full image+overlaying Scenefo” display to/from an “image and Scenefo split half” display.

Upon detecting a press of a left key or a right key while the contents are being played, the contents jump to before or after the Scenefo or SceneList.

The DTV functions based on the data used latest (Scenefo or a specific list in SceneList) and functions based on the Scenefo by default. If there is not a Scenefo and a SceneList has never been used during the play of the contents, the DTV activates nothing.

Upon detecting a press of a [SceneList activate] button while the list of Scenefos is being displayed, the DTV changes its screen to a selection screen of the SceneList.

For example, the DTV has the Scenefos used as one of the tag lists using an existing “use tag lists” function.

Furthermore, based on one Scenefo, the DTV can display several tag lists, for example, one of which is directed to CMs alone, and the other of which is directed to merchandise information alone.

Upon detecting a press of the [Scenefo] button, the DTV displays detailed information of the Scenefo second nearest to the position being played.

The DTV always display the Scenefo nearest to the position being played.

Upon detecting a press of the “Go to shopping site via application” application, the DTV receives an URL of a shopping site and shows the shopping site using a browser in the application.

Upon detecting a press of a [Favorite Scenefo] button, the DTV displays the list of favorites and shows a shopping site corresponding to an action such as “Go to shopping site”.

<Related Log Upload Requirements>

Re: DTV

Upon detecting a press of [Scenefo] key in a standard mode, the DTV uploads a play position displaying the list of Scenefos (Scenefo mode start) and the Scenefo.

Upon detecting a press of the [Enter] key while the list of Scenefos is being displayed, the DTV uploads the Scenefo used for scene jumping.

Upon detecting a press of the [Right] key while the list of Scenefos is being displayed, the DTV uploads the Scenefo used for detailed display of the Scenefo.

The DTV uploads information obtained from Scenefo details such as an URL of a site such as shopping site, merchandise site, shop site, or map site.

If the Scenefo details are transferred to an application, the DTV uploads the Scenefo corresponding to the Scenefo details.

If the Scenefo details are sent in mail, the DTV uploads the Scenefo corresponding to the Scenefo details.

The DTV uploads the Scenefo with a “Like!” evaluation.

The DTV uploads the Scenefo registered in Favorites.

Re: Terminal

If the Scenefo is displayed in response to the press of [Scenefo] key, the terminal uploads the play position of the Scenefo and the Scenefo.

The terminal uploads information obtained from Scenefo details such as an URL of a site such as shopping site, merchandise site, shop site, or map site.

If the Scenefo details are sent in mail, the terminal uploads the Scenefo corresponding to the Scenefo details.

The terminal uploads the Scenefo with a “Like!” evaluation.

The terminal uploads the Scenefo registered in Favorites.

Note that a Scenefo is regraded as one of the tag lists, and a tag list use log is thus uploaded.

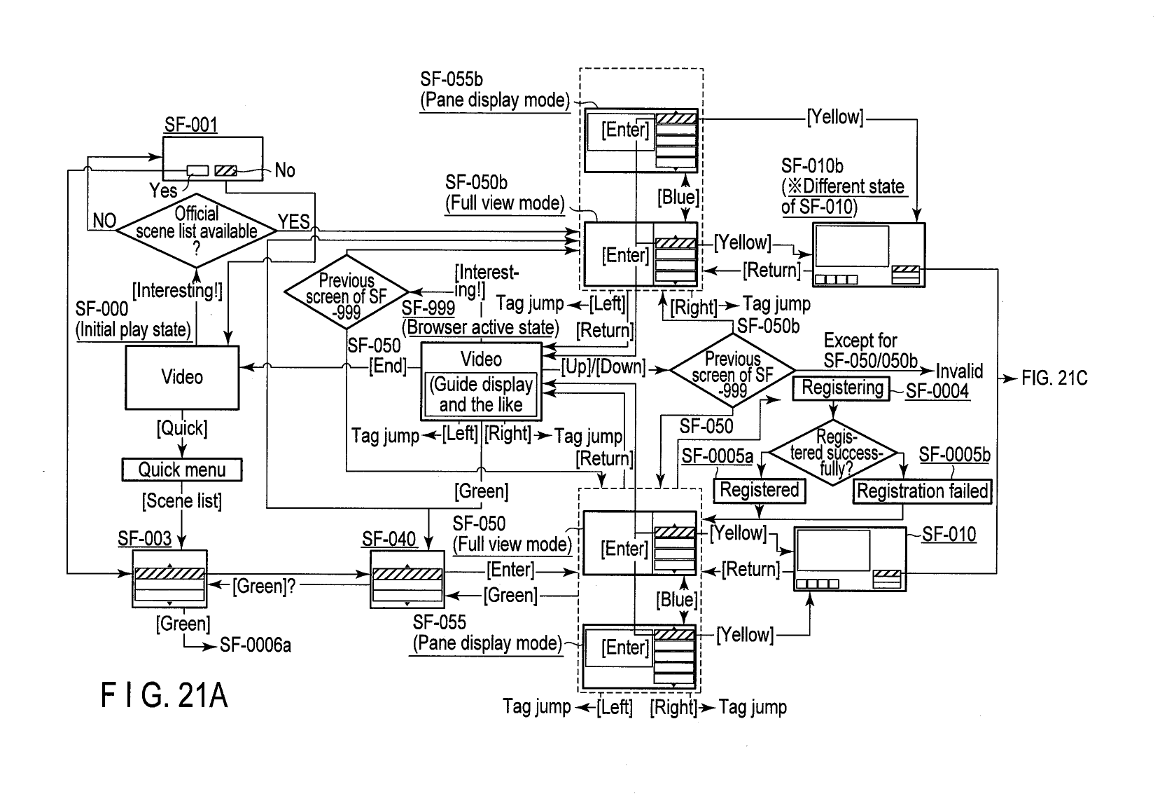

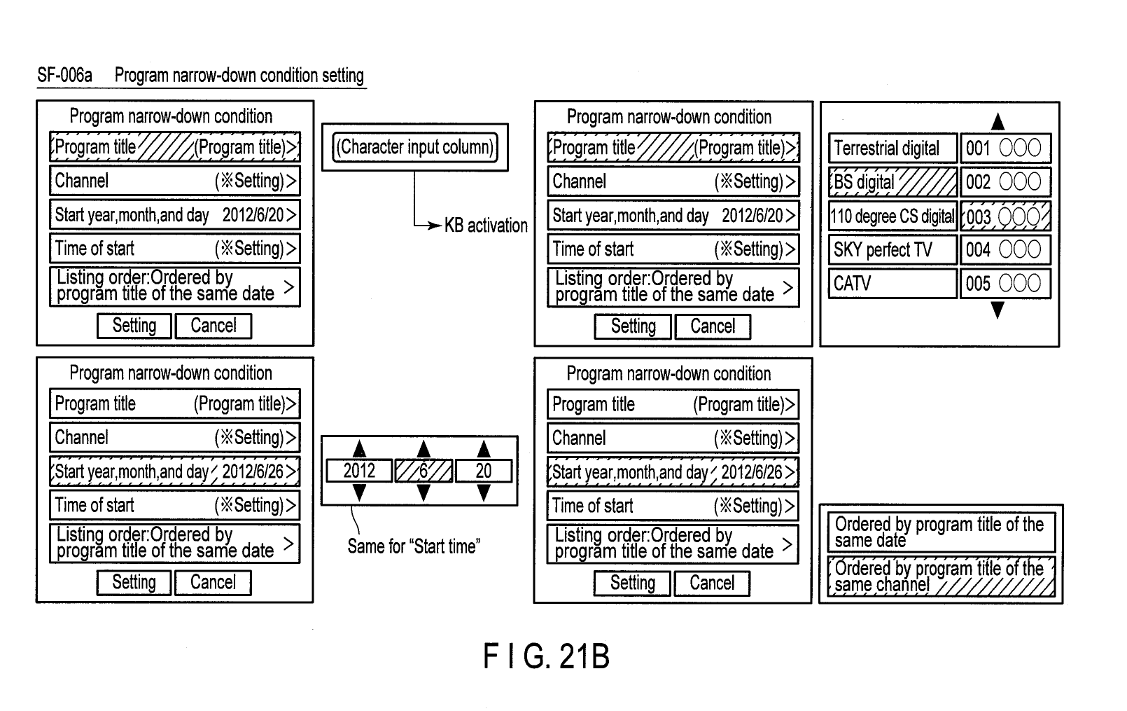

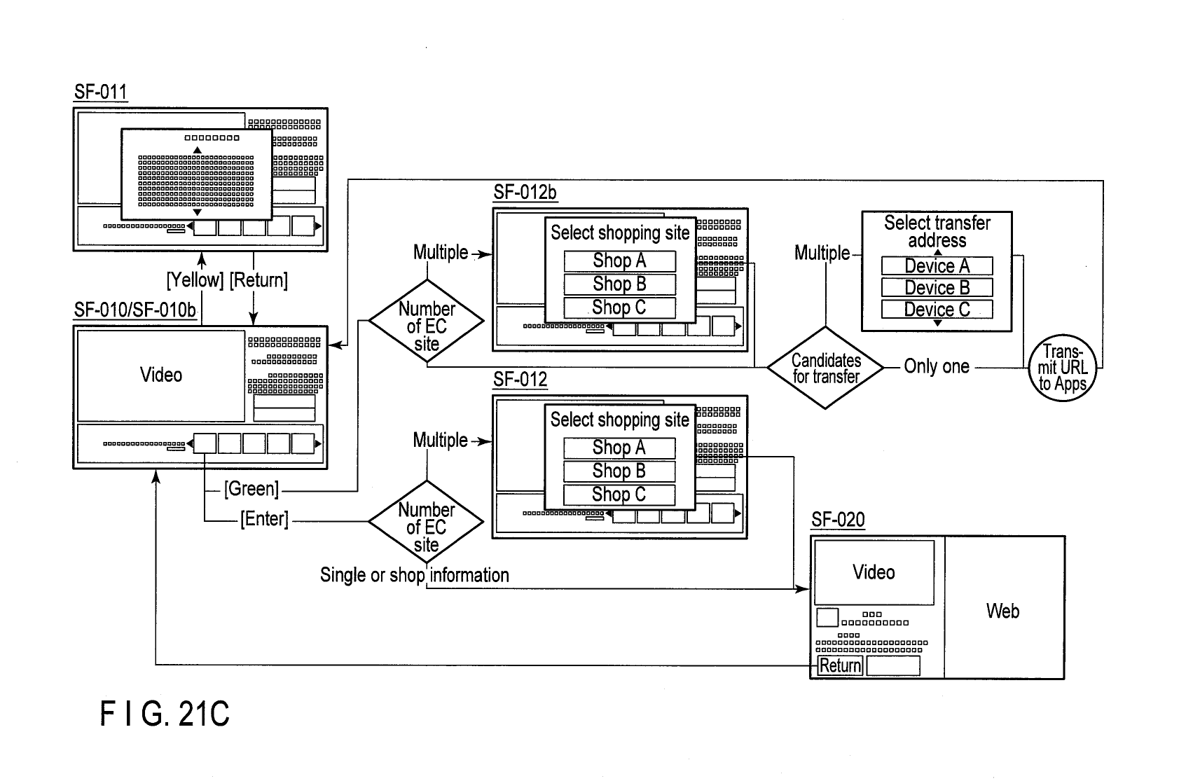

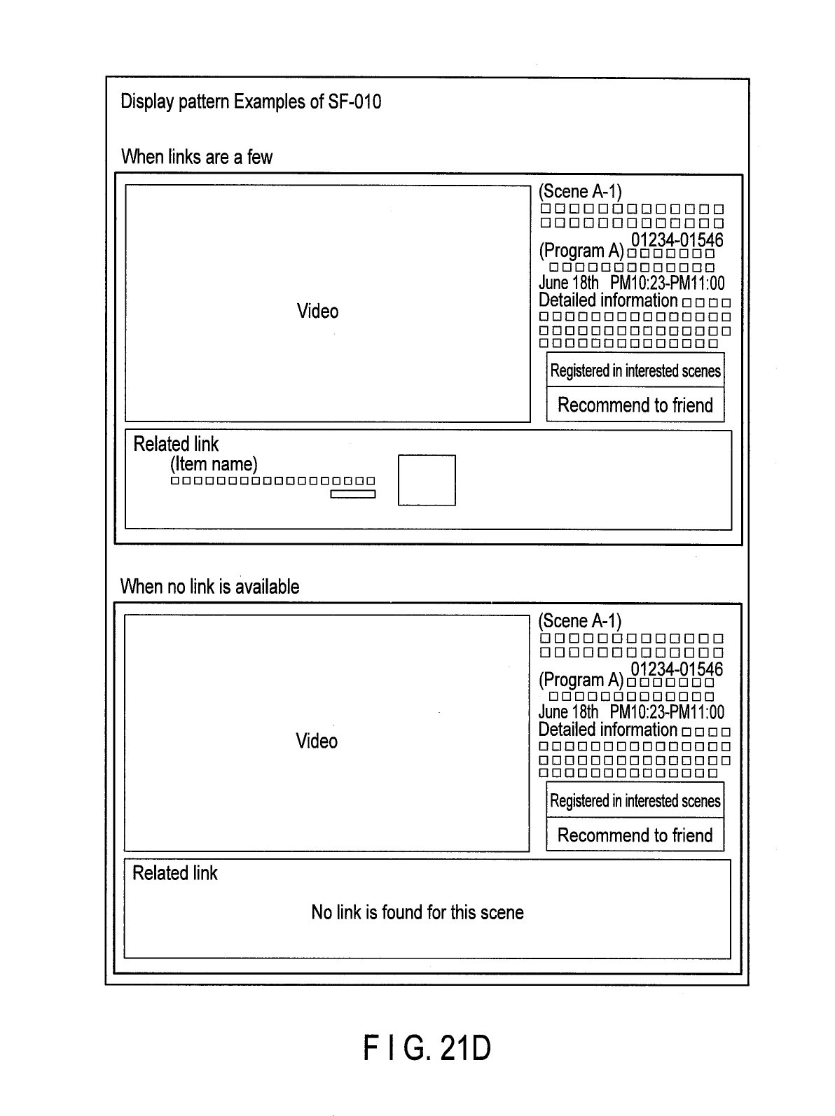

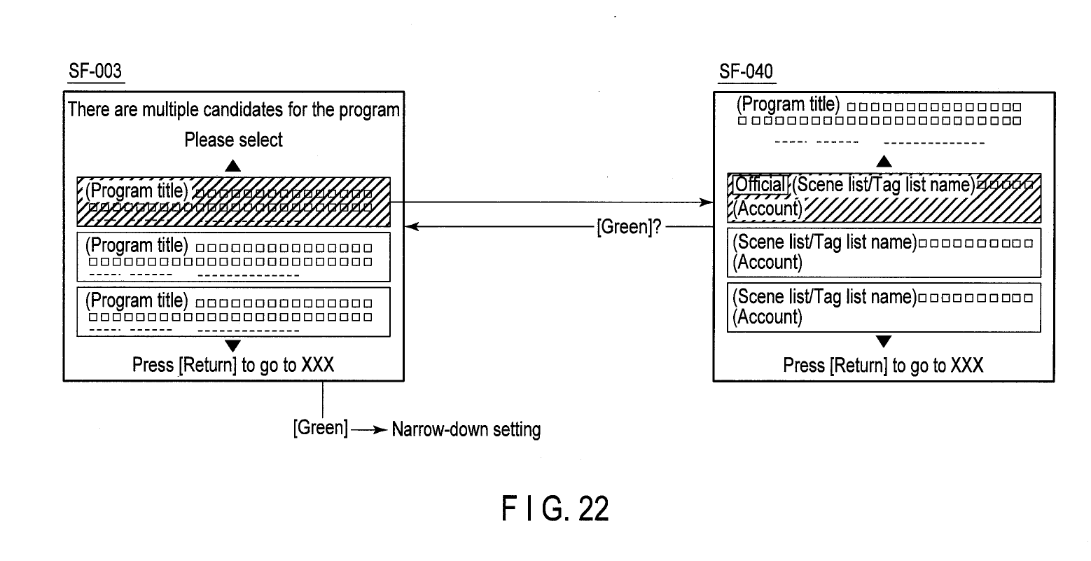

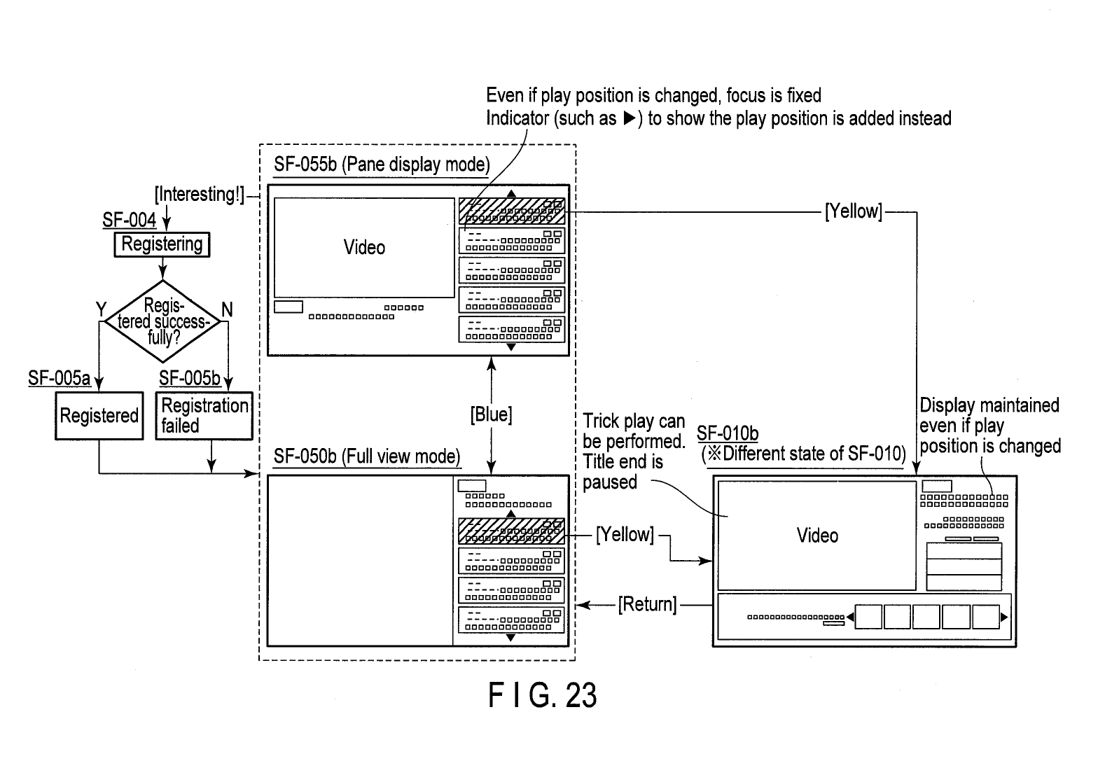

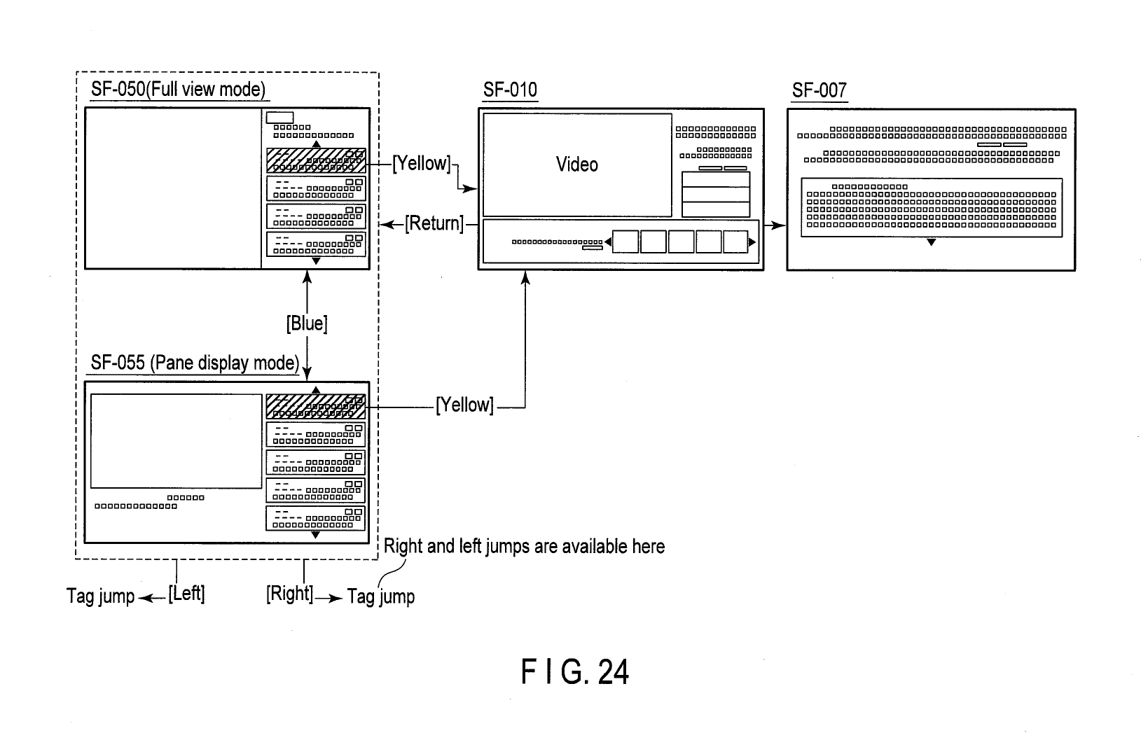

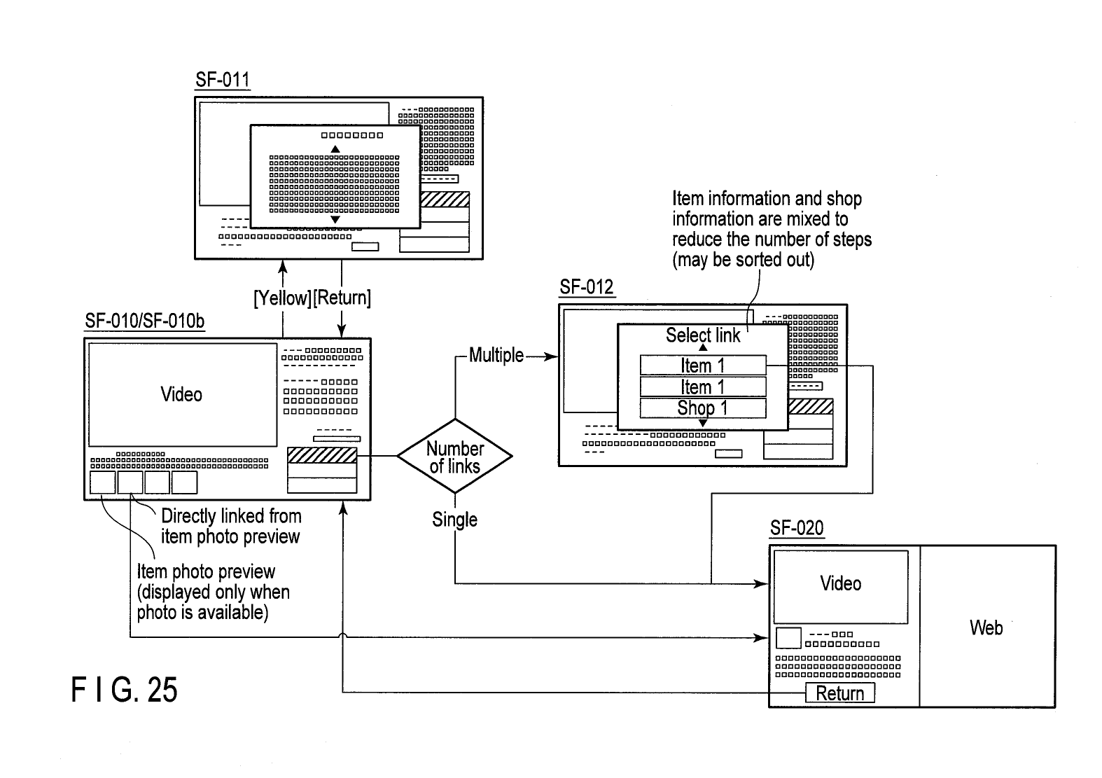

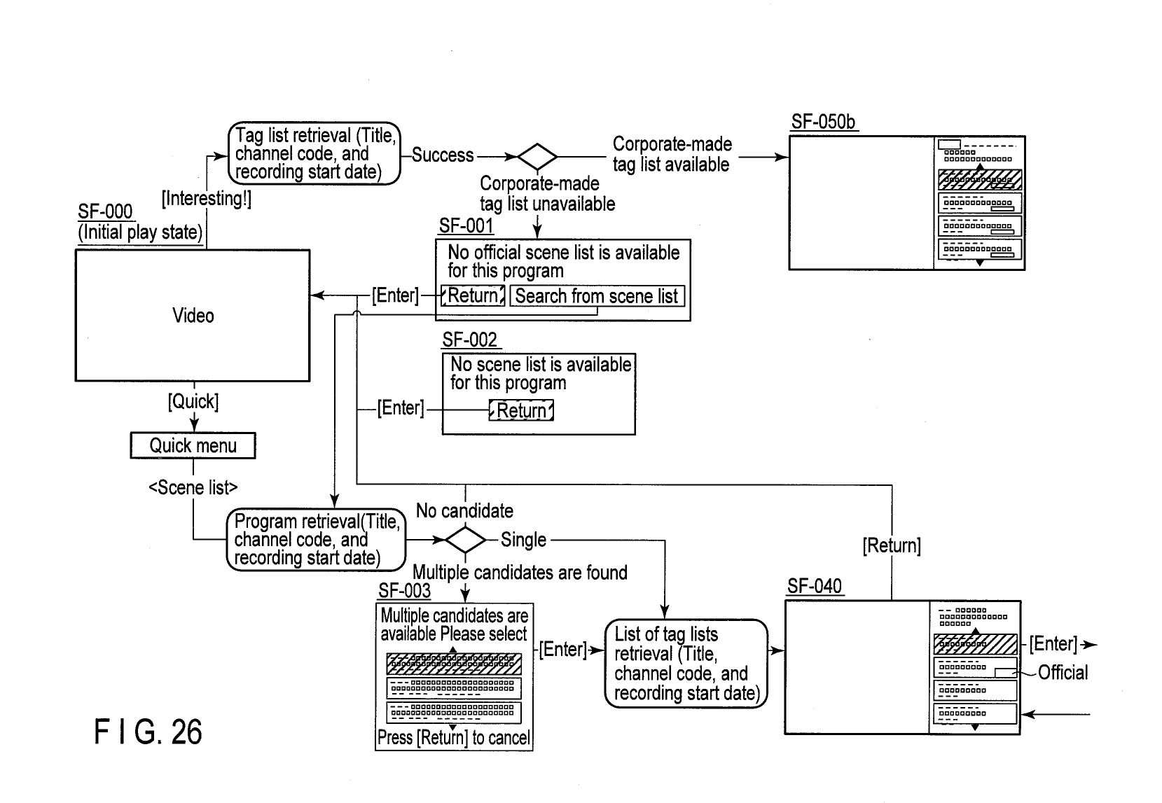

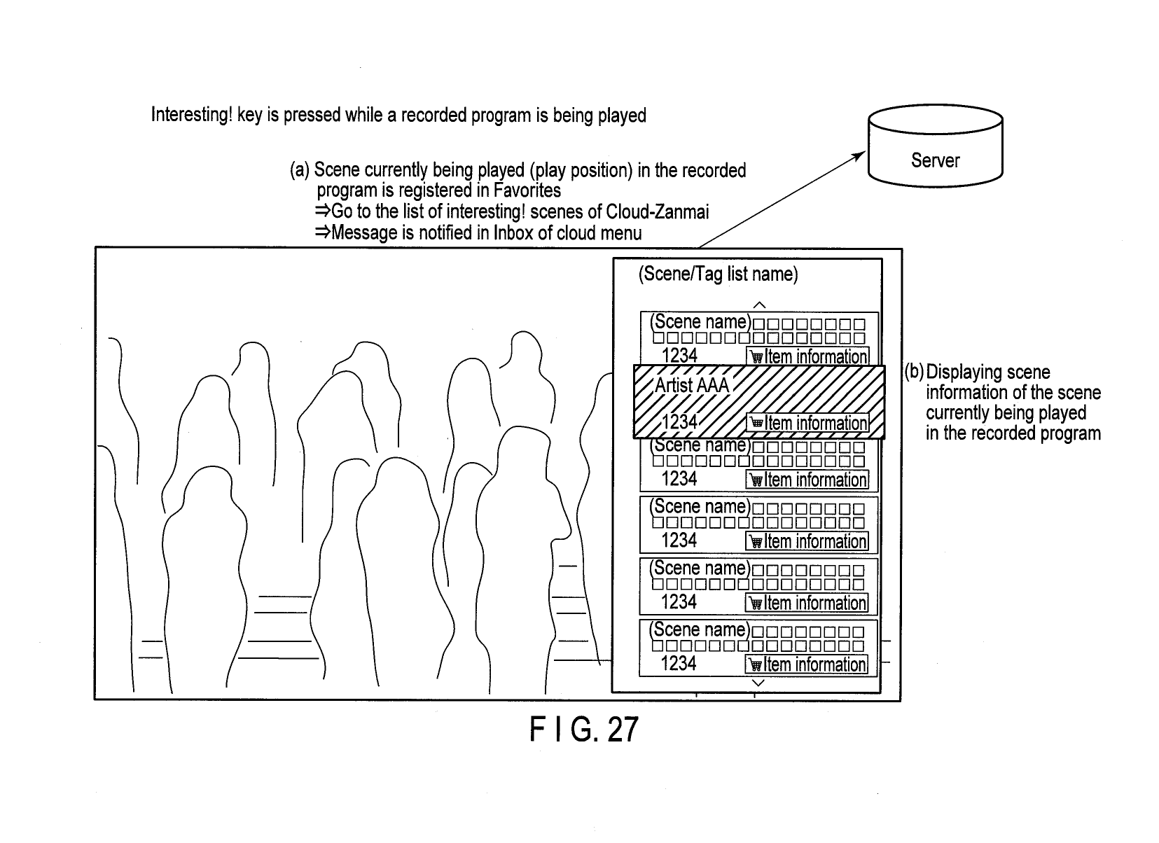

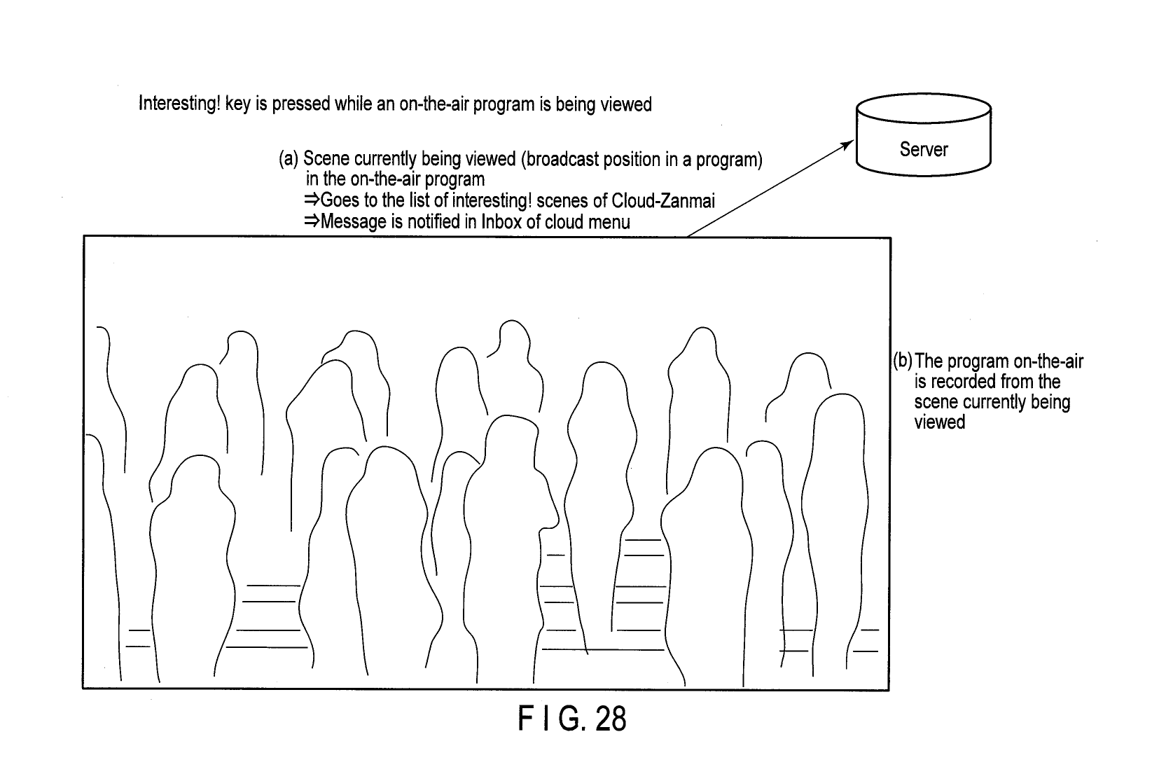

Now, an example of screen transition is explained. FIGS. 21A, 21B, 21C, and 21D show an example of screen transition. FIGS. 22 to 26 show an example of screen transition in detail. FIGS. 27 to 30 show an example of each screen.

For example, while the DTV 1 is in an initial play state or an initial browser state and is displaying a play screen of, for example, recorded contents (recorded program) (SF-000/SF-999 in FIG. 21A), the DTV 1 displays, upon detecting a press of the interesting! key, scene information of the scene being played, scene information of the scene posterior to the scene being played, and scene information of the scene prior to the scene being played.

FIG. 27 shows a display example of scene information items in a list. Upon detecting a press of the interesting! Key while the recorded contents (recorded program) are being played, the DTV 1, for example, registers the scene being played (play position) in Favorites, registers the scene in the interesting! scene list of a cloud-zanmai function, and dispatches a message in an inbox in a cloud menu. Furthermore, the DTV 1 displays a plurality of scene information items in a list (displays the scene information of the scene being played, the scene information of the scene posterior to the scene being played, and the scene information of the scene prior to the scene being played). Furthermore, the scene information includes an merchandise information icon and the like, and the user can refer to the merchandise information site and item purchase site corresponding to the scene by simply selecting the merchandise information icon.

Furthermore, while the DTV 1 is in the initial play state or the initial browser state and is displaying a play screen (realtime play screen) (SF-000/SF-999 in FIG. 21A), the DTV 1, upon detecting a press of the interesting! key, registers the scene being played (broadcast position) in the interesting scene list of the cloud-zanmai function, and dispatches a message in the inbox in the cloud menu. Furthermore, the DTV 1 starts recording the scene being played.

As can be understood from the above, the processes triggered by the press of the interesting! button are switched based on the play conditions. That is, if the press of the interesting! key is detected while a recording content is being played, the scene information is displayed. If the press of the interesting key is detected while a broadcast content is being played, the recording is started.

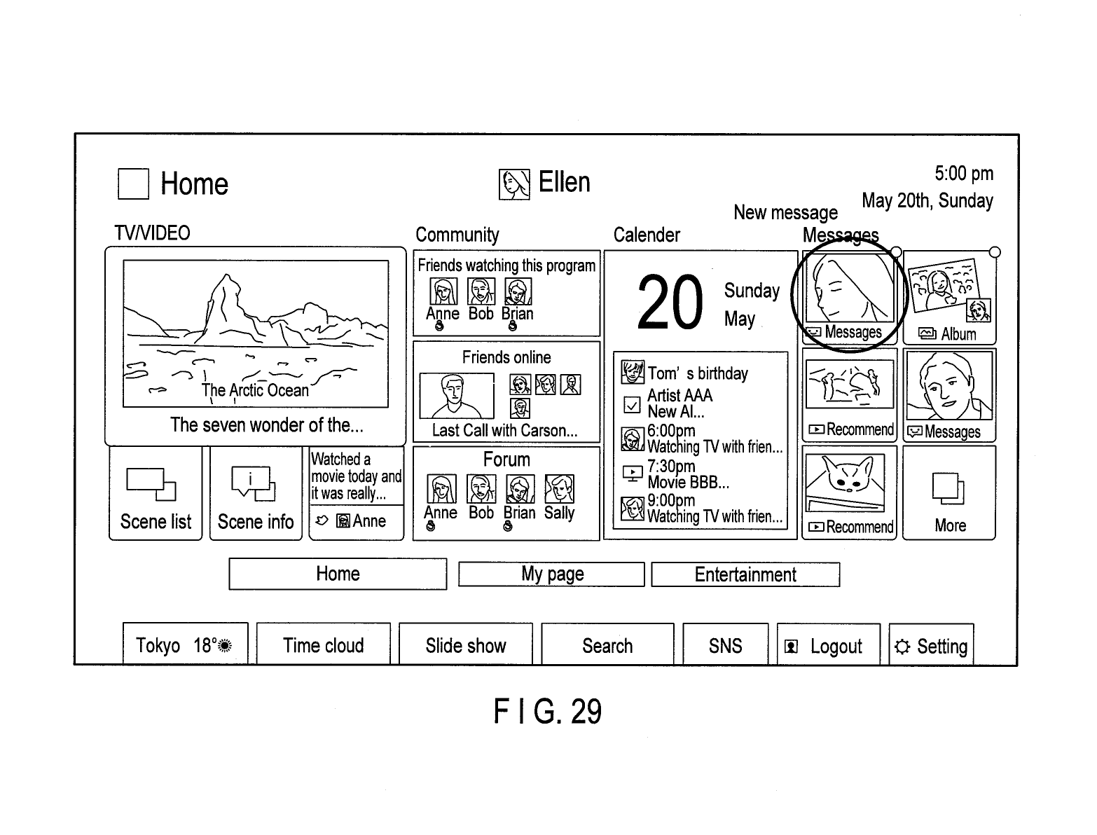

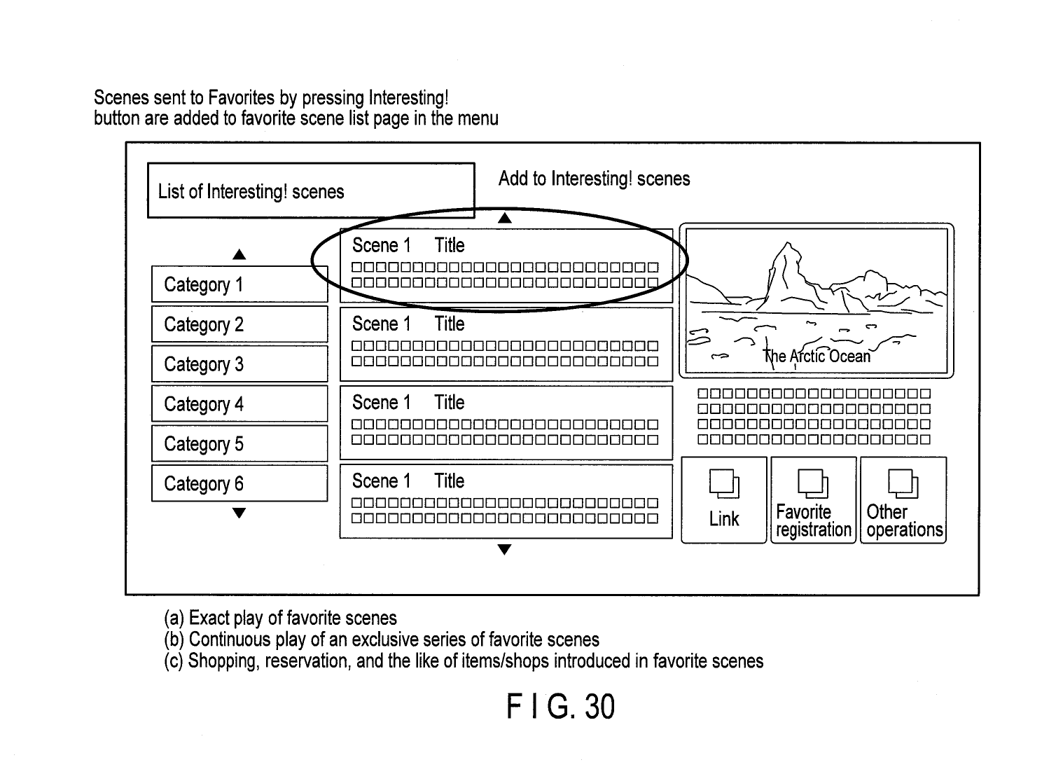

FIG. 29 shows an example of the cloud menu displayed by the DTV. The notice of the above message is reflected upon an message icon. Furthermore, if a scene list icon is selected, the scene list screen as in FIG. 30 is displayed. That is, the above registered scene information can be selected from the scene list screen. For example, if the user selects any desired registered scene information, the DTV 1 then plays the scene corresponding to the desired registered scene information selected by the user. Furthermore, if the user selects a continuous play based on a plurality of scene information items, the DTV 1 continuously plays the scenes corresponding to the plurality of scene information items. If the user selects an icon such as a merchandise icon or a shop icon in the registered scene information, the DTV 1 displays websites such as merchandise information site, item purchase site, and shop site.

The followings are examples of recommendations in the time cloud function.

<Recommended Scene>

Power-Push Scene

A time band gathering many viewers is calculated from the view logs, and the scenes of the data corresponding to such a time band are designated as high view rating scenes. If there is a scene of the program recorded by the user in the high view rating scenes, the scene is then recommended.

Popular Scene

The tagged scene which has gathered a large number of tag jumps is calculated from the tag jump logs in the time cloud. If there is a tag corresponding to the tagged scene in the program recorded by the user, the scene tag is then recommended.

Scene Everyone is Interested in

A scene tag which has been favorites frequently is calculated from the scene tags put in Favorites by time cloud users. If there is a scene tag corresponding to the calculated scene tag in the program recorded by the user, the scene tag is then recommended.

Twitter Buzzing Scene

A time band gathering many tweets is calculated from the tweets directed to hash tags of broadcast stations. The scene of the program corresponding to such a time band in the metadata generating server is then recommended as a buzzing scene.

Friend Recommend Scene

The scene recommended by a friend via a message is recommended.

User Recommend Scene List

The user made scene list gathering his/her favorite tagged scenes is presented.

Friend-Watched Scene

The tagged scene which has gathered a large number of tag jumps is calculated from the tag jump logs of a friend, and is recommended.

Popular Item/Shop Scene

A shopping site gathering many jumps is calculated from the number of jumps to shopping websites (items), and is recommended. The shopping site gathering many jumps is calculated from the number of jumps to the shopping sites (shops), and is recommended.

Exclusive Recommended Scene

The recommendation is personalized to the user. The scene to be preferred by the user is calculated from profiles and viewed scene logs of other users. If there is a scene corresponding to the scene to be preferred by the user in the program recorded by the user, the scene is then recommended.

Note that all of the above processes can be executed by software (scene information output program). Thus, the above processes can easily be achieved by simply installing a program (application) to execute the above processes in a player or a mobile terminal.

For example, the player or the mobile terminal can download the above program from a server and store the downloaded program to complete the install of the program. Or, the player or the mobile terminal can read the above program from a computer-readable storage medium and store the read program to complete the install of the program.

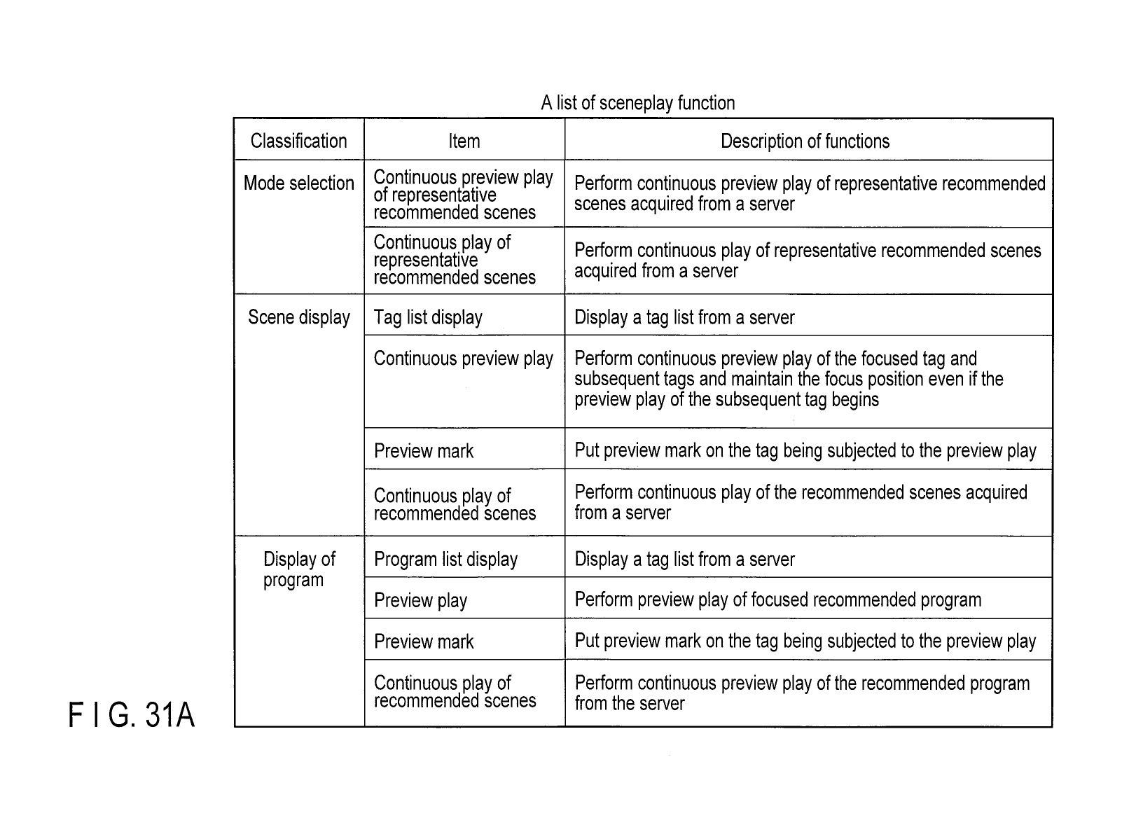

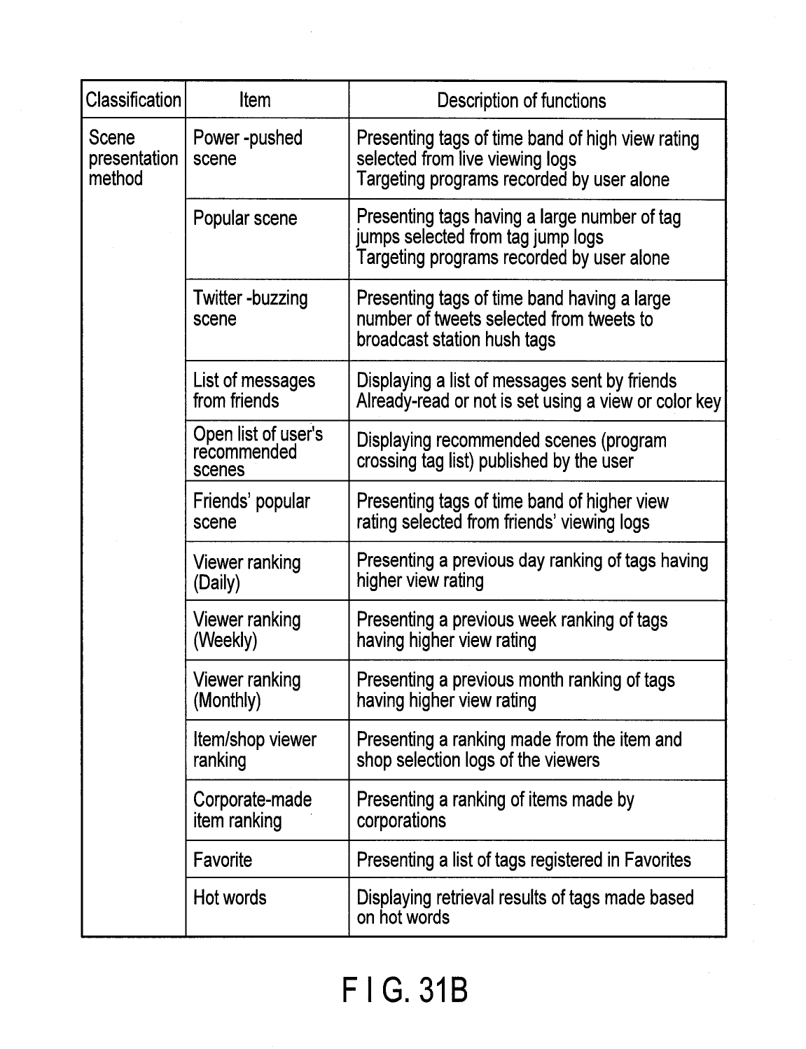

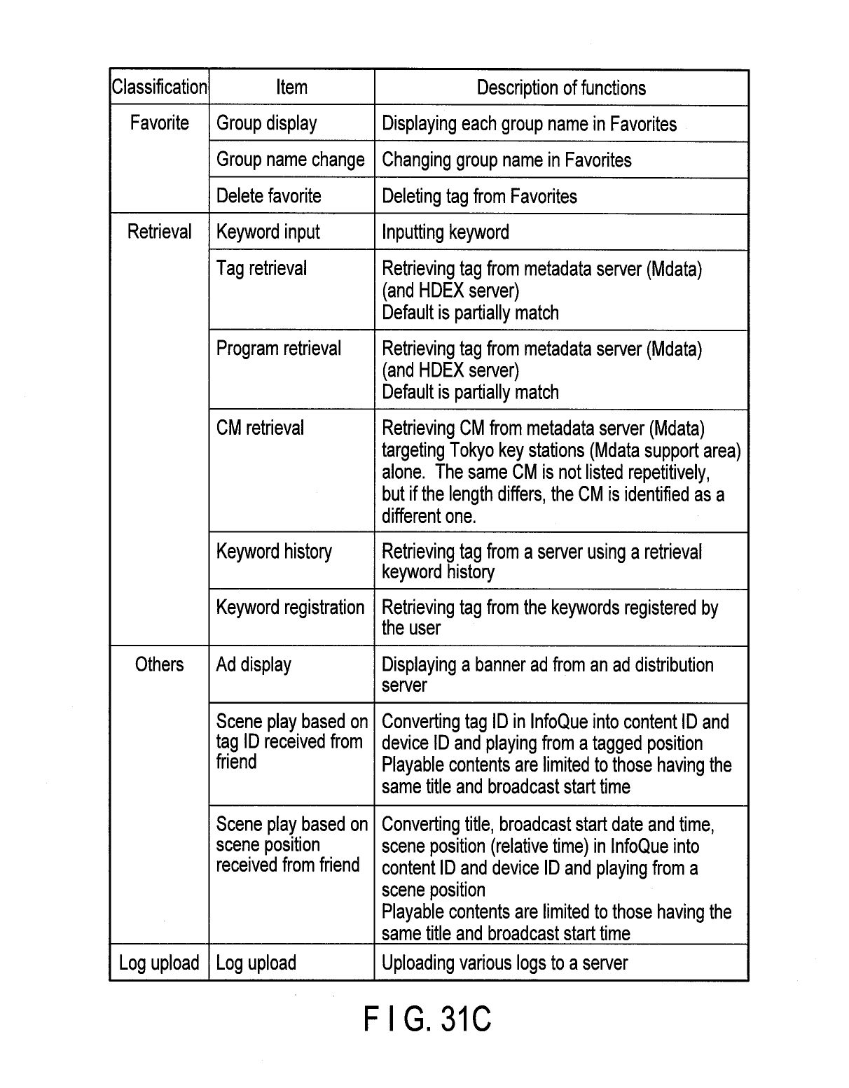

Now, a scene-by-scene play by the ScenePlay function in the DTV is explained. FIGS. 31A, 31B, and 31C show an example of listed functions of the ScenePlay.

For example, the DTV transfers a recording log of recorded contents to a server in response to the recording process of the contents. The recording log includes identification information of the DTV and identification information of the recorded contents (title, date of broadcast, channel number, ID, and the like of the program). The server associates the identification information of the DTV with the identification information of the recorded contents for management. Through this process, the server can manage the entire contents recorded in the DTV. That is, the entire contents playable by the DTV can be managed therein. For example, the history collection server S13 shown in FIG. 16 manages the entire contents playable in each DTV. Note that, the entire contents recorded in the DTV are explained as the contents playable by the DTV in the above explanation but also the entire contents recorded by a recorder which is connected to the DTV can be regarded as the contents playable by the DTV. The contents may be recorded in a storage medium (for example, a hard disk) stored in the DTV, an external storage medium connected to the DTV, a storage medium stored in the recorder, or an external storage medium connected to the DTV.

The server manages a plurality of scene information items corresponding to a plurality of scenes in each of the contents. The server transmits the scene information items corresponding to the contents playable in the DTV to the DTV. For example, the metadata server S11 shown in FIG. 16 manages a plurality of scene information items each including identification information (title, date of broadcast, channel number, ID, and the like of the program). Since the server manages the identification information of the recorded contents playable by the DTV, the server can detect the scene information items to be sent to the DTV, and send the scene information items to the DTV. That is, the server compares the identification information of the recorded contents playable by the DTV with the identification information of the scene information items, and if, for example, at least a part of the identification information of the recorded contents playable by the DTV matches with at least a part of the identification information of the scene information items, the server sends the matching scene information items to the DTV.

The DTV receives one or more scene information items corresponding to one or more scenes of one or more contents from the server. Here, as a precondition, the DTV receives a plurality of scene information items corresponding to a plurality of scenes in a plurality of contents from the server.

Furthermore, based on at least one of various information items (such as view rating information described below) and designated conditions (such as a keyword), the DTV can retrieve a plurality of recommended scene information items and present (display) the retrieved recommended scene information items. For example, the DTV can display the recommended scene information items sorted out category-by-category (as in FIG. 21B).

For example, the DTV can present a plurality of scene information items as power-push scenes based on currently most retrieved word information (popular retrieval keyword information) from the server. For example, the DTV can present a plurality of scene information items corresponding to the top ten words which are currently most retrieved in the currently most retrieved word information. That is, the plurality of scene information items including the top ten words which are currently most retrieved can be presented. The DTV may play one scene corresponding to the scene information item selected from the plurality of scene information items corresponding to the top ten words which are currently most retrieved (for example, the scene corresponding to the top word of the currently most retrieved words), or may continuously play a plurality of scenes corresponding to the scene information items corresponding to the top ten words which are currently most retrieved (for example, a plurality of scenes corresponding to the ten words of the currently most retrieved words).

For example, the DTV can present a plurality of scene information items as power-push scenes based on view rating information from the server. For example, the DTV can present a plurality of scene information items corresponding to the top ten view ratings in the view rating information. The view rating information is generated based on a compilation result of play logs and the like from a plurality of DTVs and includes IDs of the scene information items of top ten view ratings. The DTV may play one scene corresponding to the scene information item selected from the plurality of scene information items corresponding to the top ten view ratings (for example, the scene corresponding to the top view rating), or may continuously play a plurality of scenes corresponding to the scene information items corresponding to the top ten view ratings (for example, a plurality of scenes corresponding to the top ten view ratings). For example, as shown in FIG. 42, the DTV may present a plurality of scene information items corresponding to popular top thirty scenes.

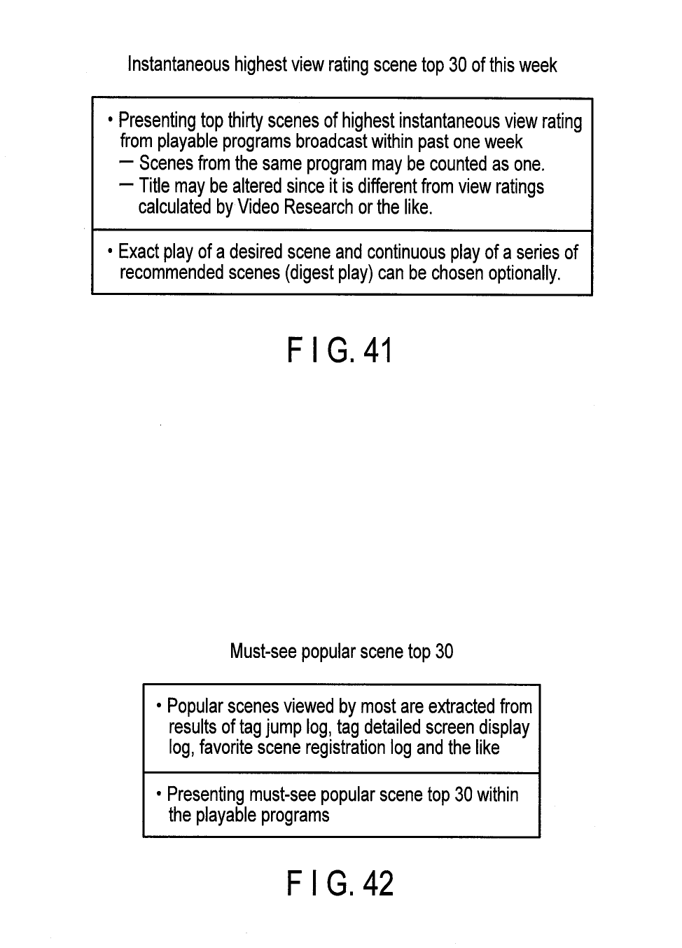

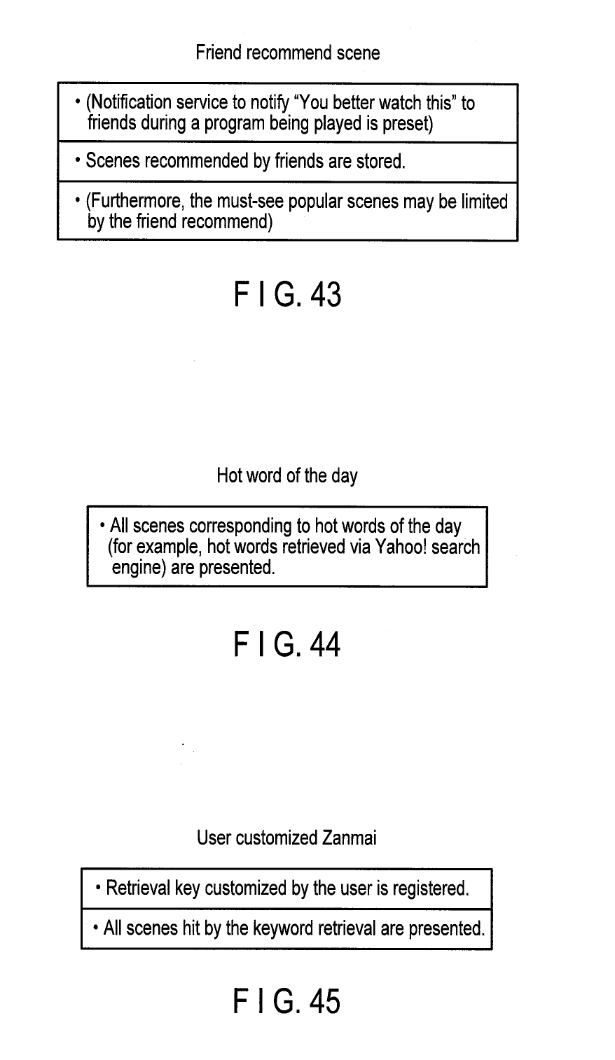

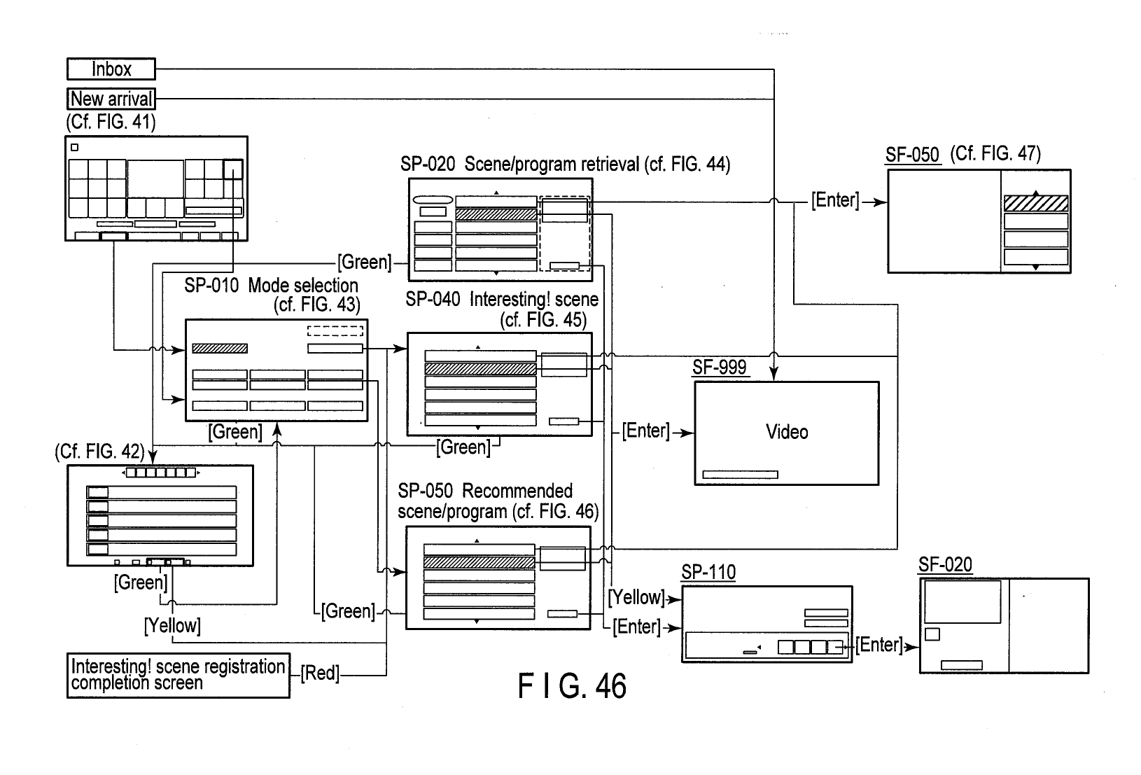

When a scene information item is selected, the DTV retrieves a scene in contents based on the identification information included in the selected scene information item and plays the retrieved scene. For example, the scene is retrieved from the contents broadcast and recorded within one week. When a plurality of scene information items are selected, the DTV retrieves a plurality of scens in contents based on a plurality of identification information items included in the selected scene information items and plays the retrieved scenes. For example, the scenes are retrieved from the contents broadcast and recorded within one week. Here, as shown in FIG. 41, a plurality of scene information items corresponding to instantaneous view rating top thirty may be presented.

For example, the DTV can present a plurality of scene information items as popular scenes based on popular scene information (information of scenes frequently played) from the server. For example, the DTV can present a plurality of scene information items corresponding to the top ten popular scenes in the popular scene information. The popular scene information is generated based on a compilation result of play logs and the like from a plurality of DTVs and includes IDs of the popular scene information items of top ten popular scenes. The DTV may play one scene corresponding to the scene information item selected from the plurality of scene information items corresponding to the top ten popular scenes (for example, the scene corresponding to the most popular scene), or may continuously play a plurality of scenes corresponding to the scene information items corresponding to the top ten popular scenes (for example, a plurality of scenes corresponding to the top ten popular scenes). For example, as shown in FIG. 42, the DTV may present a plurality of scene information items corresponding to popular top thirty scenes.

When a scene information item is selected, the DTV retrieves a scene in contents based on the identification information included in the selected scene information item and plays the retrieved scene. When a plurality of scene information items are selected, the DTV retrieves a plurality of scenes in contents based on a plurality of identification information items included in the selected scene information items and plays the retrieved scenes.

For example, the DTV can present a plurality of scene information items as scenes related to popular sites based on popular site information from the server. For example, the DTV can present a plurality of scene information items corresponding to the top ten popular sites in the popular site information. The popular site information is generated based on a compilation result of access history and the like and includes IDs of the popular site information items of top ten popular sites. The DTV may play one scene corresponding to the scene information item selected from the plurality of scene information items related to the top ten popular sites (for example, the scene corresponding to the most popular site), or may continuously play a plurality of scenes corresponding to the scene information items related to the top ten popular sites (for example, a plurality of scenes corresponding to the top ten popular sites).

Furthermore, as shown in FIG. 43, the DTV can present scene information items recommended by friends and play a scene corresponding to a scene information item selected from the presented scene information items.

Furthermore, as shown in FIG. 44, the DTV can present scene information items corresponding to hot words of the day and play a scene corresponding to a scene information item selected from the presented scene information items.

For example, the DTV can compile only the scoring scenes in recorded football games and play them continuously.

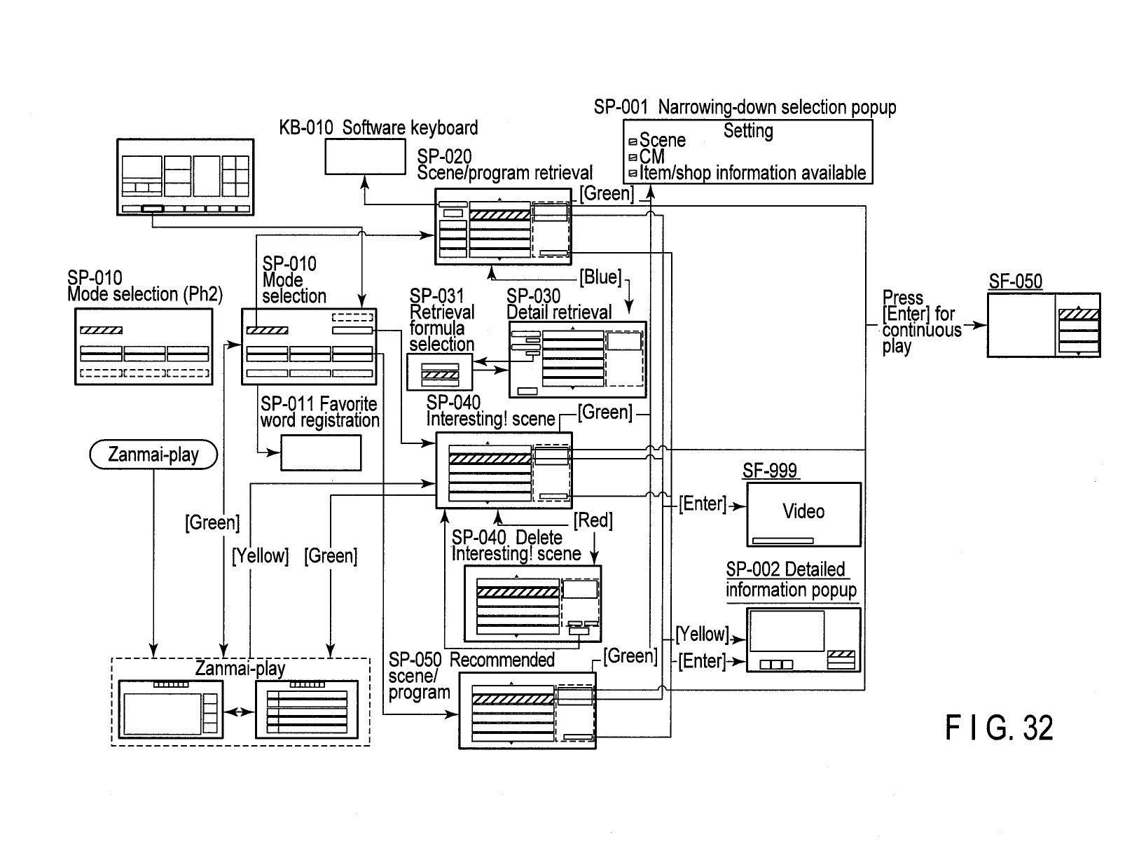

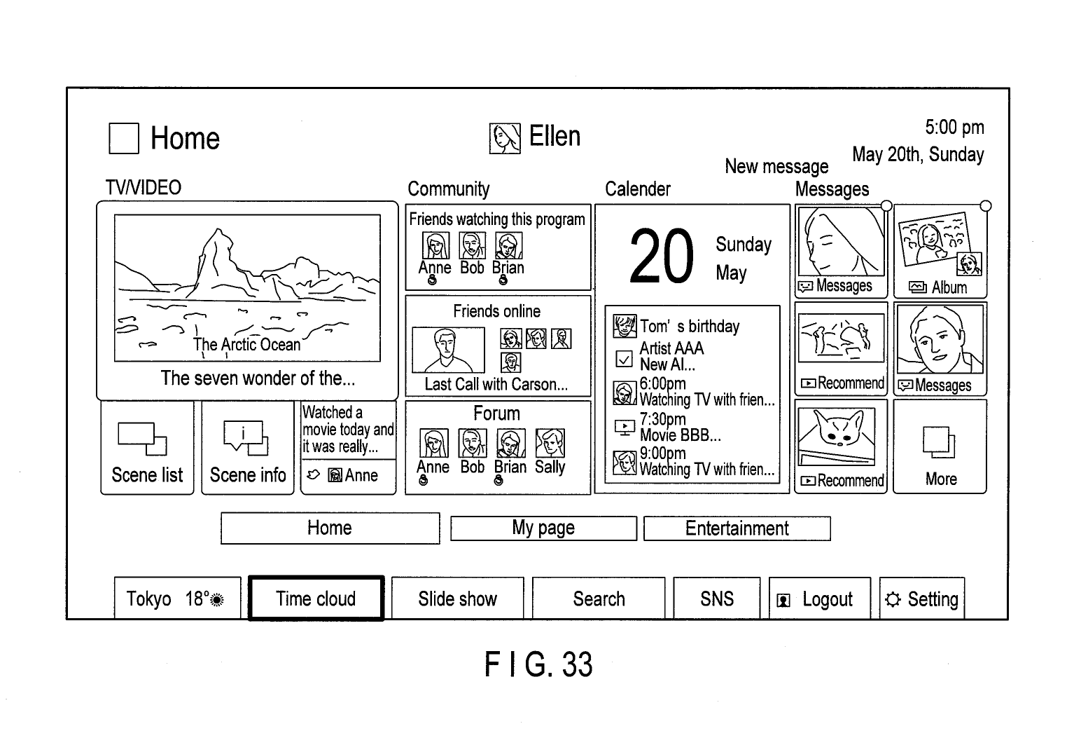

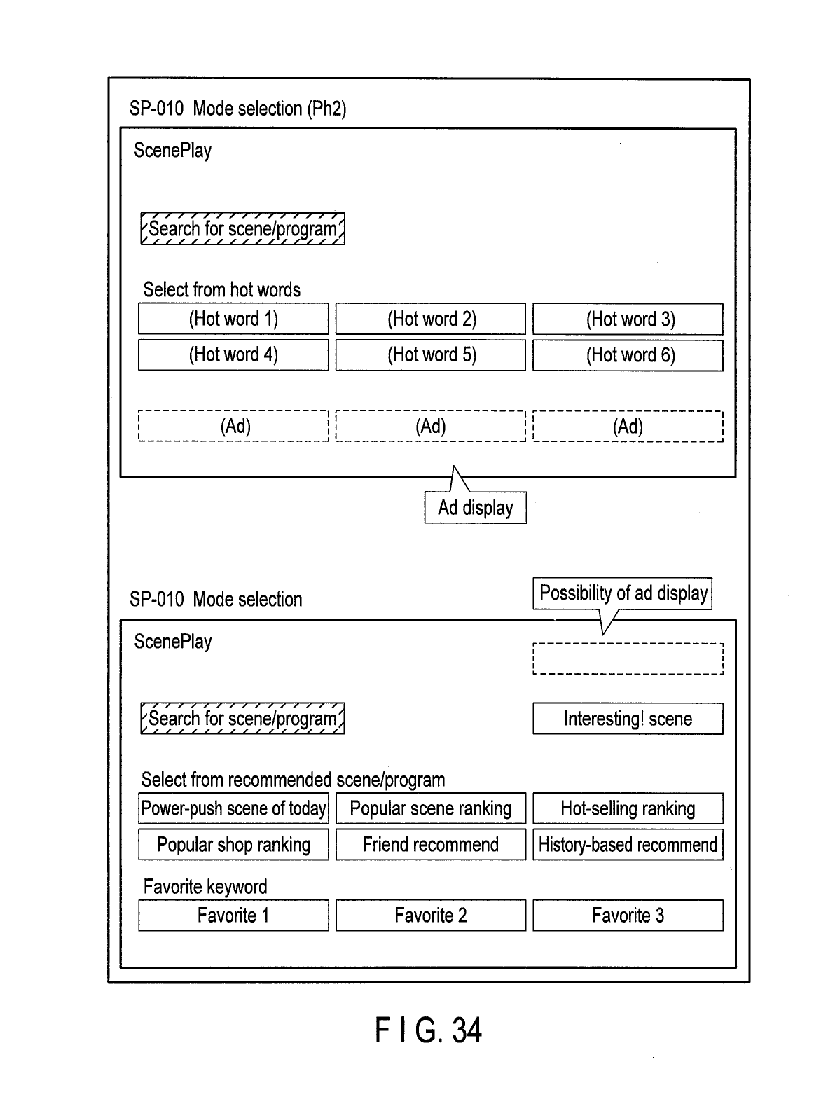

Now, an example of screen transition is explained. FIG. 32 shows an example of the screen transition. FIG. 33 shows an example of a cloud menu screen. FIGS. 34 to 39 show an example of a screen after the transition.

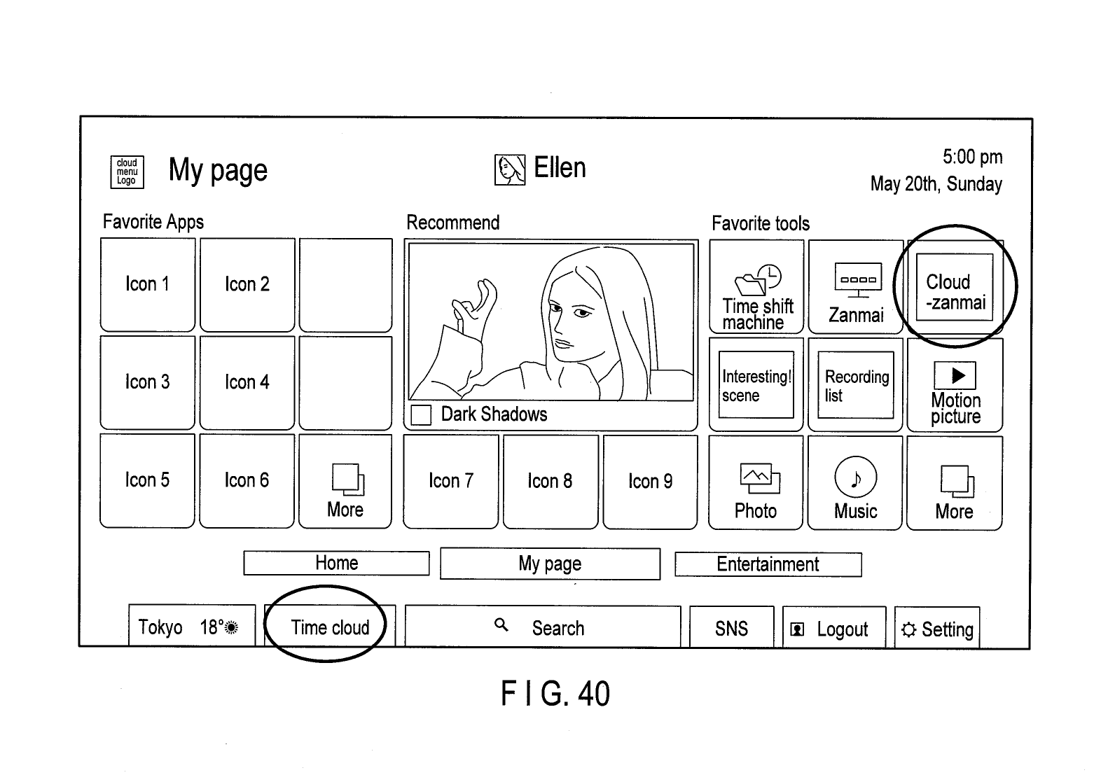

For example, the DTV displays a cloud menu screen (as in FIG. 33 or 40), and if the time cloud is selected from the cloud menu screen, the DTV displays a scene play screen listed by category (as in FIG. 34). For example, the scene play screen listed by category includes items such as power-push scene of the day, popular scene ranking, hot-selling item ranking, popular shop ranking, friend recommendation, history-based recommendation. The scene play screen listed by category (as in FIG. 34) can be customized by user. For example, scenes hit in the keyword retrieval may be gathered to display the user-customized scene play screen (as in FIG. 45).

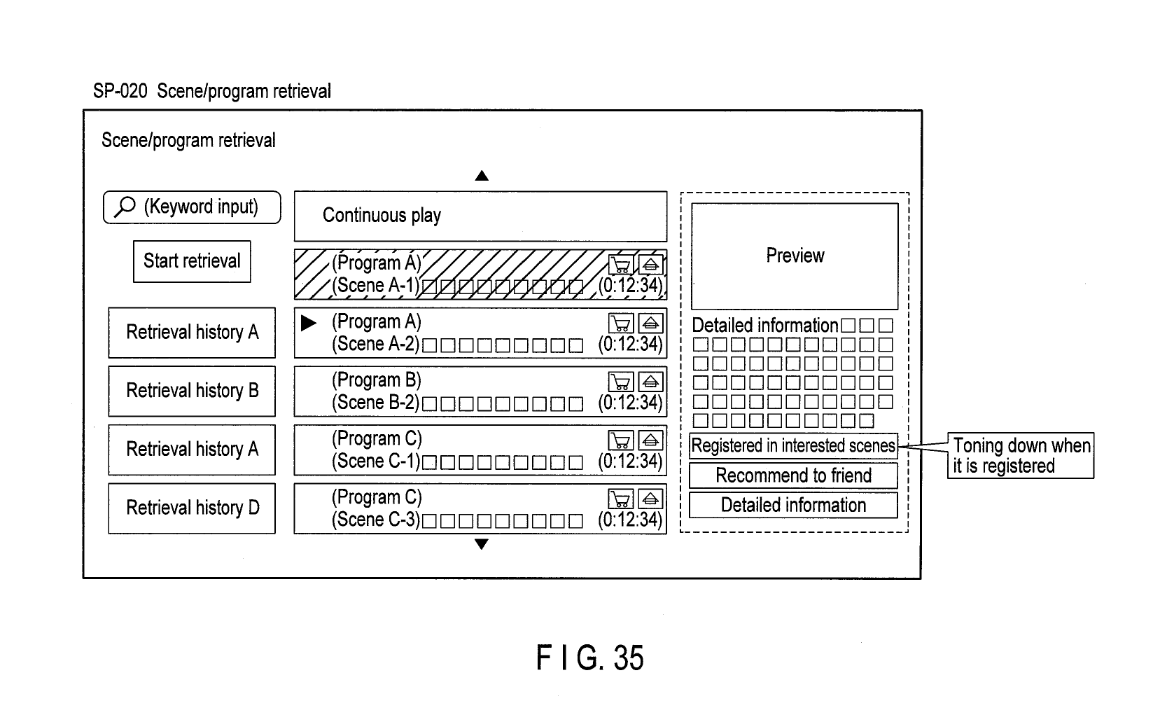

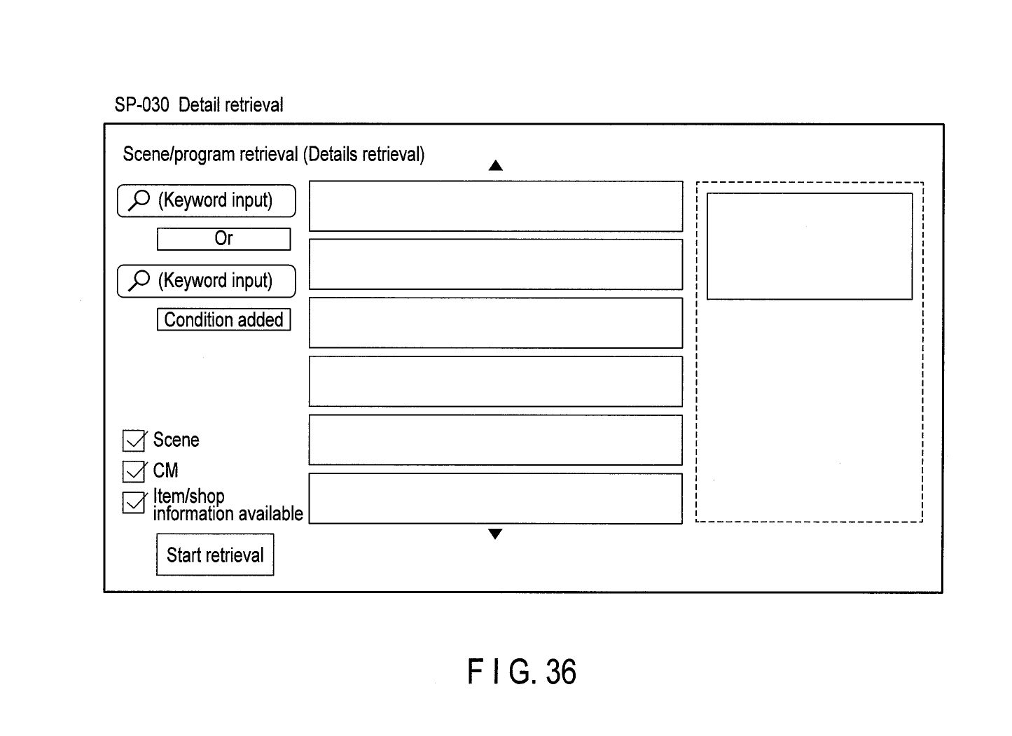

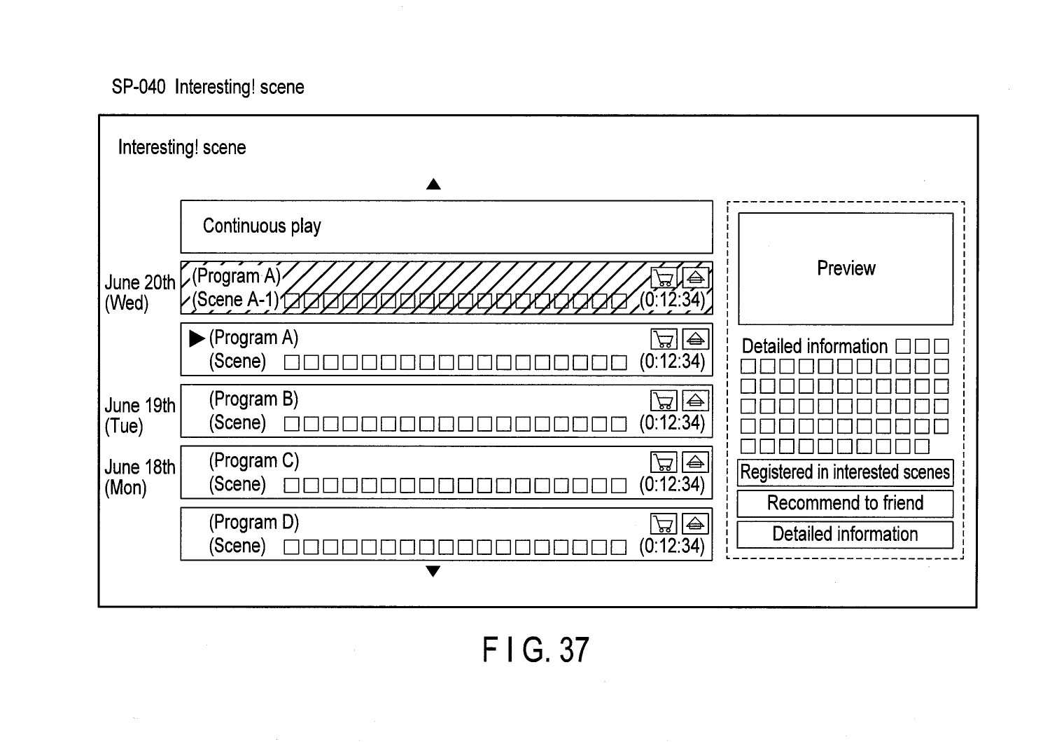

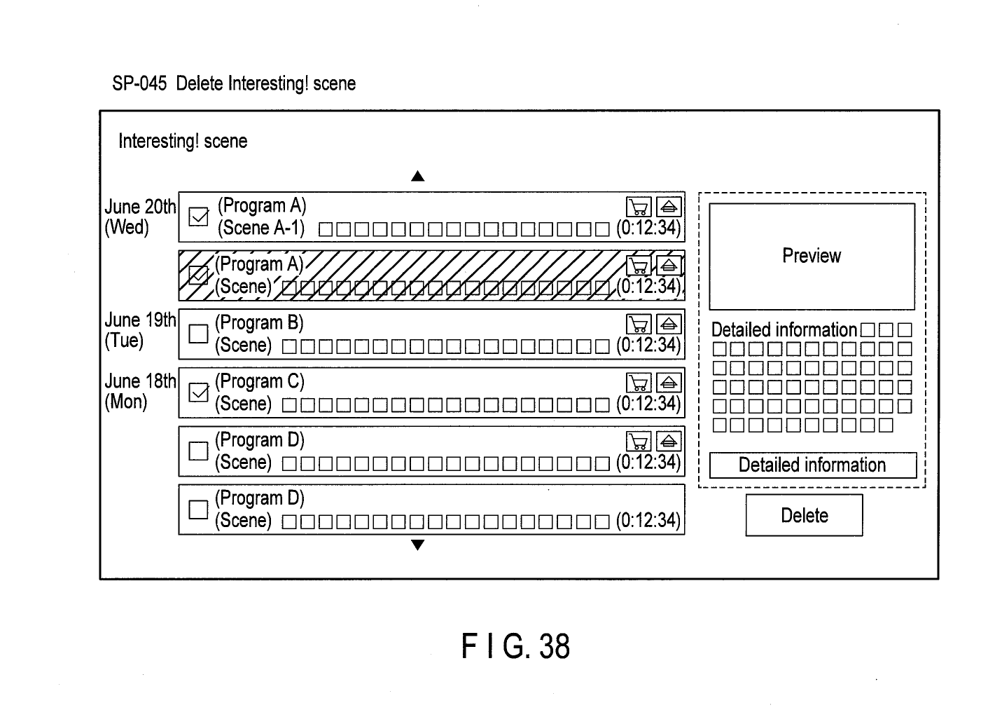

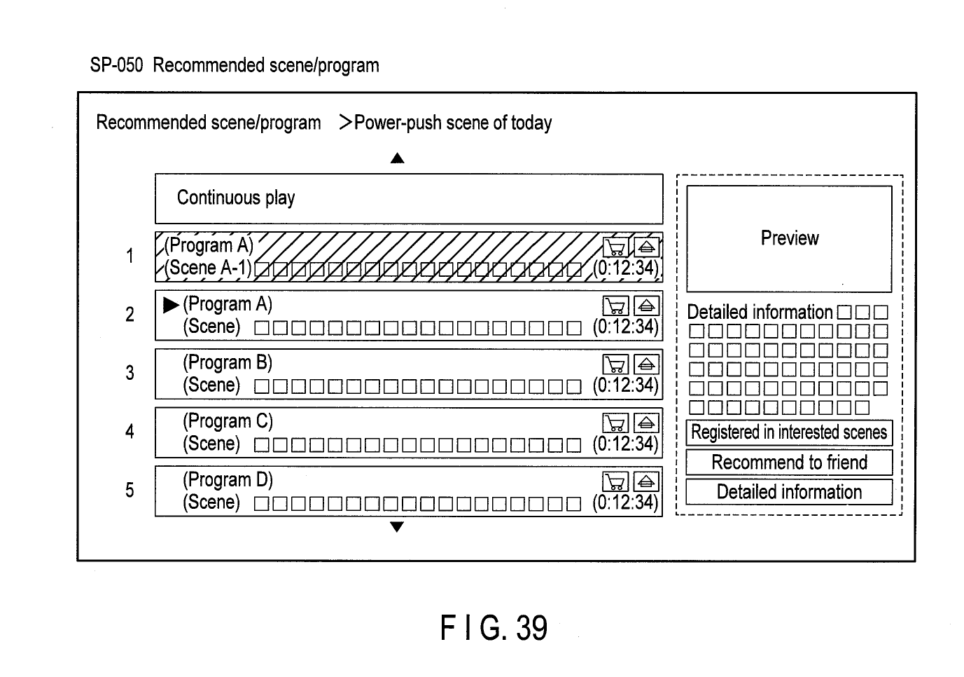

Furthermore, after the screen transition, the DTV shows, for example, a scene/program retrieval screen (as in FIG. 35), a detail retrieval screen (as in FIG. 36), an interesting! scene screen (as in FIG. 37), an interesting! scene delete screen (as in FIG. 38), and a recommended scene/program screen (as in FIG. 39).

The ScenePlay function of DTV explained above is now summarized.

The DTV can present a list of recommended scenes, and if a scene is selected from the list of recommended scenes, play a program including the selected scene or the scene itself directly. Furthermore, the DTV can play only the recommended scenes in series.

The above can be specified as follows.

The DTV retrieves recommended scenes on a scene-by-scene basis.

The DTV displays recommended scenes, recommended programs, favorites, and scene retrieval in a list.

The DTV presents representative recommended scenes.

The DTV retrieves a scene from programs (recorded contents) viewable by a user.

The server stores logs of record/deletion of contents from each DTV for the above processes achieved in the DTV. Or, the DTV itself may retrieve scene information items from the server based on a recording list of the contents.

The contents stored in a recorder or the like connected to the DTV may be included in the contents viewable in the DTV.

The DTV keeps the scenes in Favorites even if they are unplayable (so that a user can refer to merchandise information and the like).

The DTV keeps the retrieval-type history in the scene retrieval history. Or, the DTV registers favorite retrieval keys.

The DTV can perform the retrieval on a program-by-program basis or on a scene-by-scene basis.

The DTV presents a plurality of categories in the recommended scene screen. For example, the categories are:

Power-push of the day;

Popular scenes;

Hot-selling items;

Friend recommends, and the like.

Upon detecting a skip instruction while a plurality of scenes are being played continuously, the DTV plays the scene next to the scene being played, or the scene of the contents next to the contents including the scene being played.

Note that all of the above processes can be executed by software (scene play program). Thus, the above processes can easily be achieved by simply installing a program (application) to execute the above processes in a player or a mobile terminal.

For example, the player or the mobile terminal can download the above program from a server and store the downloaded program to complete the install of the program. Or, the player or the mobile terminal can read the above program from a computer-readable storage medium and store the read program to complete the install of the program.

Here, additional explanation of the ScenePlay function is presented.

For example, when a user cannot decide what to watch, he/she can refer to the ScenePlay service of the player 1 (for example, DTV). Through the ScenePlay service, the player 1 can present to the user one or more recommended scenes (scene information items). If, for example, the user selects one recommended scene information item from the recommended scene information items, the player 1 specifies a scene in contents corresponding to the selected recommended scene information item (hereinafter referred to as corresponding contents), and starts to play the specified scene (that is, recommended scene) directly. For example, as shown in FIG. 18A, the scene information item includes program identification information (title of program and the like), start time of the scene, and end time of the scene, and thus, the player 1 compares the program identification information included in the scene information to the program identification information in the recorded contents (contents management information) to check if they match, and specifies the contents corresponding to the scene information. Furthermore, the player 1 can specify the scene in the contents corresponding to this scene information.

Upon receiving an ordinary scene play instruction (first play instruction), the player 1 starts to play a certain scene in the corresponding contents, and after the certain scene ends, continues to play the subsequent scenes. That is, upon receiving the ordinary scene play instruction, the player 1 starts to play the certain scene in the corresponding contents and continues to play the contents until their end.

Upon receiving a scene continuous play instruction (second play instruction), the player 1 starts to play a certain scene in the corresponding contents, and after the certain scene ends, starts to play the recommended scene which is next to the certain scene (the selected recommended scene). The next recommended scene may be found in the corresponding contents or in other contents.

(1) Basic Functions of Interesting! Scene

Registration to Interesting! Scenes

If the interesting! button is pressed while a broadcast, PVR, or timeshift program is being viewed, the player 1 registers the scene being played in the server. For example, the information registered in the server includes unique program ID information by which the program being viewed can be specified and viewing position information (which is play time information indicative of, for example, a position from the starting point of the program). Note that, if the interesting! button is pressed during the broadcast, the player 1 starts to record the program being broadcast.

Transition to Interesting! Scene

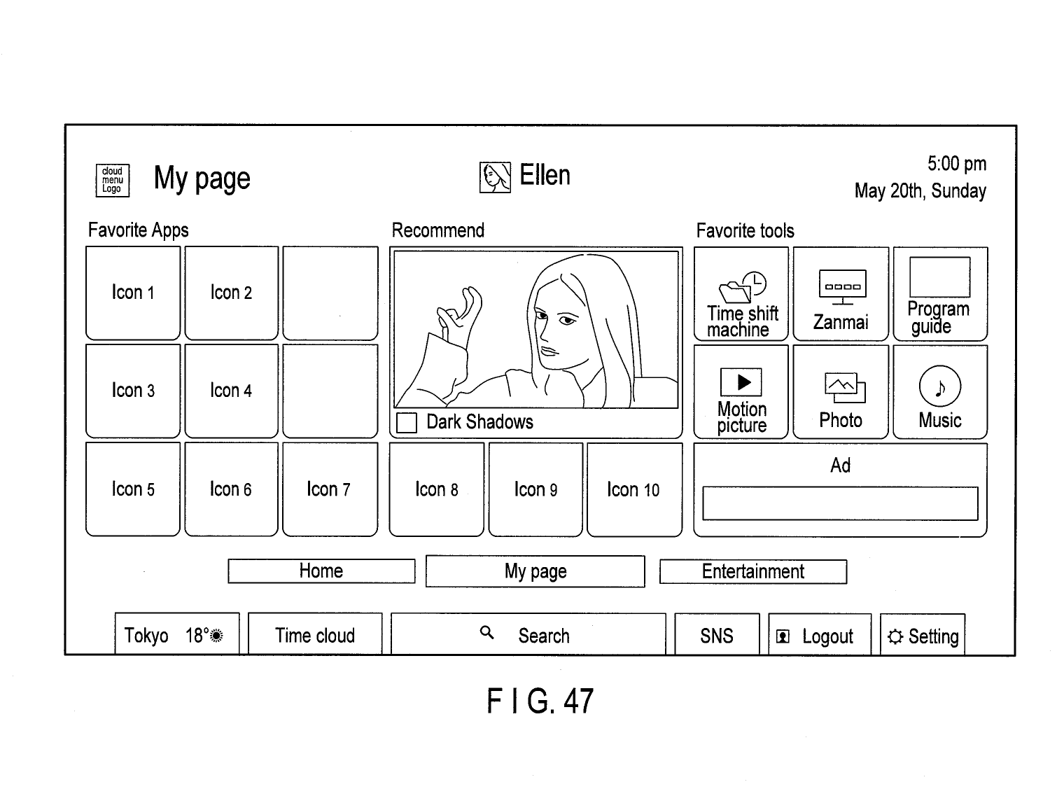

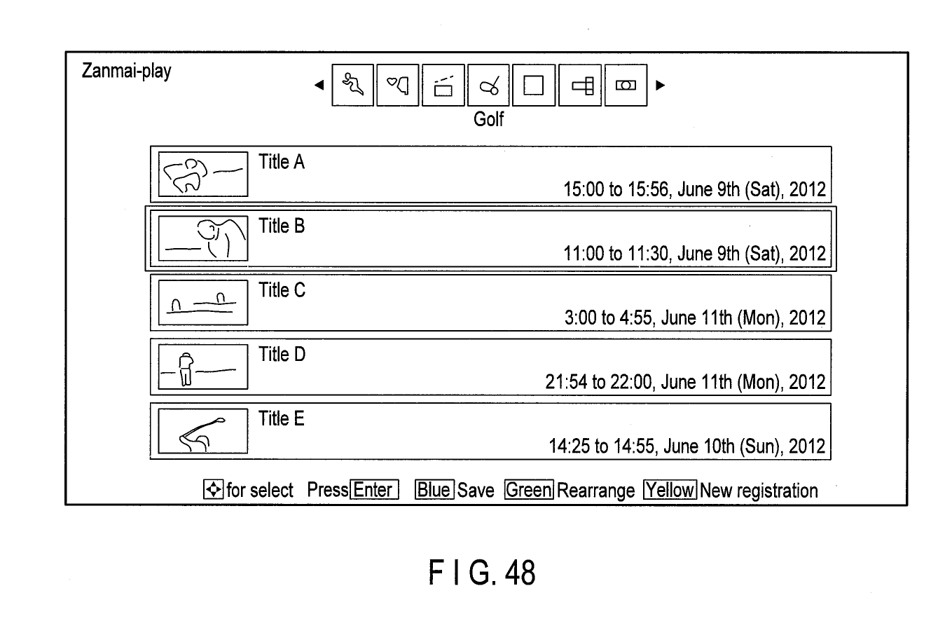

The user can refer to the interesting! scene by the transition from a menu screen (for example, as in FIGS. 33, 40, and 47) displayed on the player 1, the Cloud-Zanmai function (for example, as in FIGS. 40 and 48), and various other pages.

For example, the player 1 plays a selected interesting! scene, and after the scene play ends, starts to play its subsequent scene automatically or in response to the play instruction from the user (ordinary scene play or scene continuous play). Or, the player 1 plays a selected interesting ! scene based on the selected interesting scene based on preset scene play setting (ordinary scene play or scene continuous play), and after the scene play ends, starts to play its subsequent scene. Details of the ordinary scene play and scene continuous play are explained later.

Complete Registration of Interesting! Scene

From a popup box indicative of the completion of the registration of the interesting scene, a user can calls up the ScenePlay function directly.

(2) Interesting! Scene List Display Function/List Preparation Process

The following [1] and [2] lists of interesting! scenes are displayed at once.

[1] Scene which itself was selected and registered in Favorites

[2] Scene of a position (point) of the very moment when the interesting! button is pressed.

Work of Player

At the moment when a press of the interesting button is detected, the player 1 instantly sends scene information acquisition information (for example, program ID being viewed and view position information (play time information)) at that time (at that point of time) to the server. When the interesting! scene list is prepared, the player 1 receives the scene information at that time (at that point of time) from the server. Note that, the server which receives the scene information acquisition information may send the scene information item corresponding to one scene only or may send the whole scene information items related to the program being viewed. That is, the player 1 sends the scene information acquisition information to the server and then, the player 1 may receive the scene information item corresponding to one scene only or may receive the whole scene information items related to the program being viewed. In the latter case, there is no need to access the server at every scene to acquire the scene information, and the scene information acquisition process can be performed with high efficiency.

Furthermore, if the player 1 plays a position associated with scene information while a program is being played, the below-described popup or the like can be used to notify that there is the scene information available to the user. The timing to acquire the scene information is flexible in a case where the recorded program is viewed since the player can request the scene information of the program at the time when the program is started to obtain the whole scene information items of the program from the server. In this case, the user do not need to request the scene information at each interested scene.

Work of Server

The server receives the scene information acquisition information at that time (at that point of time) (for example, the program ID of the program being viewed and view point information (play time information)) from the player 1. Based on the scene information acquisition information received, the server retrieves the tags or the scene information items prepared by the metadata generating company and the like.

As above, the player 1 sends the scene information acquisition information to the server and the server sends the tags or the scene information items retrieved based on the scene information acquisition information to the player 1. The player 1 receives the tags or the scene information items from the server. Through this process, the user can use the tags or the scene information items related to that time (that point of time) by simply pressing the interesting! button.

Furthermore, even if tags or scene information items are not prepered at the time when the user presses the interesting button, the server can send the tags or the scene information items to the player 1 after the preparation of the tags or the scene information items. The player 1 receives the tags or the scene information items and then notifies the reception to the user by a popup function or the like.

Furthermore, there may be a case where the tags or the scene information items are updated, and in that case, the server can send the updated tags or the updated scene information items to the player 1. The player 1 receives the updated tags of the updated scene information items and then notifies the reception and update to the user by a popup function or the like.

(3) Inbox/New Message

The player 1 can display Inbox Message on the menu screen or in a popup during the program viewing.

Furthermore, the player 1 can display a new message.

Furthermore, the player 1 can display a popup to the user based on a triggering action made by the user him/herself (such as pressing the interesting! button or the like).

Furthermore, the player 1 can display a popup to the user based on a triggering action made by a different user (such as receiving a recommended scene from a friend or the like).

Furthermore, the player 1 can perform an automatic preparation of the Inbox Message and an automatic display of a popup based on an action such as pressing the interesting button or the like.

Furthermore, the player 1 can play a recommended/designated scene directly from the Inbox Message and new message.

(4) Drawing (Recommendation to Other Users)

Now, the recommendation of scenes to the friends and the like are explained. Depending on the area of broadcast, some programs are broadcast in different channels, and on different start and end times. Thus, even if a player 1 in a certain area receives the information (recommended scene information and recommended program information) from a different player 1 (different user) in a different area, the player 1 may not play the target scene based on the received information.

Thus, if the player 1 in a certain area sends the recommended scene information or the recommended program information to the player 1 in a different area, the server receives the recommended scene information or the recommended program information and then, converts the channel code, broadcast start time, broadcast end time, and the like of the received information into the the information directed to the different area. Then, the server sends the recommended scene information or the recommended program information including the converted channel code, broadcast start time, broadcast end time, and the like to the player 1 in the different area.

A unique contents ID is assigned to the contents stored in each of the players 1, and thus, the contents are managed by the contents ID. Note that the contents ID is unique only in the storage device (HDD) of each of the players 1 and is secret to the other users.

With a channel code (inherent in the whole world) and broadcast time band, the contents are identified uniquely. The player 1 at the friend side can sends the channel code and the broadcast time band to the server. The server can narrow down the target contents based on the channel code and the broadcast time band. The player 1 at the friend side can send the title, summary, and broadcast time of the program to the server. The server can specify the contents based on the title and broadcast time of the program.

If the server can identify the contents, the server can derive the contents ID corresponding to each of the players 1 based on the recording log and the like of each of the players 1.

(5) Mode Selection

In using the ScenePlay function, the player 1 determines which retrieval mode and which continuous play list generating mode are used.

For example, the player 1 can retrieve a scene information item including a hot ward from a large number of scene information items sent from the server. If the user selects the retrieved scene information item, the player 1 starts playing the scene of the contents corresponding to the selected scene information item.

The scene or program retrieval based on the hot word is based on the tags or the scene information items (such as titles and casts) generated by the metadata generating company and the like.

The tag list is made by the automatic tag list preparation software or the user.

(6) Scene Program Retrieval (Including UI)

The player 1 displays results of the scene information retrieval based on the mode selected by the mode selection.

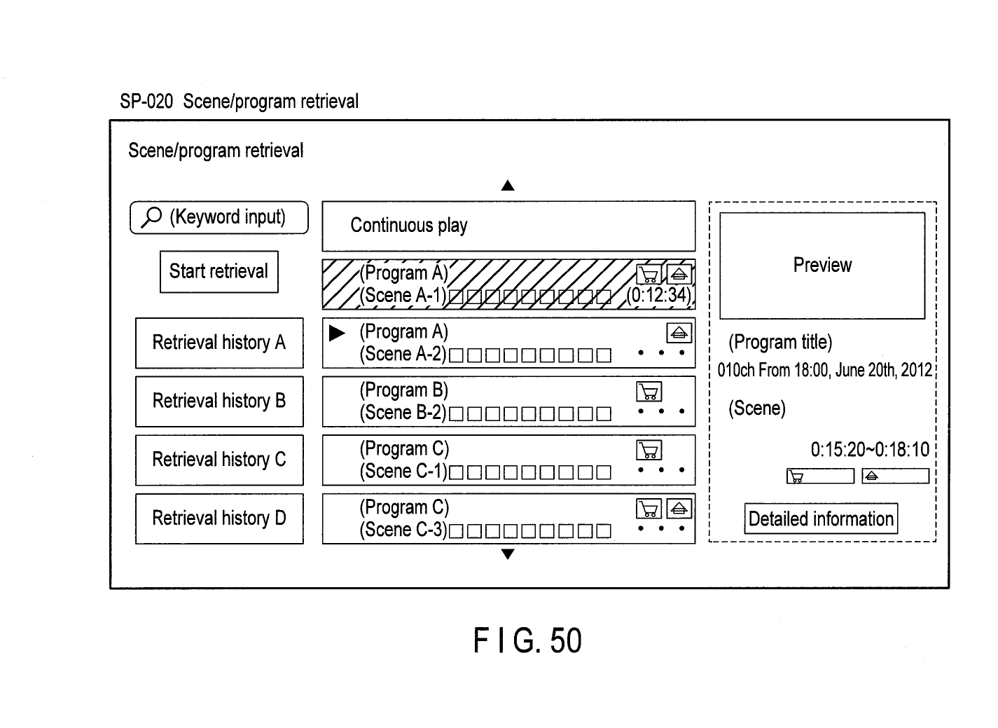

UI (refer to FIG. 50)

Upper left: Retrieval keyword input screen

Middle left, lower left: History of keywords retrieved in past

Center: Retrieval results (a plurality of scenes)

Upper right: Preview of the focused scene

Middle right, lower right: Detailed information of the focused scene

If the continuous play button is pressed, the player 1 plays the scenes in the order of the retrieval results. The player 1 arranges the scene information items based on the hit order of the retrieval results. The player 1 arranges the scenes of one program continuously as possible. The player 1 displays the merchandise information icon and shop information icon per retrieval result (scene-by-scene).

The merchandise information icon is displayed if there is merchandise information. The shop information icon is displayed if there is shop information (URL) for shopping.

The preview is, in general, a preview of the scene being focused. After the preview of the focused scene completes, the preview of the next scene begins. That is, the preview is played continuously.

The focused scene and the scene in the preview may differ, and in that case, an icon indicative of a preview play position (scene) is applied to the screen.

If a new scene is focused, the preview is switched alongside.

The detailed information is, for example, title, time, details of the program, registration as the interesting! scene, recommendation to friends, related links (item names). Two or more keywords can be used for the detailed retrieval using and/or/not conditions.

(7) Scene Play Control

Now, the scene play control is described. The scene play control is used to select a scene from the ScenePlay function, interesting! scenes, and recommended scenes for playing. Here, the scene play control based on the scene information is described; however, it can be interpreted as the scene play control based on the tag information.

Scene Selection

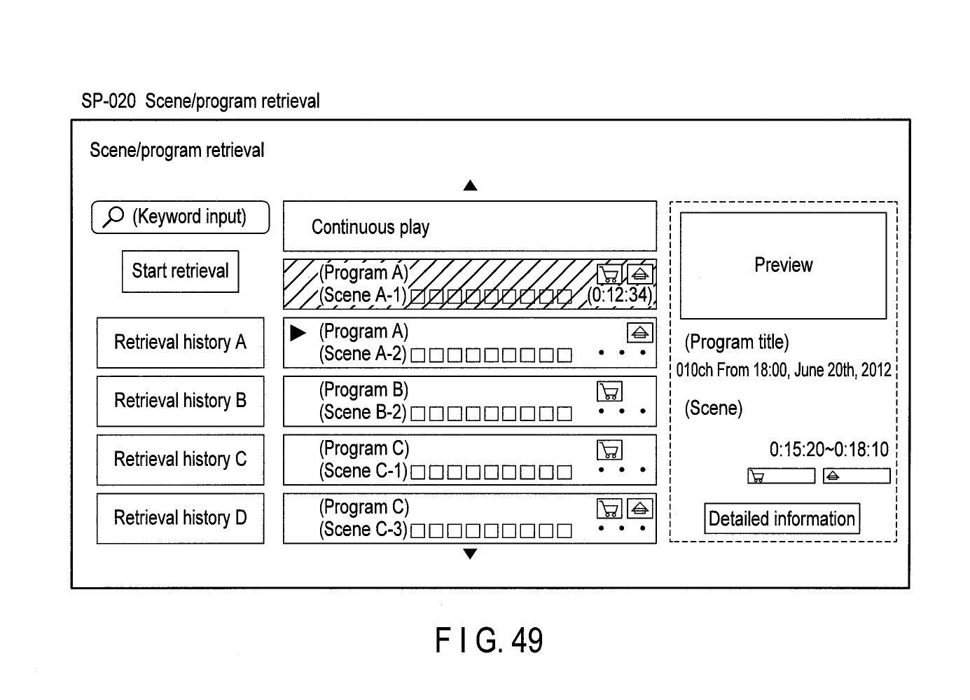

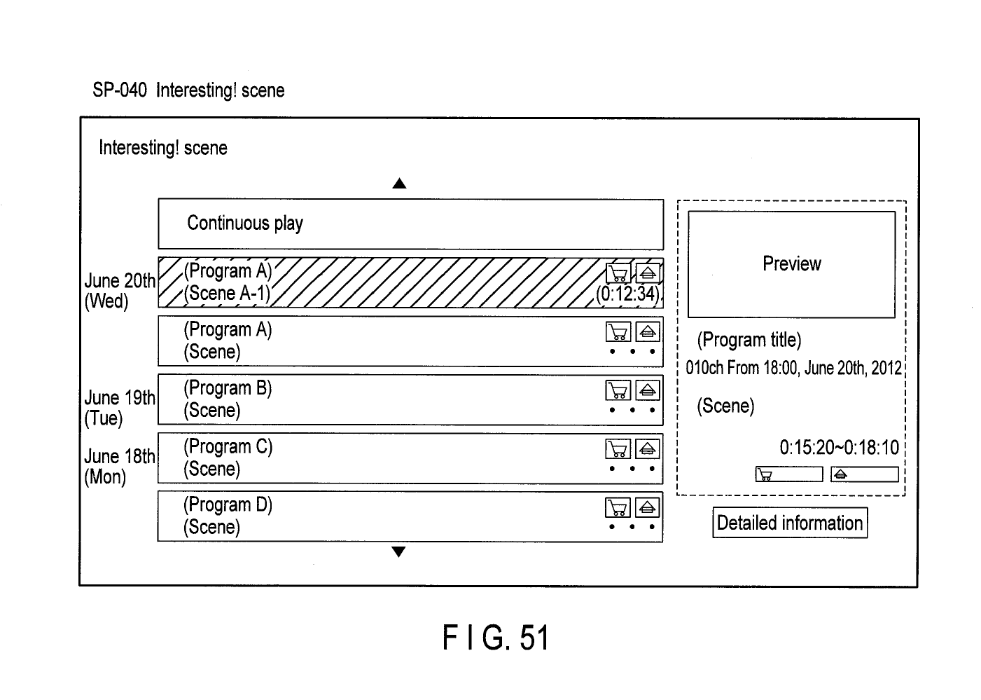

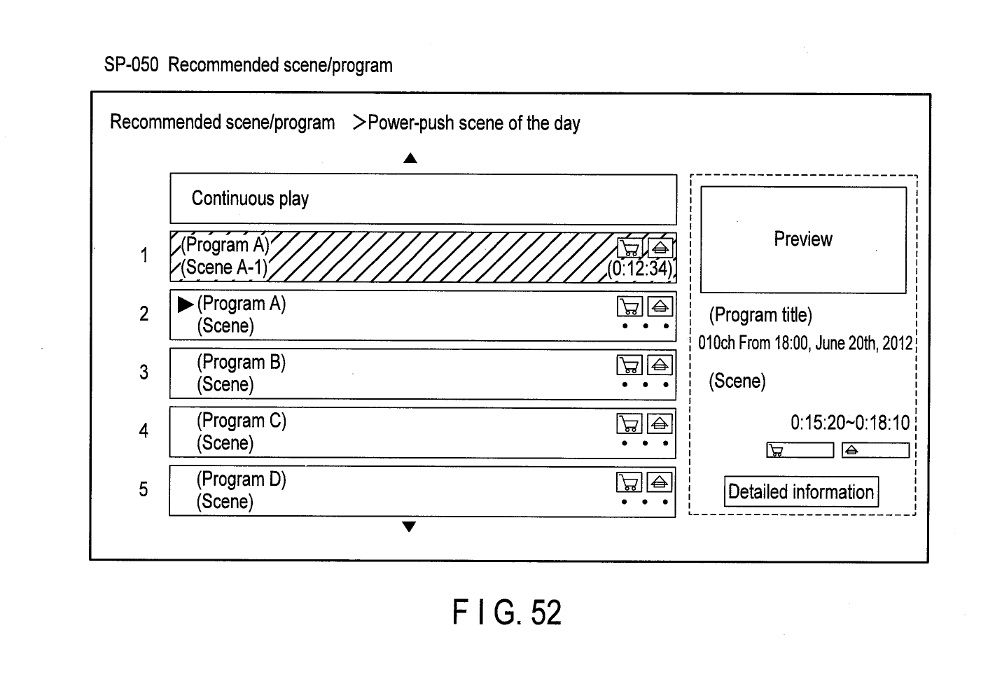

As explained above, the player 1 receives a large number of scene information items from the server and displays the scene information items (as in FIG. 50). Furthermore, the player 1 extracts a plurality of scene information items from the received scene information based on various conditions (such as hot words and the like). That is, based on the mode selection (as in FIG. 49), the player 1 can extract a plurality of scene information items from the received scene information (as in FIGS. 51 and 52).

For example, the player 1 displays the extracted scene information items as interesting scenes (as in FIG. 51). The player 1 displays the extracted scene information items as recommended scenes (as in FIG. 52).

If the user selects a desired scene information item from the extracted scene information items, the player 1 starts playing a scene corresponding to the selected scene information item from its starting position.

For example, if the user selects a desired scene information item and instructs the ordinary scene play (first play), the player 1 starts playing the scene corresponding to the selected scene information item from its starting position in a specific content, and after the completion of the scene play, continues playing the next scene of the specific contents. Thus, the specific content is played to its end. Note that, if the specific content is not recorded completely, the player 1 plays the content until the position recorded lastly.

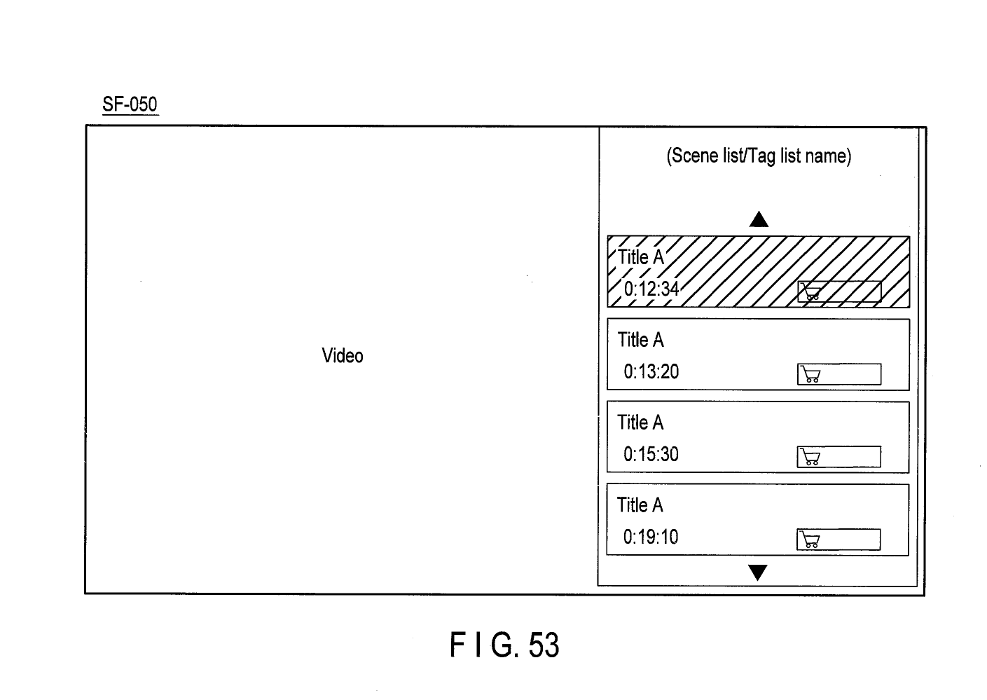

For example, if the user selects a desired scene information item and instructs the scene continuous play (second play), the player 1 starts playing the scene corresponding to the selected scene information item from its starting position in a specific content, and after the completion of the scene play, continues playing the scene of the scene information item next to the selected scene information item (as in FIG. 53).

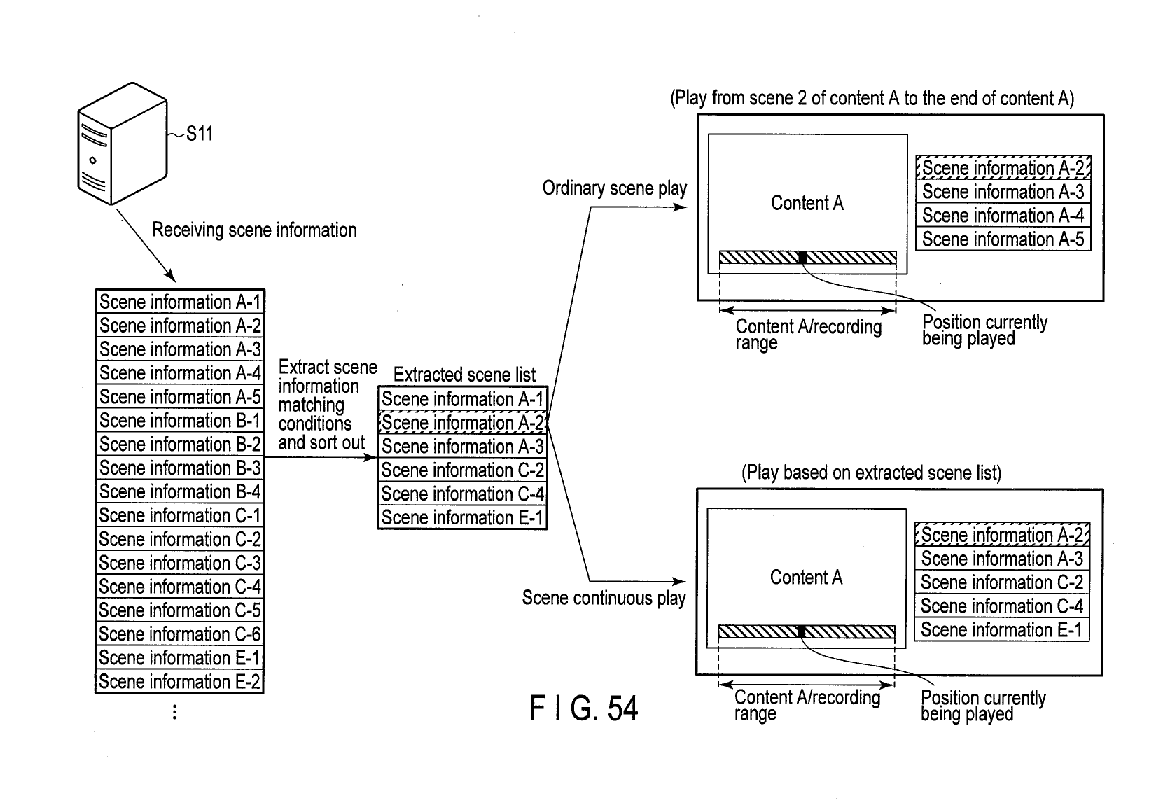

Referring to FIG. 54, the ordinary scene play instruction (first play instruction) and the scene continuous play instruction (second play instruction) are explained as an example.

Given that the player 1 is receiving the scene information items A-1, A-2, . . . , B-1, B-2, . . . , C-1, C-2, . . . , and E-1, E-2, . . . from the server, the scene information item A-1 indicates scene 1 of content A. The player 1 extracts the scene information items corresponding to the designated conditions and sorts out (as in FIGS. 51 and 52). For example, the player 1 displays an extractes scene list including the scene information items A-1, A-2, A-3, C-2, C-4, and E-1.

If the user selects the scene information item A-2 in the extracted scene list and gives the ordinary scene play instruction (first play instruction), the player 1 starts playing scene 2 corresponding to the selected scene information item A-2 from its starting position in the content A, and after the completion of the play of scene 2, plays subsequent scenes (3, 4, and 5) in the content A. At that time, the player 1 outputs the image of the content A (scene 2) and the image corresponding to a seek bar (guide bar) indicative of the play start and play end positions of the content A (recorded range) together with the position currently being played.

If the user selects the scene information item A-2 in the extracted scene list and gives the scene continuous play instruction (second play instruction), the player 1 starts playing scene 2 corresponding to the selected scene information item A-2 from its starting position in the content A, and after the completion of the play of scene 2, starts planing a scene corresponding to the scene information item A-3 which is next to the selected scene information item A-2. Then, the player 1 plays a scene corresponding to the scene information item C-2, a scene corresponding to the scene information item C-4, and a scene corresponding to the scene information item E-1. While playing the scene corresponding to the scene information item A-2, the player 1 outputs the image of the content A (scene 2) and the image corresponding to a seek bar (guide bar) indicative of the play start and play end positions of the content A (recorded range) together with the position currently being played. Furthermore, while playing the scene corresponding to the scene information item C-2, the player 1 outputs the image of the content C (scene 2) and the image corresponding to a seek bar (guide bar) indicative of the play start and play end positions of the content C (recorded range) together with the position currently being played. Furthermore, while playing the scene corresponding to the scene information item E-1, the player 1 outputs the image of the content E (scene 1) and the image corresponding to a seek bar (guide bar) indicative of the play start and play end positions of the content E (recorded range) together with the position currently being played.

If a program is partly recorded but an instruction to play before the start position of the recorded range is given, the player 1 starts playing the start position of the recorded range. Furthermore, if an instruction to play after the end position of the recorded range is given, the player 1 does not start the playing process.

Now, continuous play of scenes in a single program (first continuous play) and continuous play of scenes in difference programs (second continuous play) are explained.

The player 1 plays the scenes in a seeking process (without stopping the play) in the first continuous play. On the other hand, the player 1 plays the first scene of the first content, stops the first scene of the first content, and then, plays the first scene of the second tentent.

Furthermore, upon receiving a fastforward instruction in the forward direction during the first continuous play (while the first scene of the first content is being played), the player 1 performs the fastforward play in the forward direction within the range of the first content (the player 1 plays the start of the current scene, the end of the current scene, the start of the next scene, and the end of the next scene).

Furthermore, upon receiving a fastforward instruction in the forward direction during the second continuous play (while the first scene of the first content is being played), the player 1 performs the fastforward play in the forward direction within the range of the first to nth scenes (the player 1 plays the start of the current scene, the end of the current scene, the start of the next scene, and the end of the next scene).

Furthermore, upon receiving a fastforward instruction in the backward direction during the first continuous play (while the first scene of the first content is being played), the player 1 performs the fastforward play in the backward direction within the range of the first content (the player 1 plays the end of the current scene, the start of the current scene, the end of the previous scene, and the start of the previous scene). Furthermore, upon receiving a fastforward instruction in the backward direction during the second continuous play (while the first scene of the first content is being played), the player 1 performs the fastforward play in the backward direction within the range of the first to nth scenes (the player 1 plays the end of the current scene, the start of the current scene, the end of the previous scene, and the start of the previous scene).

Furthermore, upon receiving a skip instruction in the forward direction during the first continuous play (while the first scene of the first content is being played), the player 1 performs the skip play from a scene of a skip play position in the forward direction far from the current play position for a certain period of time within the range of the first content, or performs the skip play from a start position of the scene next to the first scene. Furthermore, upon receiving a skip instruction in the forward direction during the second continuous play (while the first scene of the first content is being played), the player 1 performs the skip play from a scene of a skip play position in the forward direction far from the current play position for a certain period of time within the range of the first to nth scenes, or performs the skip play from a start position of the scene next to the first scene.

Furthermore, upon receiving a skip instruction in the backward direction during the first continuous play (while the first scene of the first content is being played), the player 1 performs the skip play from a scene of a skip play position in the backward direction far from the current play position for a certain period of time within the range of the first content, or performs the skip play from a start position of the scene previous to the first scene within the range of the first content. Furthermore, upon receiving a skip instruction in the backward direction during the second continuous play (while the first scene of the first content is being played), the player 1 performs the skip play from a scene of a skip play position in the backward direction far from the current play position for a certain period of time within the range of the first to nth scenes, or performs the skip play from a start position of the scene previous to the first scene within the range of the first to nth scenes.

Note that, if the backward play reaches the start position of the scene currently being played by the fastforward play in the backward direction, the play may be stopped instead of moving to the previous scene.

Furthermore, if the scene or the program is partly recorded (if the recording range is limited), the play is controlled using the head and the tail of the scene, or the head and the tail of the program as breaks.

(8) Recommended Scene Category

The categories of the recommended scenes displayed by the player 1 are, for example, as follows.

Power-push scenes of the day

Popular scenes

Scenes everyone is interested in

Twitter buzzing scenes

Friend recommend scenes

Scenes friends are interested in

Popular item/shop scenes

Popular item scenes

Exclusive recommended scenes

Scene view rating ranking

Hot word retrieval

Note that the hot word retrieval is the retrieval based on the recommended keywords.

(9) Displaying Interesting! Scenes

Upon receiving a press of the interesting! button by the user, the player 1 registers and keeps the interesting! scenes in the server.

The player 1 displays the interesting! scenes sorted out based on the dates. For example, the upper limit of the interesting! scenes registerable (in the server) is 5,000. For example, the player 1 displays 20 interesting! scenes at a time. For example, the player 1 receives the information for 60 interesting! scenes from the server, sorts out the scenes based on the dates, and displays 20 scenes in ascending or descending order. Since 20 scenes before and 20 scenes after the 20 scenes currently being displayed have already been received, the display can be updated in an instant in response to a scrolling operation. Note that the player 1 can retrieve a scene from the maximum 5,000 interesting! scenes registered in the server. The player 1 narrows down the scenes. For example, the scenes are narrowed down by checking whether the scenes to be displayed are scene information or not, whether they are commercials or not, whether they are related to item/shop information or not.

(10) Limitation of Recommendation

The player 1 can play the scene corresponding to the scene information of the scene retrieval results, ranking results, and friend recommendation results. That is, the player 1 receives the scene information corresponding to the scenes in the recorded contents. Thus, as long as the scene information is displayed by the player 1, the user can select and view any scene corresponding to the scene information.

For example, if the player 1 is linked with a recording device which records the whole contents of the entire channels for 24 hours, the player 1 can retrieve and play a certain scene in the contents recorded in the recording device.

Note that the module mentioned above may be achieved as hardware or may be achieved by software using a central processing unit and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
receiving information related to scenes included in contents of genres;
displaying scene listings included in the information;
displaying first scene listings sorted out in a first sorting order when an operation is performed with respect to a first scene in a first content of a first genre in the scene listings; and
displaying second scene listings sorted out in a second sorting order different from the first sorting order when an operation is performed with respect to a second scene in a second content of a second genre different from the first genre in the scene listings.

2. The method of claim 1, comprising: outputting a scene list including scene listings categorized as the first genre and scene listings categorized as the second genre, the scene listings sorted out based on a first sorting condition and a second sorting condition which are set for the first genre and the second sorting condition which is set for the second genre.

3. The method of claim 2, wherein the first sorting condition is to sort out the scene listings based on a first priority and the second sorting condition is to sort out the scene listings based on a second priority which is lower than the first priority.

4. The method of claim 3, wherein the first sorting condition is a viewing history of contents categorized as the first genre.

5. The method of claim 4, wherein the first sorting condition is to sort out the scene listings included in the contents categorized as the first genre and having the viewing history based on the first priority.

6. The method of claim 5, wherein the first sorting condition is to sort out the scene listings included in the contents retrieved in the past and having the viewing history based on the first priority.

7. The method of claim 6, wherein the first sorting condition is to sort out the scene listings included in the contents retrieved in the past and having no viewing history based on a third priority which is lower than the second priority.

8. The method of claim 2, wherein the second sorting condition is a date of broadcast.

9. The method of claim 1, wherein the scene list to be output includes scene listings matching the sorting conditions.

10. The method of claim 1, wherein, in response to a selection of a scene listing, a scene corresponding to the selected scene listing.

11. The method of claim 1, wherein the scene list to be output includes the scene listings on which the viewing history is reflected.

12. The method of claim 1, wherein the scene list to be output includes the scene listings on which the viewing history of a user account is reflected.

13. An electronic device, comprising:
a receiver to receive scene information items related to scenes included in contents of genres; and
a display processor to display the scene information items at least partly sorted out, to display the scene information items sorted out in a first sorting order when an operation is performed with respect to a first scene in a first content of a first genre in the scene information items, and to display the scene information items sorted out in a second sorting order which is different from the first sorting order when an operation is performed with respect to a second scene in a second content of a second genre which is different from the first genre in the scene information items.

14. A computer-executable program by which a computer executes:
a step of displaying at least a part of scene information items in a sorted manner, the scene information items related to scenes included in contents of genres; and
a step of displaying the scene information items sorted out in a first sorting order when an operation is performed with respect to a first scene in a first content of a first genre in the scene information items, and
a step of displaying the scene information items sorted out in a second sorting order which is different from the first sorting order when an operation is performed with respect to a second scene in a second content of a second genre which is different from the first genre in the scene information items.

15. A server comprising:
a receiver configured to receive a process history from a content processing device which displays at least a part of scene information items, displays the scene information items sorted out in a first sorting order when an operation is performed with respect to a first scene in a first content of a first genre in the scene information items, and displays the scene information items sorted out in a second sorting order which is different from the first sorting order when an operation is performed with respect to a second scene in a second content of a second genre which is different from the first genre in the scene information items;
a processor to extract scene information items related to scenes included in contents of genres based on the process history; and
a transmitter to transfer the scenes information items to the content processing device.
